(19) United States
(12) Patent Application Publication
(10) Pub. No.: US 2006/0120213 A1
(43) Pub. Date: Jun. 8, 2006

(54) Emulsion process using microchannel process technology

(76) Inventors: Anna Lee Tonkovich, Dublin, OH (US); Jennifer Anne Freeman, Columbus, OH (US); Bin Yang, Columbus, OH (US); Laura J. Silva, Dublin, OH (US); Richard Q. Long, New Albany, OH (US); Paul Neagle, Westerville, OH (US); Barry L. Yang, Dublin, OH (US); Thomas Yuschak, Lewis Center, OH (US); Eric Daymo, Dublin, OH (US); Dongming Qiu, Bothell, WA (US); Kristina M. Pagnotto, Cincinnati, OH (US); Michael Alan Marchiando, London, OH (US); Amanda Rae Divan Glass, Galloway, OH (US); David J. Kuhlmann, Powell, OH (US); Jeffrey Dale Marco, South Charleston, OH (US); Harley D. Freeman, Dublin, OH (US); William A. Rogers JR., Marysville, OH (US)

Correspondence Address: NEIL A. DUCHEZ (VELOCYS);RENNER, OTTO, BOISSELLE & SKLAR, LLP, 1621 EUCLID AVENUE, 19TH FLOOR, CLEVELAND, OH, 44115, US

(21) Appl. No.: 11/283,525

(22) Filed: Nov. 17, 2005

Related U.S. Application Data
(60) Provisional application No. 60/628,639, filed on Nov. 17, 2004.
(60) Provisional application No. 60/697,900, filed on Jul. 8, 2005.
(60) Provisional application No. 60/727,126, filed on Oct. 13, 2005.
(60) Provisional application No. 60/731,596, filed on Oct. 27, 2005.

(51) Int. Cl. B01F 3/08; B01F 15/06; B01F 17/00

(52) U.S. Cl. 366/144; 516/9

(57) ABSTRACT

The disclosed invention relates to a process for treating or making an emulsion in a microchannel. The emulsion comprises a first liquid and a second liquid, the first liquid forming a continuous phase, the second liquid forming droplets dispersed in the continuous phase.

This application claims priority under 35 U.S.C. §119(e) to U.S. Provisional Application Ser. No. 60/628,639, filed Nov. 17, 2004, U.S. Provisional Application Ser. No. 60/697,900, filed Jul. 8, 2005, U.S. Provisional Application Ser. No. 60/727,126, filed Oct. 13, 2005, and U.S. Provisional Application Ser. No. 60,731,596, filed Oct. 27, 2005. The disclosures in these prior applications are incorporated herein by reference in their entirety.

### TECHNICAL FIELD

This invention relates to a process for making and/or treating an emulsion using microchannel process technology.

### BACKGROUND

Emulsions may be formed when two or more immiscible liquids, usually water or a water-based solution and a hydrophobic organic liquid (e.g., an oil), are mixed so that one liquid forms droplets in the other liquid. Either of the liquids can be dispersed in the other liquid. When, for example, oil is dispersed in water, the emulsion may be referred to as an oil-in-water (o/w) emulsion. The reverse case is a water-in-oil (w/o) emulsion. More complex emulsions such as double emulsions may be formed when, for example, water droplets in a continuous oil phase themselves contain dispersed oil droplets. These oil-in-water-in-oil emulsions may be identified as o/w/o emulsions. In the same manner a w/o/w emulsion may be formed.

A problem with many emulsions is that if they are not stabilized, for example, by adding surfactants or emulsifiers, they tend to agglomerate, form a creaming layer, coalesce, and finally separate into two phases. If a surfactant or emulsifier (sometimes referred to as a surface-active agent) is added to one or both of the immiscible liquids, one of the liquids may form a continuous phase and the other liquid may remain in droplet form (“dispersed or discontinuous phase”), the droplets being dispersed in the continuous phase. The degree of stability of the emulsion may be increased when droplet size is decreased below certain values. For example, a typical o/w emulsion of a droplet size of 20 microns may be only temporally stable (hours) while that of one micron may be considered as “quasi-permanently” stable (weeks or longer). However, the energy consumption and the power requirement for the emulsification system and process may be significantly increased for smaller droplet sizes when using conventional processing techniques, especially for highly viscous emulsions with very small droplet sizes and large outputs. For example, the doubling of energy dissipation (energy consumption) may cause a reduction of average droplet size of only about 25% when using conventional processing techniques. Shear force may be applied to overcome the interfacial tension force and in turn to break larger droplets into smaller ones. However, as the droplet size decreases, the interfacial tension required to keep the droplet shape tends to increase. Energy consumption may take place in various forms, for example, it can be the energy needed by the stirrer to overcome shear force of the emulsion in a batch process, the energy for heating and cooling, and/or the power to overcome pressure drop in a continuous process such as in a homogenizer. Heating is often needed for emulsification when one of the phases does not flow or flows too slowly at room temperature. A heated emulsion typically has lower stability, however, due to lower viscosity of the continuous phase and in turn less drag. Drag may be necessary to stop or resist the motion of the droplets and in turn the coalescence into larger and often undesired droplets or aggregates of droplets as well as phase separation into layers. After emulsification, droplets tend to rise by buoyancy. As such, an immediate cooling down may be needed, which also consumes energy.

A problem with many of the processes that are currently available for making emulsions is that the range of compositions that are feasible for formulating product are constrained. For example, a problem with many of the emulsions that are currently available relates to the presence of surfactants or emulsifiers in their formulations. These surfactants or emulsifiers may be required to stabilize the emulsions, but may be undesirable for many applications. For example, heating without bubbling or boiling is often desired in emulsification processes, however in some instances the onset temperature of nucleate boiling or air bubble formation from dissolved air in the continuous phase may lower when surfactants or emulsifiers are present. Boiling may cause unwanted property changes. Air bubbles may cause creaming and other undesired features.

Emulsions that have low surfactant or emulsifier concentrations or are free of such surfactants or emulsifiers are often desirable for skin care products in the cosmetic industry. A disadvantage with some surfactants or emulsifiers is their tendency to interact with preservatives, such as the esters of p-hydroxybenzoic acid, used in skin care products. Skin irritation is another problem often associated with the use of surfactants or emulsifiers. Many adverse skin reactions experienced by consumers from the use of cosmetics may be related to the presence of the surfactants or emulsifiers. Another example relates to the problem with using surfactants or emulsifiers wherein water proofing is desired. For example, in water-based skin care products such as sunscreen, the active ingredient may not be waterproof due to the presence of water-soluble surfactants or emulsifiers.

A problem relating to the use of many pharmaceutical compounds relates to the fact that they are insoluble or poorly soluble in water and there are limitations as to the surfactants or emulsifiers that can be used. This has resulted in the discovery of drugs that are not clinically acceptable due to problems relating to transporting the drugs into the body. Emulsion formulation problems may be problematic with drugs for intravenous injection and the administration of chemotherapeutic or anti-cancer agents.

### SUMMARY

The present invention, at least in one embodiment, may provide a solution to one or more of the foregoing problems. In one embodiment, it may be possible to make an emulsion using a relatively low level of energy as compared to the prior art. The emulsion made in accordance with the inventive process, at least in one embodiment, may have a dispersed phase with a relatively small droplet size and a relatively uniform droplet size distribution. The emulsion made in accordance with the inventive process, in one embodiment, may exhibit a high degree of stability. In one embodiment, the emulsion made by the inventive process may have a low surfactant or emulsifier concentration or be free of such surfactants or emulsifiers. The emulsions made in accordance with the inventive process, in one embodiment, may be useful, for example, as a skin care product, pharmaceutical composition, etc.

In one embodiment, the invention relates to a process, comprising: flowing an emulsion in a process microchannel, the emulsion comprising a continuous phase and a dispersed phase, the continuous phase comprising a first liquid, the dispersed phase comprising a second liquid; and exchanging heat between the process microchannel and a heat source and/or heat sink to increase or decrease the temperature of the emulsion by at least about 10° C. within a period of up to about 750 milliseconds. Advantages of this process may include improved emulsion stability. The droplet size distribution can be set and maintained for a longer period of time than if the emulsion were cooled more slowly. This process may provide the advantage of improved control for changing thermodynamic states. For example, it is possible to control the local temperature profile to effect a phase inversion based on temperature change in a controlled manner. For some emulsion formations, inverting a phase during processing can result in a smaller, more uniform droplet size distribution. The process may provide the advantage of improved control over the emulsified product rheology. For example, the final viscosity of the emulsion product may be a function of formulation, as well as shear and temperature history. It may be possible to have one formulation used to make multiple products in the same emulsion process unit, simply by changing the temperature processing history among the various products. The inventive process may provide the advantage of minimizing time at high temperatures for sensitive formulations (e.g., minimizing structural changes to proteins, polymers, and the like). This process may provide the advantage of minimizing the thermal gradient between the process microchannel wall and the bulk fluid in the process microchannel.

In one embodiment, the dispersed phase may be in the form of liquid droplets, the liquid droplets having a volume-based mean diameter in the range up to about 200 microns, and a span in the range from about 0.005 to about 10.

In one embodiment, the flow rate of the emulsion in the process microchannel may be at least about 0.01 liter per minute.

In one embodiment, the superficial velocity of the emulsion flowing in the process microchannel may be at least about 0.01 meter per second.

In one embodiment, the first liquid and the second liquid may be mixed to form the emulsion in the process microchannel.

In one embodiment, the process microchannel may comprise at least one side wall and at least one apertured section extending along at least part of the axial length of the side wall, the second liquid flowing through the apertured section into the process microchannel in contact with the first liquid to form the emulsion. In one embodiment, the second liquid may flow from a liquid channel through the apertured section.

In one embodiment, the process may be conducted in an emulsion process unit, the emulsion process unit comprising a plurality of the process microchannels and at least one header for distributing the liquids to the process microchannels, the process further comprising mixing the first liquid and the second liquid to form the emulsion in the header, the emulsion flowing from the header into the process microchannels.

In one embodiment, the header may comprise at least one first liquid zone, at least one second liquid zone, and an apertured section positioned between the first liquid zone and the second liquid zone, the second liquid flowing from the second liquid zone through the apertured section into the first liquid zone in contact with the first liquid to form the emulsion, the emulsion flowing from the first liquid zone into the process microchannels.

In one embodiment, a stream of the second liquid may contact a stream of the first liquid in the header to form the emulsion.

In one embodiment, a stream of the second liquid may contact a stream of the first liquid in the process microchannel to form the emulsion.

In one embodiment, the process microchannel comprises surface features formed in and/or on one or more interior walls for modifying flow and/or mixing within the process microchannel.

In one embodiment, the liquid channel comprises surface features formed in and/or on one or more interior walls of the liquid channel for modifying flow and/or mixing within the liquid channel.

In one embodiment, the heat source and/or heat sink comprises at least one heat exchange channel, the heat exchange channel comprising surface features formed in and/or on one or more interior walls of the heat exchange channel for modifying flow and/or mixing within the heat exchange channel.

In one embodiment, the invention relates to a process for making an emulsion, comprising: flowing a first liquid in a process microchannel, the process microchannel having an axial length extending parallel to the direction of flow of the first liquid, the process microchannel having at least one wall with at least one apertured section, the apertured section having an axial length extending parallel to the axial length of the process microchannel; flowing a second liquid through the apertured section into the process microchannel in contact with the first liquid to form the emulsion, the first liquid forming a continuous phase, the second liquid forming droplets dispersed in the continuous phase; and maintaining the flow of the second liquid through the apertured section at a rate that is substantially constant along the axial length of the apertured section.

In one embodiment, the second liquid flows in a liquid channel and from the liquid channel through the apertured section, the liquid channel being parallel to the process microchannel, the apertured section being positioned between the liquid channel and the process microchannel, the first liquid undergoing a pressure drop as it flows in the process microchannel, the second liquid undergoing a pressure drop as it flows in the liquid channel, the pressure drop for the first liquid flowing in the process microchannel being substantially the same as the pressure drop for the second liquid flowing in the liquid channel. In one embodiment, the liquid channel comprises a microchannel.

In one embodiment, the second liquid flows in a liquid channel and from the liquid channel through the apertured section, the liquid channel being parallel to the process microchannel, the apertured section being positioned between the liquid channel and the process microchannel, the first liquid undergoing a pressure drop as it flows in the process microchannel, the internal pressure within the liquid channel being reduced along the length of the liquid channel to provide a pressure differential across the apertured section that is substantially constant along the length of the apertured section. In one embodiment, the liquid channel comprises one or more, and in one embodiment a plurality, of internal flow restriction devices to reduce the internal pressure within the liquid channel along the length of the liquid channel. In one embodiment, the liquid channel comprises one or more, and in one embodiment a plurality, of internal zones positioned along the length of the liquid channel, the second liquid flowing from the liquid channel through the internal zones and through the apertured section, the pressure within the internal zones being reduced along the length of the liquid channel to provide the substantially constant pressure differential across the apertured section along the length of the apertured section.

In one embodiment, the invention relates to a process, comprising: flowing an emulsion in a process microchannel in contact with surface features formed in and/or on one or more interior walls of the process microchannel, the emulsion comprising a continuous phase and a dispersed phase, the continuous phase comprising a first liquid, the dispersed phase comprising droplets of a second liquid, the flow of the emulsion being at a superficial velocity sufficient to reduce the average size of the droplets.

### BRIEF DESCRIPTION OF THE DRAWINGS

In the annexed drawings, like parts and features have like references.

FIG. 1 is a schematic illustration of a microchannel that may be used in the inventive process.

FIG. 2 is a schematic illustration of an emulsion process unit wherein a first liquid and a second liquid may be combined to form an emulsion in accordance with the invention, the emulsion process unit comprising a microchannel core section comprising a plurality of process microchannels, a header for distributing fluid to the microchannel core section, and a footer for removing fluids from the microchannel core section.

FIG. 3 is a schematic illustration of an alternate embodiment of the emulsion process unit illustrated in FIG. 2 wherein a heat exchange fluid flows through the microchannel core section and exchanges heat with the first liquid, second liquid and/or product emulsion.

FIG. 4 is a schematic illustration of a microchannel repeating unit that may be used in the emulsion process unit illustrated in FIG. 2 or FIG. 3 wherein the first liquid flows in a process microchannel and is mixed with a second liquid that flows into the process microchannel from an adjacent liquid channel, the second liquid flowing through an apertured section in a side wall of the process microchannel.

FIG. 5 is a schematic illustration of an alternate embodiment of the microchannel repeating unit illustrated in FIG. 4 wherein a heat exchange channel is adjacent to the process microchannel.

FIG. 6 is a schematic illustration of a microchannel repeating unit that may be used in the emulsion process unit illustrated in FIG. 2 or FIG. 3 wherein the first liquid flows in a process microchannel and is mixed with a second liquid that flows into the process microchannel from an adjacent liquid channel, the second liquid flowing through an apertured section in a sidewall of the process microchannel, the liquid channel containing a plurality of internal zones positioned along the axial length of the liquid channel for controlling the pressure differential across the apertured section.

FIG. 7 is a schematic illustration of an alternate embodiment of the microchannel repeating unit illustrated in FIG. 6 wherein a heat exchange channel is adjacent to the process microchannel.

FIG. 8 is a schematic illustration of a microchannel repeating unit that may be used in the emulsion process unit illustrated in FIG. 2 or FIG. 3 wherein the first liquid flows through a process microchannel and is mixed with the second liquid that flows into the process microchannel from an adjacent liquid channel, the second liquid flowing through an apertured section in a sidewall of the process microchannel, the liquid channel containing a plurality of flow restriction devices to reduce the internal pressure within the liquid channel along the axial length of the liquid channel.

FIG. 9 is a schematic illustration of an alternate embodiment of the microchannel repeating unit illustrated in FIG. 8 wherein a heat exchange channel is adjacent to the process microchannel.

FIG. 10 is a scanning electron microscopic (SEM) image of a porous stainless steel substrate which may be used to form an apertured section in one or more sidewalls of the process microchannel that may be used in the inventive process, the SEM image being taken before the substrate is heat treated.

FIG. 11 is an SEM image of the substrate illustrated in FIG. 10 after being heat treated.

FIG. 12 is an SEM image of a tailored porous substrate which may be used to form an apertured section in one or more sidewalls of a process microchannel that may be used in the inventive process.

FIG. 13 is a plan view of an apertured sheet which may be is used to form an apertured section in one or more sidewalls of a process microchannel that may be used in the inventive process.

FIG. 14 is a plan view of an apertured sheet or plate which may be used to form an apertured section in one or more sidewalls of a process microchannel that may be used in the inventive process.

FIG. 15 is a schematic illustration of a relatively thin apertured sheet overlying a relatively thick apertured sheet or plate which may be used to form an apertured section in one or more sidewalls of a process microchannel that may be used in the inventive process.

FIG. 16 is a schematic illustration of a relatively thin apertured sheet overlying a relatively thick apertured sheet or plate which may be used to form an apertured section in one or more sidewalls of a process microchannel that may be used in the inventive process.

FIG. 17 is a schematic illustration of an aperture that may be used in an apertured section in one or more sidewalls of a process microchannel that may be used in the inventive process, the aperture being partially filled by a coating material.

FIG. 18 is a schematic illustration showing the formation of droplets during the operation of one embodiment of the inventive process.

FIG. 19 is a schematic illustration of an emulsion process unit that may be used for conducting the inventive process.

FIG. 20 is a schematic illustration of a liquid channel insert for the emulsion process unit illustrated in FIG. 19.

FIG. 21 is a schematic illustration of a liquid channel and an apertured section for use in the emulsion process unit illustrated in FIG. 19.

FIG. 22 is a schematic illustration of a liquid channel, an apertured section, and a process microchannel for use in the emulsion process unit illustrated in FIG. 19.

FIG. 23 is a schematic illustration of an alternate embodiment of the liquid channel, apertured section and process microchannel illustrated in FIG. 22, wherein four process microchannels are used in combination with the liquid channel and apertured section.

FIG. 24 is a schematic illustration showing the formation of a droplet during the operation of one embodiment of the inventive process.

FIG. 25 is a plot of shear response for an oil-in-water emulsion made in accordance with one embodiment of the inventive process wherein a surfactant is present in the emulsion.

FIG. 26 is a plot showing a comparison of axial velocity profiles versus distance from an apertured section in a process microchannel for a Newtonian fluid (Water) and a non-Newtonian fluid (hand cream emulsion) made in accordance with one embodiment of the inventive process.

FIG. 27 is a plot showing a rheogram (viscosity as a function shear for constant temperature) for an emulsion made in accordance with one embodiment of the inventive process.

FIGS. 28-31 are plots showing profiles of velocity (FIG. 28), shear stress (FIG. 29), shear rate (FIG. 30) and viscosity (FIG. 31) across the height or width (gap) of a process microchannel used in one embodiment of the inventive process.

FIGS. 32 and 33 are magnified images of an emulsion made in accordance with one embodiment of the inventive process.

FIG. 34 is a force diagram of an emulsion droplet made in accordance with one embodiment of the inventive process.

FIG. 35 is a plot that shows a comparison of successive force balance models to experimental data, the plot showing droplet detachment diameter as a function of pore size in an apertured section of a process microchannel for flow conditions in accordance with one embodiment of the inventive process.

FIG. 36 is a microscopic photo of a laser drilled substrate plate that may be used to form an apertured section in one or more sidewalls of a process microchannel that may be used in the inventive process.

FIG. 37 is a plot showing measured viscosity used as input for a computational functional dynamics (CFD) model in accordance with one embodiment of the inventive process.

FIG. 38 is a schematic illustration showing the CFD model domain and three-dimensional geometry.

FIG. 39 is a schematic illustration showing details of an emulsion process unit that may be used in the inventive process.

FIG. 40 shows a flow velocity profile comparison for the emulsion process unit illustrated in FIG. 39. The plot in FIG. 40A is for the channel with support slots on the emulsification surfaces. The plot in FIG. 40B is for the channel without slots. The plot in FIG. 40C is for a selected slice flow region without slots and without inlet effect.

FIG. 41 is an illustration showing the results of droplet formation in accordance with the inventive process at 5 ml/min oil flow rate and 0.001 N/m surface tension.

FIG. 42 is an illustration showing the results of droplet formation in accordance with the inventive process at 30 ml/min oil flow rate and 0.001 N/m surface tension.

FIG. 43 is an illustration showing the results of droplet formation in accordance with the inventive process at 5 ml/min oil flow rate and 0.02 N/m surface tension.

FIGS. 44-49 show the progression of droplet formation in accordance with the inventive process from inception of detachment (FIG. 44), extension of droplet (FIG. 45), complete detachment (FIG. 46), downstream advection of droplet (FIG. 47), breakup of droplet (bifurcation) (FIG. 48), and diffusion of droplet into a continuous phase (FIG. 49).

FIG. 50 is a plot showing the impact of cross flow velocity on droplet size for apertured sections used in a process microchannel in accordance with the inventive process having pore sizes of 7 microns, 4 microns, 1 micron and 0.1 micron wherein the surface tension is 0.02 Newtons per meter (N/m).

FIG. 51 is a plot showing the impact of wall shear stress on droplet size for apertured sections used in a process microchannel in accordance with the inventive process having pore sizes of 4 microns, 1 micron and 0.1 micron wherein cross flow velocity is 1.67 meters per section (m/s) and the surface tension of 0.02 N/m.

FIG. 52 is a plot showing the impact of surface tension on droplet size for apertured sections used in a process microchannel in accordance with the inventive process having pore sizes of 4 microns, 1 micron and 0.1 micron.

FIG. 53 is a plot showing droplet size distributions for test runs performed in a process microchannel having the construction illustrated in FIG. 39.

FIGS. 54-58 are schematic illustrations of surface features that may be formed in channels (e.g., process microchannels, liquid channels, heat exchange channels) used in the inventive process.

FIG. 59 is a schematic illustration of a process used in accordance with one embodiment of the invention wherein the droplet size of the dispersed phase of the emulsion is controlled by controlling pressure within the emulsion process unit.

FIGS. 60 and 61 are schematic illustrations of one embodiment of the inventive process wherein the pressure along the axial length of a process microchannel having an apertured section in one of its sidewalls is controlled.

FIGS. 62-64 are schematic illustrations of an apparatus that may be used in accordance with one embodiment of the invention, the apparatus comprising an apertured tubular section forming the sidewalls of a liquid channel, an array of process microchannels positioned on the outside surface of the apertured tubular section and extending lengthwise in the same axial direction as the apertured tubular section, and an array of heat exchange channels adjacent to the process microchannels, the continuous phase of the emulsion flowing through the process microchannels, the dispersed phase of the emulsion flowing from the liquid channel through the apertured section into the process microchannels to form the emulsion, and the heat exchange channels providing heating or cooling of the emulsion.

FIGS. 65 and 66 are schematic illustrations of apertured sheets that may overlie one another and be used to form an apertured section in one or more sidewalls of a process microchannel that may be used in the inventive process.

FIG. 67 illustrates three apertured parallel plates which may be used to form an apertured section in one or more sidewalls of a process microchannel that may be used in the inventive process, the apertured plates being moveable relative to one another to control the droplet size of the dispersed phase.

FIGS. 68 and 69 are microphotographs at a magnification of 400× of a laser drilled disk plated with platinum using an electroless plating process, the platinum plating reducing the size of the apertures in the disks, the disks being useful for forming apertured sections in one or more sidewalls of a process microchannel that may be used in the inventive process.

FIGS. 70 and 71 are schematic illustrations of surface features that may be formed on an apertured section used in one or more sidewalls of a process microchannel that may be used in the inventive process.

FIG. 72 is a schematic illustration showing droplets flowing through an apertured section in one or more sidewalls of a process microchannel that may be used in the inventive process, the apertured section having surface features, the surface features being illustrated in FIG. 70.

FIG. 73 is a schematic illustration showing droplets of deionized water forming on the surface of a material that may be used in making the interior walls of a process microchannel that may be used in the inventive process, the droplet on the left side being formed on a sample of uncoated stainless steel and the droplet on the right side being formed on a sample of stainless steel coated with a lipophobic coating material.

FIG. 74 is a schematic illustration of one embodiment of the inventive process wherein- the continuous phase flows in contact with an impinges on an apertured section (or substrate), and the dispersed phase flows through the apertured section (or substrate) into contact with the continuous phase to form the emulsion.

FIG. 75 is a schematic illustration of one embodiment of the inventive process wherein the dispersed phase is wicked (i.e., a superficial flow is induced) via capillary action through an a porous or fibrous membrane which functions as an apertured section, and small jets are fabricated normal to the faces of a substrate separating a channel from a process microchannel, the continuous phase flow is locally accelerated through the jet pore and detaches very small droplets of dispersed phase flowing through the membrane into the jet channel.

FIG. 76 is a schematic illustration of the process illustrated in FIG. 74 wherein a jet (not shown in the drawing) is used to introduce the continuous phase into impinging contact with the apertured section at any desired angle.

FIG. 77 is a schematic illustration of the inventive process wherein an apertured section is employed in one sidewall of the process microchannel and the opposite sidewall of the process microchannel is in the form of a ramped channel having a tiered or layered surface.

FIG. 78 is a schematic illustration of a process microchannel similar to the process microchannel illustrated in FIG. 77 with the exception that the apertured section or substrate is fabricated with a wavy or corrugated topology.

FIG. 79 is a schematic illustration of a process for making an emulsion employing a microcyclone wherein a continuous phase stream is introduced tangentially into a cylindrical cavity, a vortex finder is used to force a rotating flow around the cylindrical cavity, and the dispersed phase is introduced into the cylindrical cavity through an apertured section (or porous material) in the sidewall of the cylindrical cavity.

FIG. 80 is a schematic illustration of an alternate embodiment of the microcyclone illustrated in FIG. 79 wherein the continuous phase is introduced into an annular region of a shell and tube design and rotates with a high angular velocity, the dispersed phase flows axially down the length of a substrate positioned in a hollow cylinder with the apertures pointing radially outward from the centerline access.

FIG. 81 is a schematic illustration of a microcyclone for making an emulsion similar to the microcyclone illustrated in FIG. 80 with the exception that the inner apertured section or substrate rotates radially in the opposite direction of the annular flow of the continuous phase.

FIG. 82 is a schematic illustration of the inventive process wherein the dispersed phase flows through an apertured section or substrate that contains small posts with capillary pores for injecting the dispersed phase into the continuous phase.

FIG. 83 is a schematic illustration of a process for forming micro-sized droplets wherein both the continuous phase and the dispersed phase of the emulsion are dispersed in an inert gaseous medium (e.g., nitrogen) and then combined using impinging jets or static mixtures, the gas then being separated from the resulting product which is in the form of an emulsion.

FIG. 84 is a schematic illustration of an amulsion process unit for forming an emulsion employing the apertured parallel plates illustrated in FIG. 67, and a motor for providing the up and down motion of at least one of the plates relative to one or more of the other plates to create shear in the dispersed phase as the dispersed phase flows through the apertured plates into contact with the continuous phase.

FIGS. 85-87 are schematic illustrations of a method for reducing the droplet size of the dispersed phase of the emulsion formed in the inventive process using a rotating tool to cut the dispersed phase into small droplets after it is forced through an apertured section or porous plate, the dispersed phase then being combined with the continuous phase.

FIGS. 88, 89 and 96 are schematic illustrations of emulsion process units, each of the emulsion process units comprising a microchannel core section comprising the process microchannels used in the inventive process, a header for distributing fluid to the process microchannels, and a footer for removing fluid from the process microchannels.

FIGS. 90 and 91 are schematic illustrations of microchannel repeating units that can be used in the microchannel core section of the emulsion process units illustrated in FIGS. 88, 89 or 96.

FIG. 92 is a schematic illustration of a microchannel repeating unit that can be used in an emulsion process unit for making an emulsion pursuant to the inventive process.

FIG. 93 is a schematic illustration of an emulsion process unit for housing one or more of the microchannel repeating units illustrated in FIG. 92.

FIGS. 94 and 95 are plots showing droplet size distributions for test runs using the inventive emulsion process.

FIGS. 97-99 are schematic illustrations of rib designs for supporting an apertured section in one or more sidewalls of a process microchannel that may be used with the inventive process.

### DETAILED DESCRIPTION

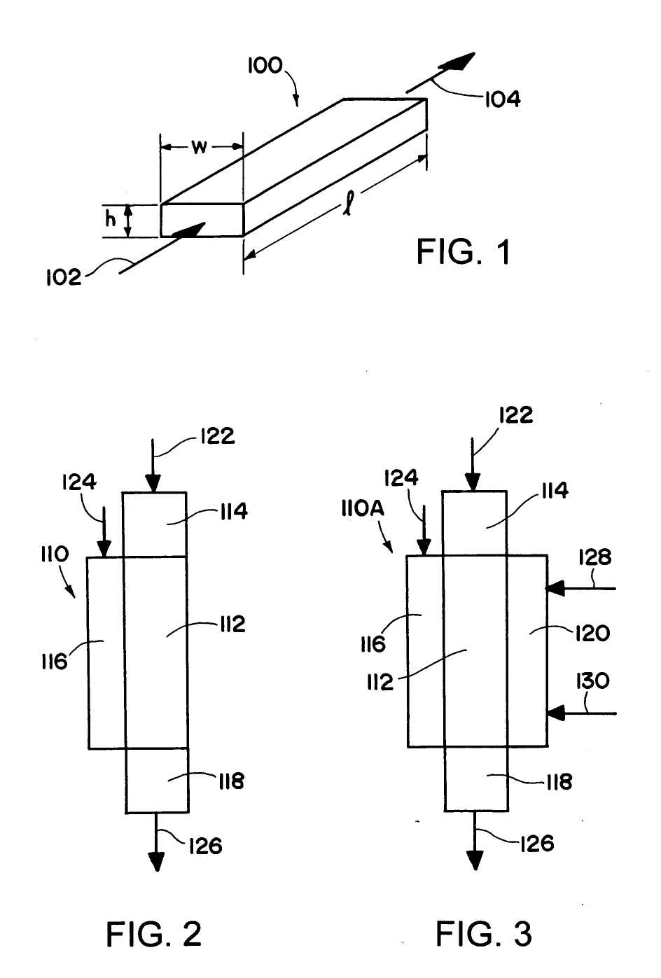

The term “microchannel” refers to a channel having at least one internal dimension of height or width of up to about 10 millimeters (mm), and in one embodiment up to about 5 mm, and in one embodiment up to about 2 mm, and in one embodiment up to about 1 mm. The bulk flow of fluid through the microchannel may proceed along the axial length of the microchannel normal to the height and width of the microchannel. An example of a microchannel that may be used with the inventive process is illustrated in FIG. 1. The microchannel 100 illustrated in FIG. 1 has a height (h), width (w) and axial length (I). The smallest of the height or width may sometimes be referred to as a gap. The bulk flow path of the liquid flowing in the microchannel 100 may be along the axial length of the microchannel in the direction indicated by arrows 102 and 104. The process microchannel that may be used in accordance with one embodiment of the invention may have at least one apertured section in one or more of its side walls; the axial length of the apertured section may be measured in the same direction as the axial length of the process microchannel. The height (h) or width (w) of the microchannel may be in the range of about 0.05 to about 10 mm, and in one embodiment about 0.05 to about 5 mm, and in one embodiment about 0.05 to about 2 mm, and in one embodiment about 0.05 to about 1.5 mm, and in one embodiment about 0.05 to about 1 mm, and in one embodiment about 0.05 to about 0.75 mm, and in one embodiment about 0.05 to about 0.5 mm. The other dimension of height or width may be of any dimension, for example, up to about 3 meters, and in one embodiment about 0.01 to about 3 meters, and in one embodiment about 0.1 to about 3 meters. The axial length (I) of the microchannel may be of any dimension, for example, up to about 10 meters, and in one embodiment in the range from about 0.05 to about 10 meters, and in one embodiment about 0.1 to about 10 meters, and in one embodiment from about 0.2 to about 6 meters, and in one embodiment from 0.2 to about 3 meters. Although the microchannel 100 illustrated in FIG. 1 has a cross section that is rectangular, it is to be understood that the microchannel may have a cross section having any shape, for example, a square, circle, semi-circle, trapezoid, etc. The shape and/or size of the cross section of the microchannel may vary over its length. For example, the height or width may taper from a relatively large dimension to a relatively small dimension, or vice versa, over the length of the microchannel.

The phrase “maintaining the flow of the second liquid through the apertured section at a rate that is substantially constant along the length of the apertured section” means that the flow rate of the second liquid through the apertured section at any point along the length of the apertured section may vary by no more than about 25% by volume, and in one embodiment no more than about 20% by volume, and in one embodiment no more than about 15% by volume, and in one embodiment no more than about 10% by volume, and in one embodiment no more than about 5% by volume, and in one embodiment no more than about 2% by volume, and in one embodiment no more than about 1% by volume, and in one embodiment no more than about 0.5% by volume, from the flow rate at any other point along the length of the apertured section.

The phrase “the pressure drop for the first liquid flowing through the process microchannel being substantially the same as the pressure drop for the second liquid flowing in the liquid channel” means that the pressure drop for the first liquid flowing through the process microchannel may vary by no more than about 25%, and in one embodiment no more than about 20%, and in one embodiment no more than about 15%, and in one embodiment no more than about 10%, and in one embodiment no more than about 5%, and in one embodiment no more than about 2%, and in one embodiment no more than about 1%, and in one embodiment no more than about 0.5%, from the pressure drop for the second liquid flowing in the liquid channel.

The phrase “a pressure differential across the apertured section that is substantially constant along the length of the apertured section” means that the pressure differential across the apertured section at any point along the axial length of the apertured section may vary by no more than about 50%, and in one embodiment no more than about 25%, and in one embodiment no more than about 10%, and in one embodiment no more than about 5%, and in one embodiment no more than about 2%, and in one embodiment no more than about 1%, and in one embodiment no more than about 0.5%, from the pressure differential at any other point along the length of the apertured section.

The term “adjacent” when referring to the position of one channel relative to the position of another channel means directly adjacent such that a wall separates the two channels. The wall may vary in thickness. However, “adjacent” channels are not separated by an intervening channel that would interfere with heat transfer between the channels.

The term “surface feature” refers to a depression in a channel wall and/or a projection from a channel wall that modifies flow and/or enhances mixing within the channel. The surface features may be in the form of circles, oblongs, squares, rectangles, checks, chevrons, wavy shapes, and the like. The surface features may contain sub features where the major walls of the surface features further contain smaller surface features that may take the form of notches, waves, indents, holes, burrs, checks, scallops, and the like. The surface features have a depth, a width, and for non-circular surface features a length. Examples are illustrated in FIGS. 54-58. The surface features may be formed on or in one or more of the interior side walls of the process microchannels used in the inventive process. The surface features may be formed on or in one or more of the interior side walls of the liquid channels and/or heat exchange channels used in the inventive process. The surface features may be referred to as passive surface features or passive mixing features.

The term “superficial velocity” for the velocity of a fluid flowing in a channel refers to the volumetric flow rate at standard pressure and temperature divided by the open cross sectional area of the channel.

The term “immiscible” refers to one liquid not being soluble in another liquid or only being soluble to the extent of up to about 1 milliliter per liter at 25° C.

The term “water insoluble” refers to a material that is insoluble in water at 25° C., or soluble in water at 25° C. up to a concentration of about 0.1 gram per liter.

The term “fluid” refers to a gas, a liquid, a gas or a liquid containing dispersed solids, a gas containing liquid droplets, a liquid containing gas bubbles, a gas containing liquid droplets and dispersed solids, or a liquid containing gas bubbles and dispersed solids.

The terms “upstream” and “downstream” refer to positions within the channels, including microchannels, used in the inventive process that are relative to the direction of flow of liquid through the channels. For example, a position within a channel not yet reached by a portion of a liquid flowing through that channel toward that position would be downstream of that portion of the liquid. A position within a channel already passed by a portion of the liquid flowing through that channel away from that position would be upstream of that portion of the liquid. The terms “upstream” and “downstream” do not necessarily refer to a vertical position since the channels used in the inventive process may be oriented horizontally, vertically, or at an inclined angle.

The term “heat source” refers to a substance or device that gives off heat and may be used to heat another substance or device. The heat source may be in the form of a heat exchange channel having a heat exchange fluid in it that transfers heat to another substance or device; the another substance or device being, for example, a channel that is adjacent to or sufficiently near the heat exchange channel to receive heat transferred from the heat exchange channel. The heat exchange fluid may be contained in the heat exchange channel and/or it may flow through the heat exchange channel. The heat source may be in the form of a heating element, for example, an electric heating element or a resistance heater.

The term “heat sink” refers to a substance or device that absorbs heat and may be used to cool another substance or device. The heat sink may be in the form of a heat exchange channel having a heat exchange fluid in it that receives heat transferred from another substance or device; the another substance or device being, for example, a channel that is adjacent to or sufficiently near the heat exchange channel to transfer heat to the heat exchange channel. The heat exchange fluid may be contained in the heat exchange channel and/or it may flow through the heat exchange channel. The heat sink may be in the form of a cooling element, for example, a non-fluid cooling element.

The term “heat source and/or heat sink” refers to a substance or a device that may give off heat or absorb heat. The heat source and/or heat sink may be in the form of a heat exchange channel having a heat exchange fluid in it that transfers heat to another substance or device adjacent to or near the heat exchange channel when the another substance or device is to be heated, or receives heat transferred from the another substance or device adjacent to or near the heat exchange channel when the another substance or device is to be cooled. The heat exchange channel functioning as a heat source and/or heat sink may function as a heating channel at times and a cooling channel at other times. A part or parts of the heat exchange channel may function as a heating channel while another part or parts of the heat exchange channel may function as a cooling channel.

The term “heat exchange channel” refers to a channel having a heat exchange fluid in it that may give off heat and/or absorb heat.

The term “heat exchange fluid” refers to a fluid that may give off heat and/or absorb heat.

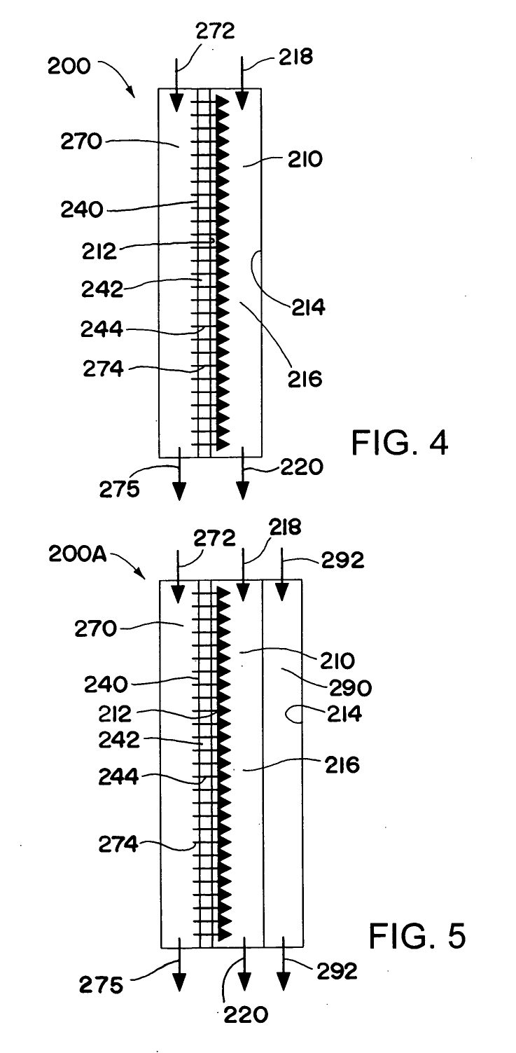

Referring to FIGS. 2 and 3, the process may be conducted using emulsion process unit 110 which includes microchannel core section 112, first liquid header 114, second liquid header 116, and product footer 118. The emulsion process unit 110A illustrated in FIG. 3 is the same as the emulsion process unit 110 illustrated in FIG. 2 except that the emulsion process unit 110A includes heat exchange manifold 120. The microchannel core section 112 in the emulsion process unit 110 contains a plurality of process microchannels and adjacent liquid channels. The microchannel core section 112 in emulsion process unit 110A is the same as the microchannel core section 112 in emulsion process unit 110 except that the microchannel core section 112 in emulsion process unit 110A includes a plurality of heat exchange channels. The liquid channels and/or heat exchange channels may be microchannels. The process microchannels, liquid channels and optionally heat exchange channels may be aligned in layers, one above the other, or side by side. The first liquid header 114 may provide a passageway for the first liquid to flow into the process microchannels with an even or substantially even distribution of flow to the process microchannels. The term “substantially even” is used herein to refer to a quality index of less than about 25%. Quality index is disclosed in U.S. Patent Publication US 2005/0087767 A1, which is incorporated herein by reference. The second liquid header 116 provides a passageway for the second liquid to flow into the liquid channels with an even or substantially even distribution of flow to the liquid channels. The product footer 118 provides a passageway for the product emulsion to flow from the process microchannels in a rapid manner with a relatively high rate of flow. The first liquid flows into the emulsion process unit 110 or 110A through the header 114, as indicated by arrow 122. The second liquid flows into the emulsion process unit 110 or 110A through the second liquid header 116, as indicted by arrow 124. The first liquid and the second liquid flow into the microchannel core section 112 and are mixed to form the product emulsion. The product emulsion flows from the microchannel core section 112 through the product footer 118, and out of product footer 118, as indicated by arrow 126. In one embodiment, the emulsion may be recycled back through the microchannel core section 112 any number of times, for example, one, two, three, four times, etc. With the emulsion process unit 110A a heat exchange fluid flows into heat exchange manifold 120, as indicated by arrow 128, and from heat exchange manifold 120 through the heat exchange channels in the microchannel core section 112 and then back to the heat exchange manifold 120, and out of heat exchange manifold 120, as indicated by arrow 130. The emulsion process units 110 and 110A may be employed in conjunction with storage vessels, pumps, valves, flow control devices, and the like, which are not shown in the drawings, but would be apparent to those skilled in the art. The microchannel core section 112 may comprise one or a plurality of microchannel repeating units. Useful embodiments of the microchannel repeating units are illustrated in FIGS. 4-9.

Referring to FIG. 4, microchannel repeating unit 200 comprises process microchannel 210, apertured section 240 and liquid channel 270. Process microchannel 210 has opposite sidewalls 212 and 214. Apertured section 240 is in sidewall 212. The apertured section 240 may be referred to as a porous section or porous substrate. The apertured section 240 may comprise a sheet or plate 242 having a plurality of apertures 244 extending through it. Additional embodiments of the apertured section 240 are discussed in detail below. The liquid channel 270 opens to process microchannel 210 through apertured section 240. The liquid channel 270 is a flow-through channel with an outlet indicated at arrow 275. The process microchannel 210 has mixing zone 216, and may have non-apertured regions (not shown in the drawings) upstream and/or downstream from mixing zone 216. The mixing zone 216 is adjacent to the apertured section 240. In one embodiment, the mixing zone 216 may have a restricted cross section to enhance mixing. In operation, the first liquid flows into process microchannel 210, as indicated by directional arrow 218, and into the mixing zone 216. A second liquid flows into liquid channel 270, as indicated by arrow 272, and then flows through apertured section 240, as indicated by arrows 274, into the mixing zone 216. In mixing zone 216, the second liquid contacts and mixes with the first liquid to form an emulsion. The second liquid may form a discontinuous phase or droplets within the first liquid. The first liquid may form a continuous phase. The emulsion flows from the mixing zone 216 out of the process microchannel 210, as indicated by arrow 220. In one embodiment, part of the second liquid may flow through the liquid channel 270, as indicated by arrow 275, and be recycled back to the second liquid header 116, while the remainder of the second liquid flows through the apertured section 240, as discussed above. The emulsions that may be formed include water-in-oil emulsions, oil-in-water emulsions, and the like. The emulsions that may be formed are discussed in greater detail below. Heating or cooling may be optional.

In one embodiment, the liquid flowing through the process microchannel 210 undergoes a pressure drop as it flows from the process microchannel inlet to the process microchannel outlet. As a result of this pressure drop the internal pressure within the process microchannel 210 progressively decreases from a high point near the process microchannel inlet to a low point near the process microchannel outlet. In order to produce emulsion droplets that are relatively uniform in size, it may be desirable, at least in one embodiment of the invention, to maintain a substantially constant pressure differential across the apertured section 240 along the axial length of the apertured section 240. In order to do this, the internal pressure within the liquid channel 270 may be reduced along its axial length to match the drop in internal pressure in the process microchannel 210 as a result of the pressure drop resulting from the flow of liquid through the process microchannel. This may be done by providing the liquid channel 270 in the form of a microchannel such that the second liquid flowing in the liquid channel undergoes a pressure drop similar to the pressure drop for the liquid flowing through the process microchannel 210.

In one embodiment, the apertured section 240 may comprise a plurality of discrete feed introduction points rather than a continuous introduction of the second liquid along the axial length of the apertured section. The number of discrete feed introduction points may be any number, for example, two, three, four, five six, seven, eight, 10, 20, 50, 100, etc.

The microchannel repeating unit 200A illustrated in FIG. 5 is the same as the microchannel repeating unit 200 illustrated in FIG. 4 except that the microchannel repeating unit 200A includes heat exchange channel 290. When heating or cooling is desired, heat exchange fluid flows through the heat exchange channel 290, as indicated by arrows 292, and heats or cools the liquids in the process microchannel 210 and liquid channel 270. The degree of heating or cooling may vary over the axial length of the process microchannel 210 and liquid channel 270. The heating or cooling may be negligible or non-existent in some sections of the process microchannel 210 and liquid channel 270, and moderate or relatively high in other sections. The flow of heat exchange fluid in the heat exchange channel 290 as indicated by arrows 292 is cocurrent with the flow of liquid through the process microchannel 210. Alternatively, the heat exchange fluid may flow in a direction that is countercurrent or cross current relative to the flow of liquid in the process microchannel 210. Alternatively, the heating or cooling may be effected using heating or cooling mediums other than a heat exchange fluid. For example, heating may be effected using an electric heating element. Cooling may be effected using a non-fluid cooling element. The electric heating element and/or non-fluid cooling element may be used to form one or more walls of the process microchannel 210 and/or liquid channel 270. The electric heating element and/or non-fluid cooling element may be built into one or more walls of the process microchannel 210 and/or liquid channel 270. Multiple heating or cooling zones may be employed along the axial length of the process microchannel 210. Similarly, multiple heat exchange fluids at different temperatures may be employed along the length of the process microchannel 210.

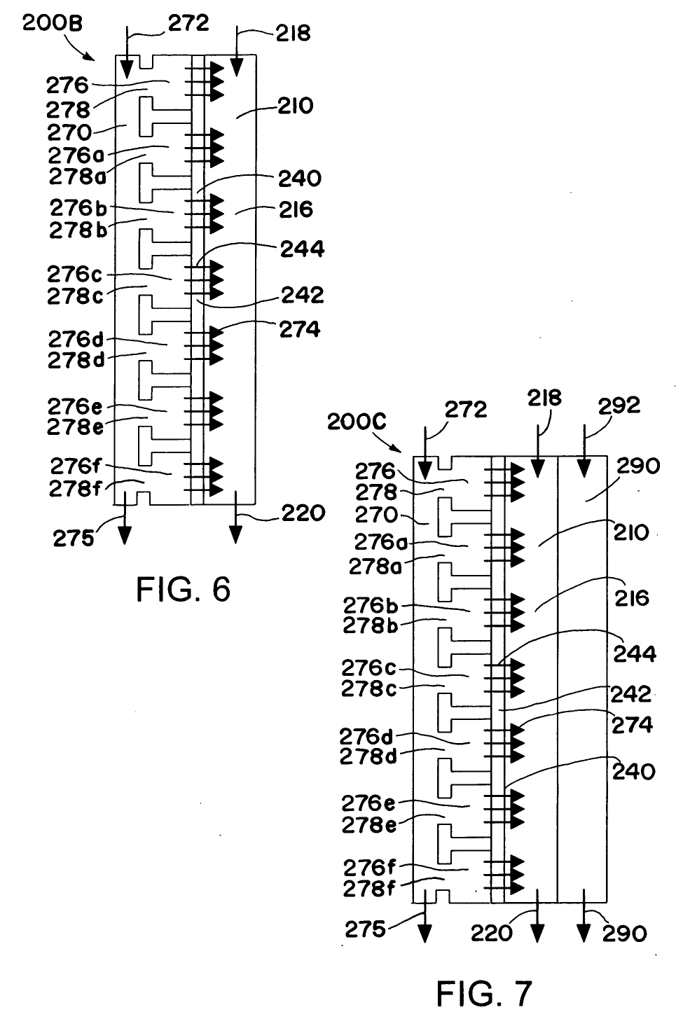

The microchannel repeating unit 200B illustrated in FIG. 6 is the same as the microchannel repeating unit 200 illustrated in FIG. 4 with the exception that the liquid channel 270 in microchannel repeating unit 200B includes internal zones 276, 276a, 276b, 276c, 276d, 276e and 276f positioned along the axial length of the liquid channel 270. These internal zones have restricted openings 278, 278a, 278b, 278c, 278d, 278e and 278f, respectively, separating them from the remainder of the liquid channel 270. The restricted openings may comprise any flow restriction device including passive or active flow restriction devices. These include orifices and the like. The restricted openings 278 through 278f may be the same or they may be progressively more restricted from restricted opening 278 through to restricted opening 278f. The internal zones 276, 276a, 276b, 276c, 276d, 276e and 276f open to the apertured section 240. Although seven internal zones are illustrated, it would be possible to employ any number of internal zones. The number of internal zones may be fewer than seven, for example, one, two, three, four, five or six internal zones. The number of internal zones may be more than seven, for example, eight, nine, ten, tens, hundreds, thousands, etc., internal zones along the axial length of the liquid channel 270. In operation, the first liquid flows into process microchannel 210, as indicated by arrow 218, and into the mixing zone 216. The second liquid flows into liquid channel 270, as indicated by arrow 272, and from liquid channel 270 through restricted openings 278, 278a, 278b, 278c, 278d, 278e and 278f, into internal zones 276, 276a, 276b, 276c, 276d, 276e and 276f, respectively. From the internal zones 276, 276a, 276b, 276c, 276d, 276e and 276f the second liquid flows through the apertured section 240, as indicated by arrows 274, into process microchannel 210 wherein it mixes with the first liquid to form the product emulsion. The product emulsion flows out of the process microchannel, as indicated by arrow 220. In one embodiment, the liquid flowing through the process microchannel 210 undergoes a pressure drop as it flows from the process microchannel inlet to the process microchannel outlet. As a result of this pressure drop the internal pressure within the process microchannel 210 progressively decreases from a high point near the process microchannel inlet to a low point near the process microchannel outlet. In order to produce emulsion droplets that are relatively uniform in size, it is desirable, at least in one embodiment of the invention, to maintain a substantially constant pressure differential across the apertured section 240 along the axial length of the apertured section 240. In order to do this, the internal pressure within the liquid channel 270 may be reduced along its axial length to match the drop in internal pressure in the process microchannel 210 as a result of the pressure drop resulting from the flow of liquid through the process microchannel. This may be done by providing progressively reduced internal pressures within the internal zones 276, 276a, 276b, 276c, 276d, 276e and 276f to match the pressure drop in the process microchannel 210. Thus, for example, the internal pressure within the internal zone 278 may be relatively high, the pressure within the next internal zone 278a may be lower, and the pressures in the subsequent internal zones 276b, 276c, 276d, 276e and 276f may be progressively lower with the lowest internal pressure being in the internal zone 276f. The progressively reduced pressures in the internal zones 276, 276a, 276b, 276c, 276d, 276e and 276f may be effected by the pressure drop in liquid channel 270 as a result of the flow of the second liquid in the liquid channel 270 in combination with the pressure drop resulting from the flow of the second liquid through the restricted openings 278, 278a, 278b, 278c, 278d, 278e and 278f.

The microchannel repeating unit 200C illustrated in FIG. 7 is the same as the microchannel repeating unit 200B illustrated in FIG. 6 except that the microchannel repeating unit 200C includes heat exchange channel 290. When heating or cooling is desired, heat exchange fluid flows through the heat exchange channel 290, as indicated by arrows 292, and heats or cools the liquids in the process microchannel 210 and liquid channel 270. The degree of heating or cooling may vary over the axial length of the process microchannel 210 and liquid channel 270. The heating or cooling may be negligible or non-existent in some sections of the process microchannel 210 and liquid channel 270, and moderate or relatively high in other sections. The flow of heat exchange fluid in the heat exchange channel 290, as indicated by arrows 292, is cocurrent with the flow of liquid through the process microchannel 210. Alternatively, the heat exchange fluid could flow in a direction that is countercurrent or cross current relative to the flow of liquid in the process microchannel 210. Alternatively, the heating or cooling can be effected using heating or cooling mediums other than a heat exchange fluid. For example, heating may be effected using an electric heating element. Cooling can be effected using a non-fluid cooling element. The electric heating element and/or non-fluid cooling element may be used to form one or more walls of the process microchannel 210 and/or liquid channel 270. The electric heating element and/or non-fluid cooling element may be built into one or more walls of the process microchannel 210 and/or liquid channel 270. Multiple heating or cooling zones may be employed along the axial length of the process microchannel 210. Similarly, multiple heat exchange fluids at different temperatures may be employed along the axial length of the process microchannel 210.

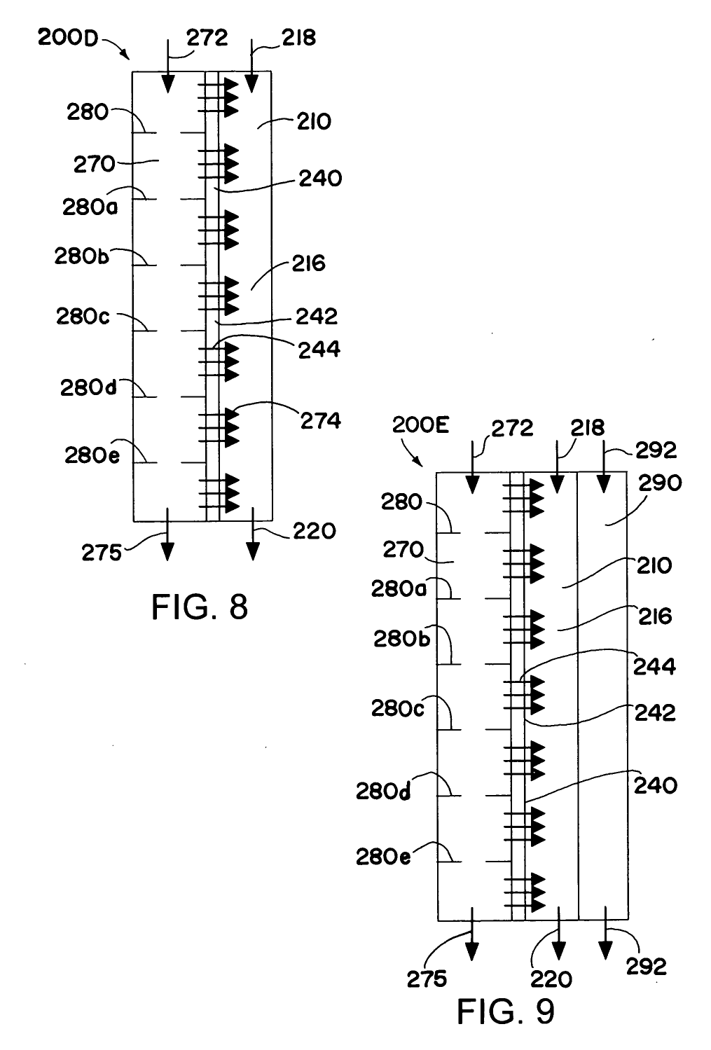

The microchannel repeating unit 200D illustrated in FIG. 8 is the same as the microchannel repeating unit 200 illustrated in FIG. 4 with the exception that the liquid channel 270 in microchannel repeating unit 200B includes internal flow restriction devices 280, 280a, 280b, 280c, 280d and 280e positioned along the axial length of the liquid channel 270. These flow restriction devices may comprise any flow restriction device including passive or active flow restriction devices. These include orifices and the like. The flow restriction devices may be the same or they may be progressively more restricted from flow restriction device 280 to flow restriction device 280e. Although six flow restriction devices are illustrated, it would be possible to employ any number of flow restriction devices. The number of flow restriction devices may be fewer than six, for example, one, two, three, four or five. The number of flow restriction devices may be greater than six, for example, seven, eight, nine, ten, tens, hundreds, thousands, etc., internal flow restriction devices along the length of the liquid channel 270. In operation, the first liquid flows into process microchannel 210, as indicated by arrow 218, and into the mixing zone 216. The second liquid flows into liquid channel 270, as indicated by arrow 272, and from liquid channel 270 through flow restriction devices 280, 280a, 280b, 280c, 280d and 280e. From the liquid channel 270 the second liquid flows through the apertured section 240, as indicated by arrows 274, into process microchannel 210 wherein it mixes with the first liquid to form the product emulsion. The product emulsion flows out of the process microchannel, as indicated by arrow 220. In one embodiment, the liquid flowing through the process microchannel 210 undergoes a pressure drop as it flows from the process microchannel inlet to the process microchannel outlet. As a result of this pressure drop the internal pressure within the process microchannel 210 progressively decreases from a high point near the process microchannel inlet to a low point near the process microchannel outlet. In order to produce emulsion droplets that are relatively uniform in size, it is desirable, at least in one embodiment of the invention, to maintain a substantially constant pressure differential across the apertured section 240 along the length of the apertured section 240. In order to do this, the internal pressure within the liquid channel 270 may be reduced along its length to match the drop in internal pressure in the process microchannel 210 as a result of the pressure drop resulting from the flow of liquid through the process microchannel. This may be done in liquid channel 270 by flowing the second liquid through the flow restriction devices 280, 280a, 280b, 280c, 280d and 280e. Thus, for example, the internal pressure within the liquid channel 270 upstream of the flow restriction device 280 may be relatively high, the pressure between the flow restriction devices 280 and 280a may be lower, and the pressures in the sections of the liquid channel 270 downstream of the flow restriction devices 280b, 280c, 280d and 280e may be progressively lower with the lowest internal pressure being downstream of the flow restriction device 280e.

The microchannel repeating unit 200E illustrated in FIG. 9 is the same as the microchannel repeating unit 200D illustrated in FIG. 8 except that the microchannel repeating unit 200A includes heat exchange channel 290. When heating or cooling is desired, heat exchange fluid flows through the heat exchange channel 290, as indicated by arrows 292, and heats or cools the liquids in the process microchannel 210 and liquid channel 270. The degree of heating or cooling may vary over the axial length of the process microchannel 210 and liquid channel 270. The heating or cooling may be negligible or non-existent in some sections of the process microchannel 210 and liquid channel 270, and moderate or relatively high in other sections. The flow of heat exchange fluid in the heat exchange channel 290, as indicated by arrows 292, is cocurrent with the flow of liquid through the process microchannel 210. Alternatively, the heat exchange fluid could flow in a direction that is countercurrent or cross current relative to the flow of liquid in the process microchannel 210. Alternatively, the heating or cooling can be effected using heating or cooling mediums other than a heat exchange fluid. For example, heating may be effected using an electric heating element. Cooling can be effected using a non-fluid cooling element. The electric heating element and/or non-fluid cooling element may be used to form one or more walls of the process microchannel 210 and/or liquid channel 270. The electric heating element and/or non-fluid cooling element may be built into one or more walls of the process microchannel 210 and/or liquid channel 270. Multiple heating or cooling zones may be employed along the axial length of the process microchannel 210. Similarly, multiple heat exchange fluids at different temperatures may be employed along the axial length of the process microchannel 210.

The apertured section (240) may be positioned in one or more sidewalls of the process microchannel (210). The apertured section may extend along part of or along the entire axial length of the process microchannel (210). In one embodiment, the apertured section may extend along at least about 1% of the axial length of the process microchannel, and in one embodiment at least about 5% of the axial length of the process microchannel, and in one embodiment at least about 10% of the axial length of the process microchannel, and in one embodiment at least about 20% of the axial length of the process microchannel, and in one embodiment at least about 35% of the axial length of the process microchannel, and in one embodiment at least about 50% of the axial length of the process microchannel, and in one embodiment at least about 65% of the axial length of the process microchannel, and in one embodiment at least about 80% of the axial length of the process microchannel, and in one embodiment at least about 95% of the axial length of the process microchannel, and in one embodiment from about 1% to about 100% of the axial length of the process microchannel, and in one embodiment from about 5% to about 100% of the axial length of the process microchannel, and in one embodiment from about 10% to about 90% of the axial length of the process microchannel, and in one embodiment from about 20% to about 80% of the axial length of the process microchannel. The apertured section may extend along part or all of the entire width and/or height of one or more of the sidewalls of the process microchannel.

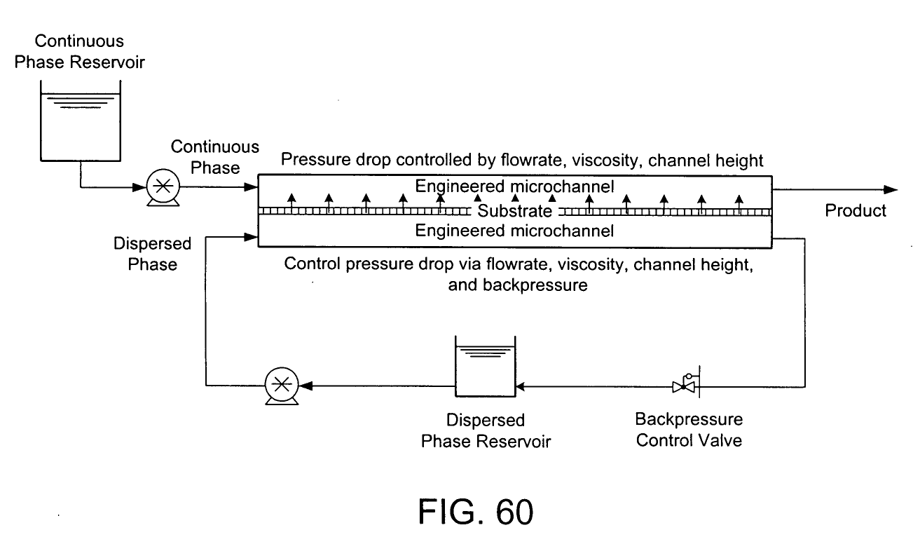

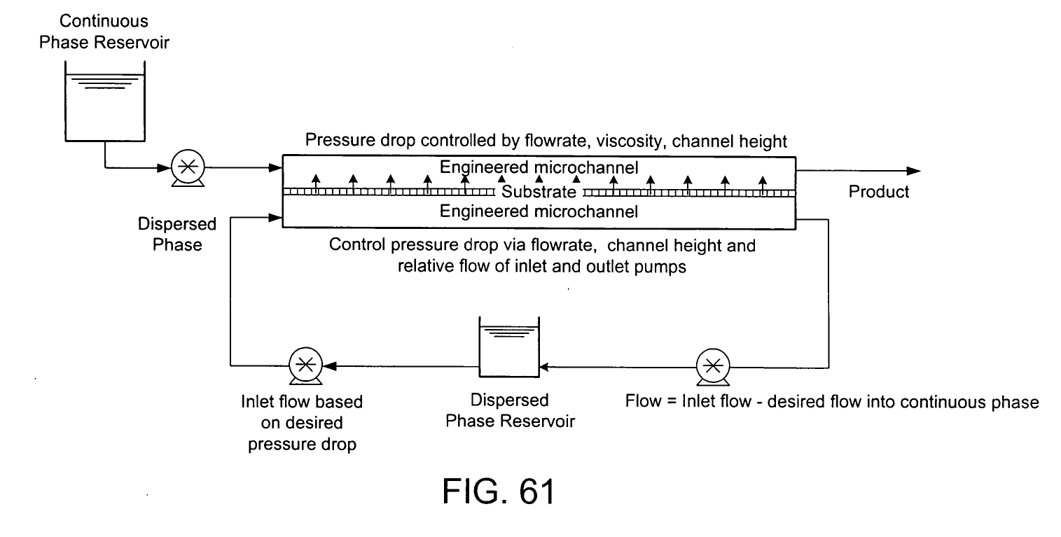

In one embodiment, the liquid channel 270 is a flow-through channel and the second liquid may exit the liquid channel as indicated by arrow 275 and be recirculated back into the liquid channel. This may allow additional options for controlling the overall differential pressure between the process microchannel 210 and the liquid channel 270 and also allow tailoring of the pressure profile along the axial length of the apertured section 240. Control of these two parameters may allow more flexibility in operating the inventive process. The flow of the second liquid through the apertured section 240 may be non-uniform along the axial length of the apertured section 240. This may be due to varying pressure differentials across the apertured section 240. For example, when a high viscosity first liquid is mixed with a low viscosity second liquid in the process microchannel 210, the viscosity of the liquid mixture along the axial length of the process microchannel 210 may become lower as the concentration of the second liquid in the resulting emulsion increases. This may result in a nonlinear pressure drop along the axial length of the apertured section 240. This may lead to higher rate of flow of the second liquid through the apertured section 240 near the exit of the liquid channel 270 than near the inlet. This may reduce the overall residence time of the mixed phases in the process microchannel and lead to larger emulsion droplet sizes than intended. The processes illustrated in FIGS. 60 and 61 may be used to establish a more uniform differential pressure along the axial length of the apertured section 240, and as a result a more uniform flow of the second liquid through the apertured section 240 into the process microchannel 210. The design concept includes a flow through system for the second liquid which may have a pressure control that is semi-independent from the process microchannel 210. This may allow designers and operators more options in tailoring the operation of the process to different fluids and apertured sections. The design involves two options. Option 1, which is illustrated in FIG. 60, uses a back pressure control valve to control the pressure of the second liquid (dispersed phase) leaving the device. The pressure drop profile along the length of the liquid channel may be determined by the flow rate and viscosity of the second liquid, the geometry of the liquid channel 270, and the inlet and back pressure imposed at the exit of the liquid channel. The quantity of the second liquid (dispersed phase) that flows across the apertured section 240 (substrate) may be dependent on the properties of the second liquid and the differential pressure along the axial length of the apertured section 240. This may be measured by weighing the second liquid (dispersed phase) reservoir during operation. Option 2, which is illustrated in FIG. 61, may allow a more precise method of delivering known quantities of the second liquid (dispersed phase) by using two high pressure positive displacement pumps to control the amount of dispersed phase entering and exiting the liquid channel 270.

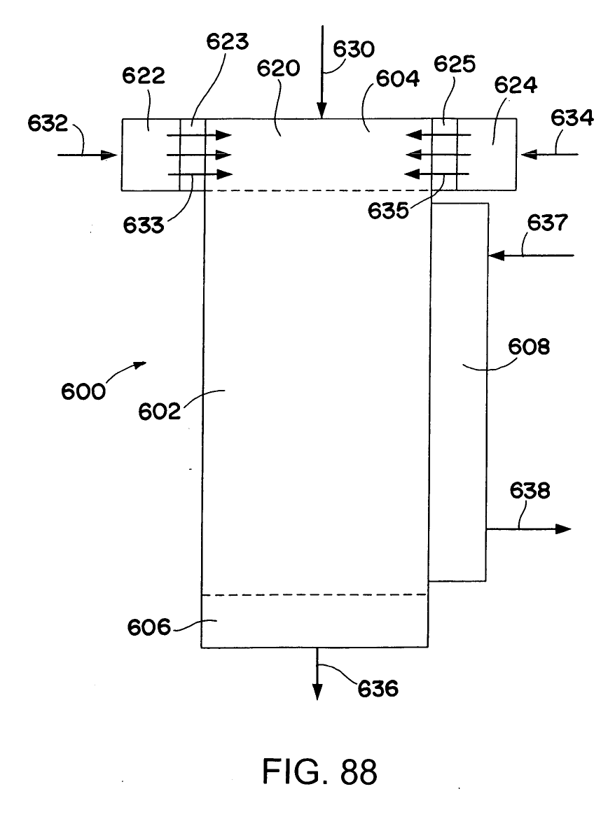

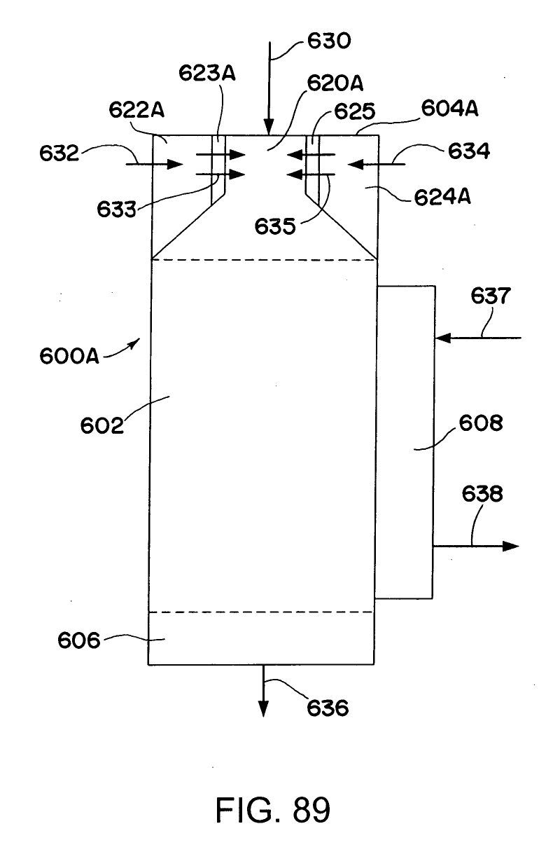

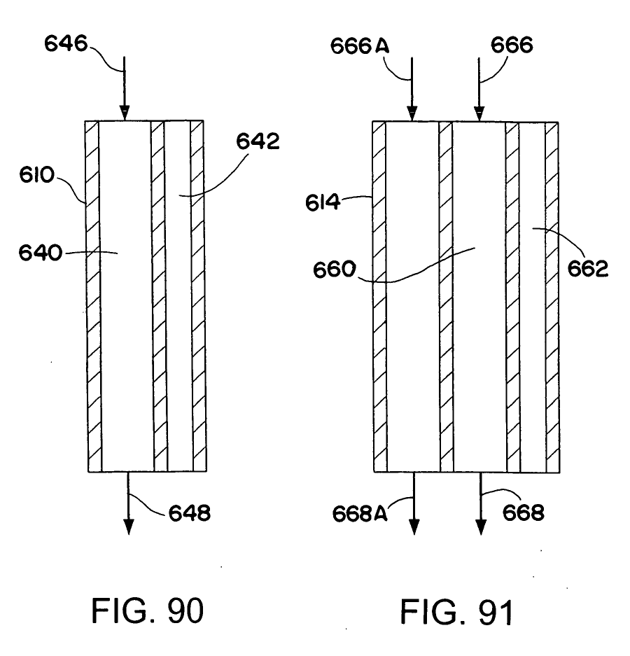

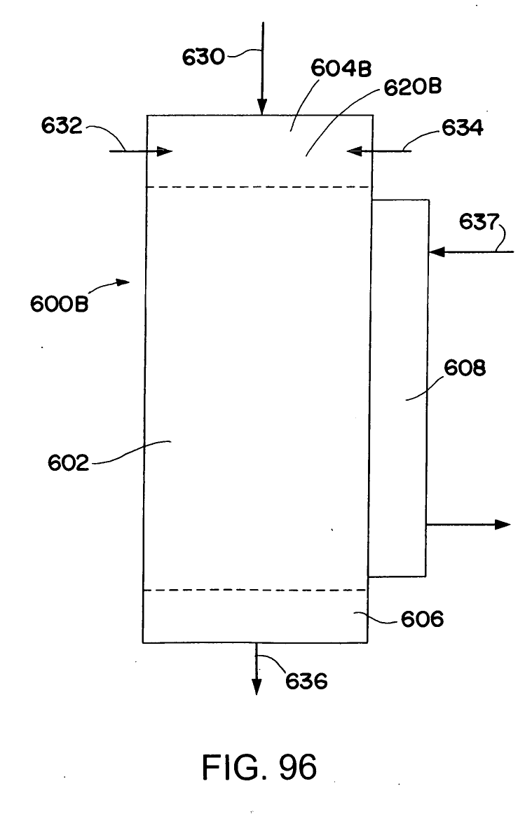

In one embodiment, the inventive process may be conducted in an emulsion process unit as illustrated, for example, in FIGS. 88-91 or 96. In this embodiment, the first liquid and second liquid are mixed in a feed stream header upstream of the process microchannel rather than in the process microchannel. Referring to FIG. 88, the process may be conducted using emulsion process unit 600, which includes microchannel core section 602, feed stream header 604, product footer 606 and heat exchange manifold 608. The emulsion process unit 600A illustrated in FIG. 89 is the same as the emulsion process unit 600 illustrated in FIG. 88 with the exception that the emulsion process unit 600A employs feed stream header 604A rather than feed stream header 604. The emulsion process unit 600B illustrated in FIG. 96 is the same as the emulsion process unit 600 illustrated in FIG. 88 with the exception that the emulsion process unit 600B employs feed stream header 604B rather than feed stream header 604. Feed stream headers 604, 604A and 604B are similar in design and operation. The design and operation of these headers is described in more detail below. The microchannel core section 602 in emulsion process units 600, 600A and 600B may contain one or more of the microchannel repeating units 610 and/or 614 illustrated in FIGS. 90 and 91, respectively.

Feed stream header 604 includes first liquid zone 620, second liquid zones 622 and 624, and apertured sections 623 and 625. Apertured section 623 is positioned between first liquid zone 620 and second liquid zone 622. Apertured section 625 is positioned between first liquid zone 620 and second liquid zone 624. Feed stream header 604A is similarly constructed and includes first liquid zone 620A, second liquid zones 622A and 624A, and apertured sections 623A and 625A.

In operation, the first liquid flows into the first liquid zone 620 as indicated by arrow 630. The second liquid flows into second liquid zones 622 and 624 as indicated by arrows 632 and 634, respectively. The second liquid flows from second liquid zone 622 through apertured section 623 into first liquid zone 620 as indicated by arrows 633. The second liquid also flows from second liquid zone 624 through apertured section 625 into first liquid zone 620 as indicated by arrows 635. In the first liquid zone 620, the second liquid disperses into the first liquid to form an emulsion. The emulsion that is formed in the first liquid zone 620 may have a continuous phase with the first liquid forming the continuous phase, and a dispersed phase with the second liquid forming the dispersed phase. The dispersed phase may be in the form of liquid droplets dispersed in the continuous phase. The emulsion flows through microchannel core section 602 where it is treated (i.e., heated, cooled and/or subjected to additional mixing). The emulsion flows into product footer 606 and out of the emulsion process unit 600 as indicated by arrow 636. Heat exchange fluid enters the heat exchange manifold 608, as indicated by arrow 637, circulates through the microchannel core section 602, returns to the heat exchange manifold 608, and exits the heat exchange manifold 608 as indicated by arrow 638.

The operation of emulsion process unit 600A is similar to that of emulsion process unit 600. The first liquid flows into the first liquid zone 620A as indicated by arrow 630. The second liquid flows into second liquid zones 622A and 624A as indicated by arrows 632 and 634, respectively. The second liquid flows from second liquid zone 622A through apertured section 623A into first liquid zone 620A as indicated by arrows 633. The second liquid also flows from second liquid zone 624A through apertured section 625A into first liquid zone 620A as indicated by arrows 635. In the first liquid zone 620, the second liquid disperses into the first liquid to form an emulsion. The emulsion that is formed in the first liquid zone 620 may have a continuous phase with the first liquid forming the continuous phase, and a dispersed phase with the second liquid forming the dispersed phase. The dispersed phase may be in the form of liquid droplets dispersed in the continuous phase. The emulsion flows through the reaction zone 602, and is treated (i.e., heated, cooled and/or subjected to additional mixing). The emulsion flows into product footer 606 and out of the emulsion process unit 600 as indicated by arrow 636. Heat exchange fluid enters the heat exchange manifold 608, as indicated by arrow 637, circulates through the microchannel core section 602, returns to the heat exchange manifold 608, and exits the heat exchange manifold 608 as indicated by arrow 638.

Feed stream header 604B comprises liquid zone 620B. In operation, a stream of the first liquid flows into liquid zone 620B as indicated by arrow 630. Streams of the second liquid flow into liquid zone 620B as indicated by arrows 632 and 634. The second liquid contacts the first and disperses into the first liquid to form an emulsion. In one embodiment, the second liquid may be injected into the first liquid using jets, spray devices, and the like. The emulsion that is formed in the liquid zone 620B may have a continuous phase with the first liquid forming the continuous phase, and a dispersed phase with the second liquid forming the dispersed phase. The dispersed phase may be in the form of liquid droplets dispersed in the continuous phase. The emulsion flows through microchannel core section 602 where it is treated (i.e., heated, cooled and/or subjected to additional mixing). The emulsion flows into product footer 606 and out of the emulsion process unit 600B as indicated by arrow 636. Heat exchange fluid enters the heat exchange manifold 608, as indicated by arrow 637, circulates through the microchannel core section 602, returns to the heat exchange manifold 608, and exits the heat exchange manifold 608 as indicated by arrow 638.

The emulsion process units 600, 600A and 600B may be used in combination with one or more storage vessels, pumps, valves, manifolds, microprocessors, flow control devices, and the like, which are not shown in the drawings, but would be apparent to those skilled in the art.

Microchannel repeating units that may be used in the microchannel core section 602 are illustrated in FIGS. 90 and 91. Referring to FIG. 90, repeating unit 610 comprises process microchannel 640 and heat exchange channel 642. The emulsion flows from the feed streams header 604, 604A or 604B into the process microchannel 640 as indicated by arrow 646. The emulsion is treated (i.e., heated, cooled and/or subjected to additional mixing) in the process microchannel 640. The emulsion flows out of the process microchannel 640 as indicated by arrow 648. Heat exchange fluid flows in heat exchange channel 642 and exchanges heat with the process microchannel 640. The exchange of heat between the heat exchange channel 642 and process microchannel 640 may result in a cooling and/or heating of the process microchannel 640. The heat exchange fluid may flow in the heat exchange channel 642 in a direction that is cocurrent, countercurrent or cross-current relative to the direction of flow of fluid in the process microchannel 640.

The repeating unit 614 illustrated in FIG. 91 is similar to the repeating unit 610 illustrated in FIG. 90 with the exception that the repeating unit 614 includes two process microchannels 660 and 660A rather than one process microchannel. Repeating unit 614 comprises process microchannels 660 and 660A and heat exchange channel 662. In operation, the emulsion flows into process microchannels 660 and 660A from feed streams header 604, 604A or 604B as indicated by arrows 666 and 666A, respectively. The emulsion flows through the process microchannels 660 and 660A and is treated (i.e., heated, cooled and/or subjected to additional mixing). The emulsion exits the repeating unit 614 as indicated by arrows 668 and 668A. The emulsion flows from the repeating unit 614 to and through the product footer 606 and out of the emulsion process unit 600, 600A or 600B as indicated by arrow 636.

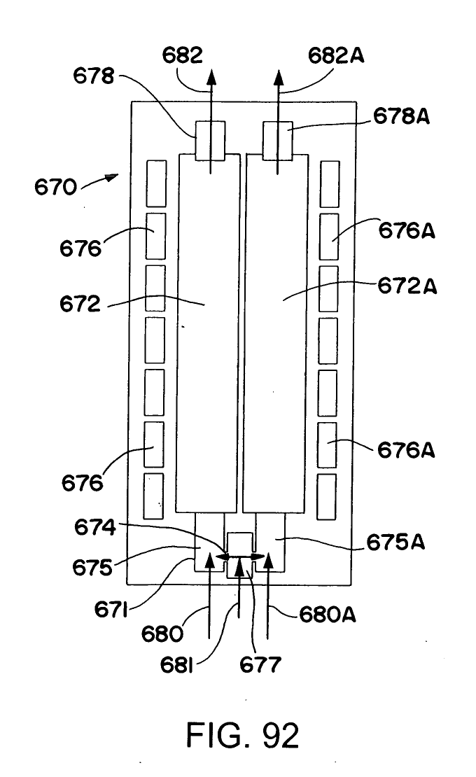

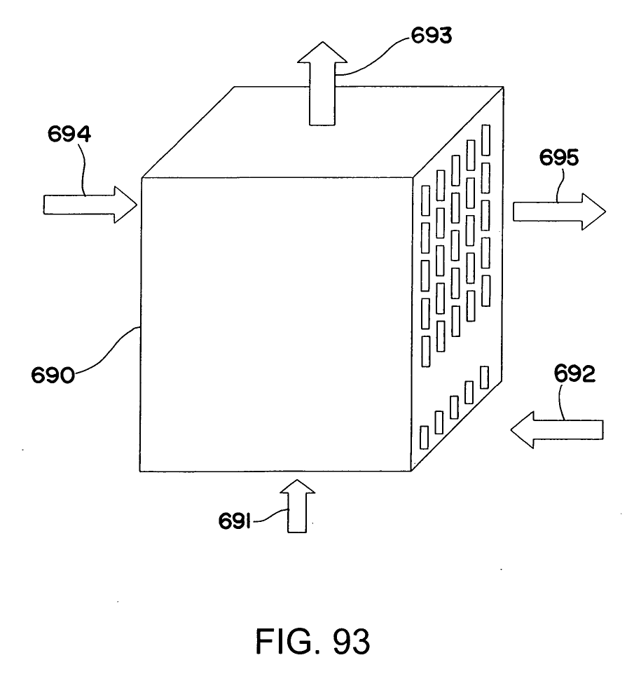

In one embodiment, the inventive process may be conducted in an emulsion process unit as illustrated, for example, in FIGS. 92 and 93. Referring to FIG. 92, the process may be conducted using repeating unit 670 which includes process microchannels 672 and 672A, and heat exchange channels 676 and 676A. The repeating unit 670 also includes an inlet manifold 671 which includes first liquid zones 675 and 675A and second liquid zone 677. Apertured sections 674 and 674A are positioned between second liquid zone 677 and first liquid zones 675 and 675A, respectively. The repeating unit 670 also includes product footers 678 and 678A. In operation, the first liquid flows into the first liquid zones 675 and 675A as indicated by arrows 680 and 680A. The second liquid flows into second liquid zone 677 as indicated by arrow 681 and from there through apertured sections 674 and 674A into first liquid zones 675 and 675A, respectively. The emulsion is formed in first liquid zones 675 and 675A. The emulsion may contain the first liquid in the form of a continuous phase and the second liquid in the form of a dispersed phase. The dispersed phase may be in the form of liquid droplets. The emulsion flows through process microchannels 672 and 672A and is treated (i.e., heated, cooled and/or subjected to additional mixing). The emulsion flows through the product footers 678 and 678A and out of the repeating unit as indicated by arrows 682 and 682A.

Not shown in FIG. 92 are surface features that may be on one or both sides of the process microchannels 672 and 672A. Alternatively, there may be only one process microchannel 672 positioned between the heat exchange channels 676 and 767A. Alternatively, three or more of the process microchannels 672 may be positioned between the heat exchange channels 676 and 767A. In one embodiment, formation of small emulsion droplets (volumetric mean less than about 10 microns) may occur in the process microchannel 672 when the process microchannel contains surface features that disturb the flow fields and mix the emulsion to reduce droplet size.

FIG. 93 illustrates emulsion process unit 690 which may be used to house one or more of the microchannel repeating units 670 illustrated in FIG. 92. With the emulsion process unit 690, the first liquid enters emulsion process unit 690 as indicated by arrow 691, and the second liquid enters as indicated by arrow 692. The emulsion exits the emulsion process unit 690 as indicated by arrow 693. Heat exchange fluid flows into the emulsion process unit 690 as indicated by arrow 694 and exits the emulsion process unit 690 as indicated by arrow 695.

Although only one microchannel repeating unit is illustrated in each of FIGS. 4-9 and 90-92, there is practically no upper limit to the number of microchannel repeating units that may be used in an emulsion process unit for conducting the inventive process. For example, one, two, three, four, five, six, eight, ten, twenty, fifty, one hundred, hundreds, one thousand, thousands, ten thousand, tens of thousands, one hundred thousand, hundreds of thousands, millions, etc., of the emulsion forming units described above may be used. In one embodiment, each microchannel repeating unit may be manifolded. Manifolding may be effected by connecting macrotubing, piping or ducting to each unit. Alternatively, many of the microchannel repeating units may be internally manifolded within an emulsion process unit containing the microchannel repeating units by creating relatively equal pressure drop circuits between each unit. On the other hand, the pressure drop may not be equal between each unit, as some flow maldistribution may not affect product quality. In one embodiment, up to about a 50% flow maldistribution may be acceptable in forming an emulsion using the inventive process. In one embodiment, the flow maldistirbution may be less than about 20%, and in one embodiment less than about 10%, to maintain the desired loading of the first liquid and the second liquid depending on the type of emulsion. In one embodiment, the flow maldistirubution, for an oil-in-water emulsion, for example, may be greater than about 20%, but less than about 50% for the water if the flow maldistribution on the oil side is matched such that the actual loading in each process channel is within about 20% of the target or desired loading. The process microchannels, and associated liquid channels and heat exchange channels may be aligned side-by-side or stacked one above another. These emulsion process units may have appropriate manifolds, valves, conduit lines, tubings, control mechanisms, etc., to control the input and output of process liquids and heat exchange fluids which are not shown in FIGS. 4-9 and 90-92, but can be provided by those skilled in the art. For example, at the inlet and outlet to the emulsion process unit containing the microchannel repeating units, sloped headers and footers may be used for connecting the conduit lines or tubings to avoid unnecessary pressure drops associated with the size of the process microchannels.

In one embodiment, a plurality of microchannel repeating units (200, 200A, 200B, 200C, 200D, 200E, 610, 614, 670) may be stacked one above another to form a core of units scaled up for on-demand large capacity. The scaled-up units may have sloped headers and footers as manifolds for the liquids used to form the emulsions as well as for the emulsion products. More uniform flow distribution may also be enhanced by the addition of an orifice plate or other apertured zone at the entrance of the process or dispersed phase or heat exchange channels. Frame sections may be used to hold and seal the emulsion forming units.

Each of the process microchannels (210, 640, 660, 660A) may have a cross section that has any configuration, for example, square, rectangular, circular, annular, oval, trapezoidal, etc. The process microchannels may be tubular. The process microchannels may be formed from parallel spaced sheets or plates positioned side-by-side or one above another. The term “sheet” refers to a wall thickness of up to about 5 mm. The term “plate” refers to a wall thickness of about 5 mm or higher. Sheets may be supplied to the user in roll form while plates may be supplied to the user in the form of flat pieces of material. Each of the process microchannels may have an internal dimension perpendicular to the flow of liquid through the process microchannel (for example, height, width or diameter) in the range of up to about 10 mm, and in one embodiment up to about 5 mm, and in one embodiment up to about 2 mm. This dimension may be in the range from about 0.05 to about 10 mm, and in- one embodiment about 0.05 to about 5 mm, and in one embodiment about 0.05 to about 3 mm, and in one embodiment about 0.05 to about 2 mm, and in one embodiment about 0.05 to about 1.5 mm, and in one embodiment about 0.05 to about 1 mm, and in one embodiment about 0.05 to about 0.5 mm. Another internal dimension perpendicular to the flow of liquid through the process microchannel (for example, height or width) may be of any value, for example, it may be in the range from about 0.01 cm to about 100 cm, and in one embodiment from about 0.01 cm to about 75 cm, and in one embodiment from about 0.1 cm to about 50 cm, and in one embodiment about 0.2 cm to about 25 cm. The length of each of the process microchannels may be of any value, for example, in the range from about 0.05 cm to about 1000 cm, and in one embodiment from about 0.1 cm to about 500 cm, and in one embodiment about 0.1 cm to about 250 cm, and in one embodiment about 1 cm to about 100 cm, and in one embodiment about 1 cm to about 50 cm, and in one embodiment about 2 cm to about 25 cm.

In one embodiment, the process microchannels (210) may have a non-apertured or non-porous region (not shown in the drawings) in their entrances upstream of the mixing zones (216) to provide an even distribution of flow of the first liquid in the process microchannels. This may be useful when multiple process microchannels are aligned side-by-side and/or one-above-another, and the flow of the first liquid into the multiple process microchannels is non-uniform. The provision of these non-apertured regions may stabilize the flow of the first liquid prior to reaching the mixing zones (216). In one embodiment, surface features (in a surface feature region) may be used in the process microchannel upstream of the apertured region to create a near plug flow fluid profile prior to introducing the second liquid in the apertured region such that mixing of the second liquid into the first liquid may occur rapidly to promote a homogenous emulsion and inhibit the formation of unwanted emulsion phase. Poor mixing in the emulsion mixture may create local regions of concentration that are different from the bulk and in turn this may promote unwanted or metastable emulsion phases, precipitants, or other undesired chemistry. The use of the non-apertured regions may be advantageous when the process microchannels (210) have circular cross sections (i.e., tubular geometries). In one embodiment, the ratio of the length of the non-apertured region from the entrance to the process microchannel (210) to the entrance to the mixing zone (216) relative to the smallest internal dimension of the process microchannel (210) in the non-apertured region may be in the range from about 0.0001 to about 10000, and in one embodiment about 0.001 to about 1000.

The liquid channels (270) may be microchannels although they may have larger dimensions that would not characterize them as microchannels. Each of these channels may have a cross section that has any configuration, for example, square, rectangular, circular, annular, oval, trapezoidal, etc. The liquid channels may be tubular. The liquid channels may be formed from parallel spaced sheets or plates positioned side-by-side or one-above-another. Each liquid channel may have an internal dimension perpendicular to the flow of liquid through the liquid channel (for example, height, width or diameter) in the range up to about 100 cm, and in one embodiment in the range from about 0.05 mm to about 100 cm, and in one embodiment about 0.05 mm to about 50 cm, and in one embodiment from about 0.05 mm to about 10 cm, and in one embodiment from about 0.05 mm to about 5 cm, and in one embodiment about 0.05 mm to about 10 mm, and in one embodiment about 0.05 mm to about 5 mm, and in one embodiment about 0.05 mm to about 2 mm, and in one embodiment about 0.05 mm to about 1 mm. Another internal dimension perpendicular to the flow of liquid through the liquid channel (for example, height or width) may be in the range from about 0.01 cm to about 100 cm, and in one embodiment about 0.01 cm to about 75 cm, and in one embodiment about 0.1 cm to about 50 cm, and in one embodiment about 0.2 cm to about 25 cm. The length of the liquid channels may be of any value, for example, in the range from about 0.05 cm to about 1000 cm, and in one embodiment from about 0.1 cm to about 500 cm, and in one embodiment about 0.1 cm to about 250 cm, and in one embodiment about 1 cm to about 100 cm, and in one embodiment about 1 cm to about 50 cm, and in one embodiment about 2 cm to about 25 cm. The separation between each process microchannel and the next adjacent liquid channel or between adjacent liquid channels may be in the range from about 0.05 mm to about 50 mm, and in one embodiment from about 0.1 to about 10 mm, and in one embodiment from about 0.2 mm to about 2 mm.

The heat source and/or heat sink may be used for cooling, heating or both cooling and heating. The heat source and/or heat sink may comprise one or more heat exchange channels. The heat source may comprise one or more electric heating elements or resistance heaters. The heat sink may comprise one or more non-fluid cooling elements. These may be adjacent to the process microchannels and/or second or third fluid stream channels. In one embodiment, the heat source and/or heat sink may not be in contact with or adjacent to the process microchannel and/or second or third fluid stream channels, but rather can be remote from either or both the process microchannel and/or second or third fluid stream channels, but sufficiently close to the process microchannel and/or second or third fluid stream channels to transfer heat between the heat source and/or heat sink and the process microchannels and/or second or third fluid stream channels. The electric heating element, resistance heater and/or non-fluid cooling element can be used to form one or more walls of the process microchannels (210, 640, 660, 660A) and/or liquid channels (270). The electric heating element, resistance heater and/or non-fluid cooling element can be built into one or more walls of the process microchannels, second fluid stream channels and/or third fluid stream channels. The electric heating elements and/or resistance heaters can be thin sheets, rods, wires, discs or structures of other shapes embedded in the walls of the process microchannels and/or liquid channels. The electric heating elements and/or resistance heaters can be in the form of foil or wire adhered to the process microchannel walls and/or liquid channel wall. Heating and/or cooling may be effected using Peltier-type thermoelectric cooling and/or heating elements. Multiple heating and/or cooling zones may be employed along the length of the process microchannels, second fluid stream channels and/or third fluid stream channels. Similarly, heat transfer fluids at different temperatures in one or more heat exchange channels may be employed along the length of the process microchannels, second fluid stream channels and/or third fluid stream channels. The heat source and/or heat sink can be used to provide precise temperature control within the process microchannels, second fluid stream channels and/or third fluid stream channels.

The heat exchange channels (290, 642, 662) may be microchannels although they may have larger dimensions that would not typically characterize them as microchannels. Each of these channels may have a cross section that has any configuration, for example, square, rectangular, circular, annular, oval, trapezoidal, etc. The heat exchange channels may be tubular. The heat exchange channels may be formed from parallel spaced sheets or plates positioned side-by-side or one-above-another. Each of the heat exchange channels may have an internal dimension perpendicular to the flow of heat exchange fluid through the heat exchange channel, for example height, width or diameter, in the range up to about 50 mm, and in one embodiment up to about 10 mm, and in one embodiment up to about 2 mm. This dimension may be in the range from about 0.05 to about 50 mm, and in one embodiment about 0.05 to about 10 mm, and in one embodiment about 0.05 to about 5 mm, and in one embodiment from about 0.05 to about 2 mm, and in one embodiment from about 0.5 to about 1 mm. Another internal dimension perpendicular to the flow of heat exchange fluid through the heat exchange channel, for example height or width, may be of any value, for example, in the range from about 0.01 cm to about 100 cm, and in one embodiment about 0.01 cm to about 75 cm, and in one embodiment about 0.1 cm to about 50 cm, and in one embodiment about 0.2 cm to about 25 cm. The length of the heat exchange channels may be of any value, for example, in the range from about 0.1 cm to about 500 cm, and in one embodiment about 0.1 cm to about 250 cm, and in one embodiment about 1 cm to about 100 cm, and in one embodiment about 1 cm to about 50 cm, and in one embodiment about 2 cm to about 25 cm. The separation between each process microchannel or liquid channel and the next adjacent heat exchange channel may be in the range from about 0.05 mm to about 50 mm, and in one embodiment about 0.1 to about 10 mm, and in one embodiment about 0.2 mm to about 2 mm. In one embodiment, a heat exchange channel may exchange heat with one, two or more process microchannels and/or liquid channels, for example, three, four, five, six or more process microchannels and/or liquid channels. Heat from one process microchannel and/or liquid channel may pass through one or more process microchannels and/or liquid channels to a heat exchange channel.

The heat exchange channels 290 illustrated in FIGS. 4-9 are adapted for heat exchange fluid to flow through the channels in a direction parallel to and co-current with the flow of liquid through the process microchannels (210) and liquid channels (270), as indicated by the directional arrows. Alternatively, the heat exchange fluid may flow through the heat exchange channels in a direction opposite to the direction indicated in FIGS. 4-9, and thus flow countercurrent to the flow of liquid through the process microchannels (210) and liquid channels (270). Alternatively, the heat exchange channels (290) may be oriented relative to the process microchannels (210) and liquid channels (270) to provide for the flow of heat exchange fluid in a direction that is cross-current relative to the flow of liquid through the process microchannels and liquid channels. The heat exchange channels (290) may have a serpentine configuration to provide a combination of cross-flow and co-current or counter-current flow.

In one embodiment, flow and/or mixing within the process microchannels (210, 640, 660, 660A), liquid channels (270), and/or heat exchange channels (290, 642, 662) may be modified by the use of surface features formed on one, two or more interior walls of such channels. The surface features may be in the form of depressions in and/or projections from one or more of the channel walls. These surface features may be oriented at angles relative to the direction of flow through the channels. The surface features may be aligned at an angle from about 1° to about 89°, and in one embodiment from about 30° to about 75°, relative to the direction of flow. The angle of orientation may be an oblique angle. The angled surface features may be aligned toward the direction of flow or against the direction of flow. The flow of fluids in contact with the surface features may force one or more of the fluids into depressions in the surface features, while other fluids may flow above the surface features. Flow within the surface features may conform with the surface feature and be at an angle to the direction of the bulk flow in the channel. As fluid exits the surface features it may exert momentum in the x and y direction for an x,y,z coordinate system wherein the bulk flow is in the z direction. This may result in a churning or rotation in the flow of the fluids. This pattern may be helpful for mixing a two-phase flow as the imparted velocity gradients may create fluid shear that breaks up one of the phases into small and well dispersed droplets.

In one embodiment, two or more surface feature regions within the process microchannels (210, 640, 660, 660A) may be placed in series such that mixing of the liquids to form an emulsion may be accomplished using a first surface feature region, followed by at least one second surface feature region where a different flow pattern is used. The second flow pattern may be used to separate one or more liquids or gases from the emulsion. In the second surface feature region, a flow pattern may be used that creates a centrifugal force that drives one liquid toward the interior walls of the process microchannels while another liquid remains in the fluid core. One pattern of surface features that may create a strong central vortex may comprise a pair of angled slots on the top and bottom of the process microchannel. This pattern of surface features may be used to create a central swirling flow pattern.

In one embodiment, the apertured section (240) may comprise an interior portion that forms part of one or more of the interior walls of each process microchannel. A surface feature sheet may overlie this interior portion of the apertured section. Surface features may be formed in and/or on the surface feature sheet. The second liquid may flow through the apertured section and the surface feature sheet into the process microchannel. Part of the second liquid may be detached from the surface of the surface feature sheet while part may flow within the surface features of the surface feature sheet. The surface feature sheet may contain angled surface features that have relatively small widths or spans relative to the overall flow length. The surface feature sheet may provide mechanical support for the apertured section. The surface features may impart a vortical flow pattern to the fluids in the process microchannel and promote good mixing of the two phases and or promote the formation of small emulsion droplets. The vortical flow pattern may impart shear to the second liquid flowing through the apertured section and thus reduce the size of the droplets in the bulk flow path.

Examples of the surface features are illustrated in FIGS. 54-58. The surface features may have two or more layers stacked on top of each other or intertwined in a three-dimensional pattern. The pattern in each discrete layer may be the same or different. Flow may rotate or advect in each layer or only in one layer. Sub-layers, which may not be adjacent to the bulk flow path of the channel, may be used to create additional surface area. The flow may rotate in the first level of surface features and diffuse molecularly into the second or more sublayers to promote reaction. Three-dimensional surface features may be made via metal casting, photochemical machining, laser cutting, etching, ablation, or other processes where varying patterns may be broken into discrete planes as if stacked on top of one another. Three-dimensional surface features may be provided adjacent to the bulk flow path within the microchannel where the surface features have different depths, shapes, and/or locations accompanied by sub-features with patterns of varying depths, shapes and/or locations.

The use of surface features or fully etched plates with patterns may be advantageous to provide structural support for thin or weak apertured plates or sheets used to form the apertured section. In one embodiment, the apertured sheet may be made from a polymeric material that has very small mean pore diameters (less than 1 micron) but can not withstand a high pressure differential (greater than about 10 psi, or greater than about 50 psi, or greater than about 100 psi, or larger) that is required to force the second liquid through the apertured section into the process microchannel. The open span required for structural support may be reduced from the cross section of the process microchannel to the open span and run the length of the surface feature. The span of the surface feature may be made smaller as required if the apertured sheet or plate has reduced mechanical integrity. One advantage of the surface features, is the convective flow that may occur within the surface features such that a significant shear stress may be created at the wall of the apertured section to assist with the detachment of small droplets.

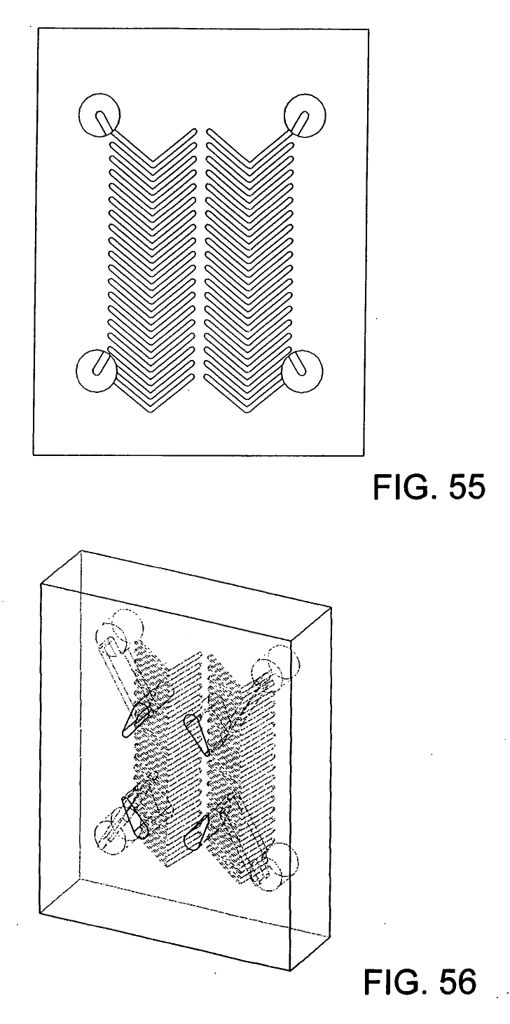

FIG. 55 is a schematic illustration of a top view of a three-dimensional surface feature structure. An example of a back view of a three-dimensional surface feature structure is illustrated in FIG. 56 where recessed chevrons are provided at the interface adjacent the bulk flow path of the microchannel. Beneath the chevrons are a series of three-dimensional structures that connect to the surface features adjacent to the bulk flow path but are made from structures of assorted shapes, depths, and/or locations. It may be further advantageous to provide sublayer passages that do not directly fall beneath an open surface feature that is adjacent to the bulk flow path within the microchannel but rather connect through one or more tortuous two-dimensional or three-dimensional passages. This approach may be advantageous for creating tailored residence time distributions in the microchannels, where it may be desirable to have a wider versus more narrow residence time distribution.

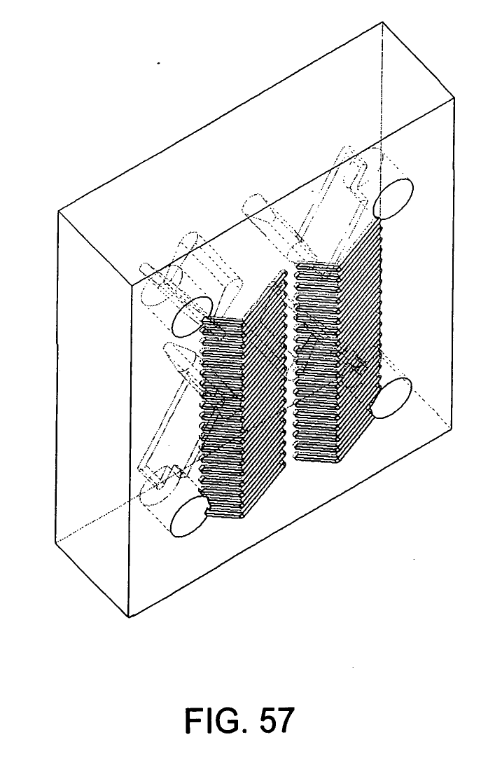

FIG. 57 is a front view of a three-dimensional surface feature where recessed chevrons abut the bulk flow path within the microchannel and have additional surface features of different shapes behind them at varying depths and locations.

The length and width of a surface feature may be defined in the same way as the length and width of a microchannel. The depth may be the distance which the surface feature sinks into or rises above the microchannel surface. The depth of the surface features may correspond to the direction of stacking a stacked and bonded microchannel device with surface features formed on or in the sheet surfaces. The dimensions for the surface features may refer the maximum dimension of a surface feature; for example the depth of a rounded groove may refer to the maximum depth, that is, the depth at the bottom of the groove.

The surface features may have depths that are less than about 2 mm, and in one embodiment less than about 1 mm, and in one embodiment in the range from about 0.01 to about 2 mm, and in one embodiment in the range from about 0.01 to about 1 mm, and in one embodiment in the range from about 0.01 mm to about 0.5 mm. The width of the surface features may be sufficient to nearly span the microchannel width (as shown in the herringbone designs), but in one embodiment (such as the fill features) can span about 60% or less of the width of the microchannel, and in one embodiment about 50% or less, and in one embodiment about 40% or less, and in one embodiment from about 0.1% to about 60% of the microchannel width, and in one embodiment from about 0.1% to about 50% of the microchannel width, and in one embodiment from about 0.1% to about 40% of the microchannel width. The width of the surface features may be in the range from about 0.05 mm to about 100 cm, and in one embodiment in the range from about 0.5 mm to about 5 cm, and in one embodiment in the range from about 1 to about 2 cm.

Multiple surface features or regions of surface features may be included within a microchannel, including surface features that recess at different depths into one or more microchannel walls. The spacing between recesses may be in the range from about 0.01 mm to about 10 mm, and in one embodiment in the range from about 0.1 to about 1 mm. The surface features may be present throughout the entire length of a microchannel or in portions or regions of the microchannel. The portion or region having surface features may be intermittent so as to promote a desired mixing or unit operation (for example, separation, cooling, etc.) in tailored zones. For example, a one-centimeter section of a microchannel may have a tightly spaced array of surface features, followed by four centimeters of a flat channel without surface features, followed by a two-centimeter section of loosely spaced surface features. The term “loosely spaced surface features” may be used to refer to surface features with a pitch or feature to feature distance that is more than about five times the width of the surface feature.

In one embodiment, the surface features may be in one or more surface feature regions that extend substantially over the entire axial length of a channel. In one embodiment, a channel may have surface features extending over about 50% or less of its axial length, and in one embodiment over about 20% or less of its axial length. In one embodiment, the surface features may extend over about 10% to about 100% of the axial length of the channel, and in one embodiment from about 20% to about 90%, and in one embodiment from about 30% to about 80%, and in one embodiment from about 40% to about 60% of the axial length of a channel.

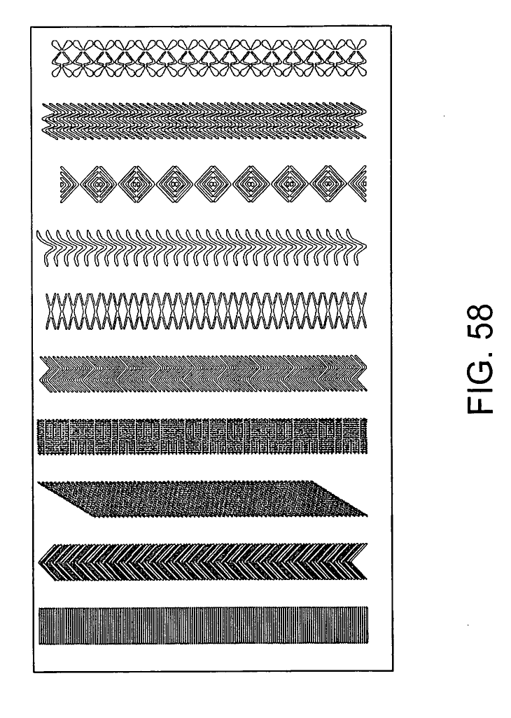

FIGS. 54 and 58 show a number of different patterns that may be used for surface features. These patterns are not intended to limit the invention, only to illustrate a number of possibilities. As with any surface feature, the patterns may be used in different axial or lateral sections of a microchannel.

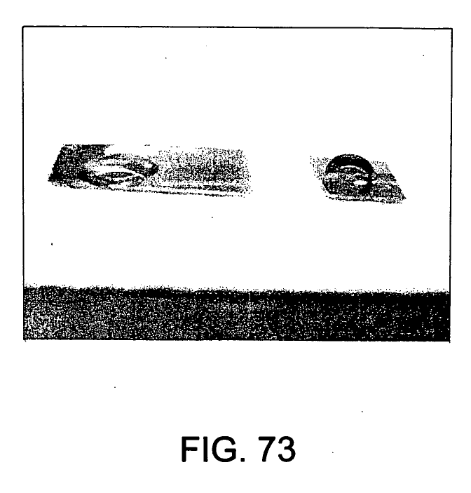

In one embodiment, the process microchannels (210, 640, 660, 660A), liquid channels 270 and/or heat exchange channels (290, 642, 662) may have their interior walls coated with a lipophobic coating (the same coating may also provide hydrophobic properties) to reduce surface energy. Teflon is an example of a coating material that may exhibit both lipophobic and hydrophobic tendencies. The surface of the apertured section 240 that faces the interior of the process microchannel 210 may be coated with a lipophobic coating to reduce droplet drag and promote the formation of smaller droplets. The coating on the apertured section may reduce the energy required to detach a droplet from the surface of the apertured section. In addition, the drag exerted on the second liquid may be lower during droplet detachment and while flowing beyond the apertured section downstream in the process microchannel. In one embodiment, a hydrophobic coating may be applied to the apertured section to assis with the detachment of water droplets into an oil phase. Fluids may not wet surfaces coated with the lipophobic coating. As such, the fluids may slip past the surface and thus negate or reduce the usual no-slip boundary condition of fluids against a wall. As the fluids slip, the local friction factor may decrease as a result of reduced drag and the corresponding pressure drop may be reduced per unit length of the channels. The local heat transfer rate may increase as a result of forced convection over a coated surface as opposed to conductive heat transfer through a stagnant film. For Newtonian fluids, viscosity is constant with flowrate or shear rate against a wall. As such the reduction in friction may be constant as a function of the flow rate (e.g., if the flow is laminar, then f=64/Re). The effect of the coating may have a different impact on different types of non-Newtonian fluids. For the case of pseudoplastic (power law) fluid without yield may appear Newtonian above shear rates that are fluid dependent. The viscosity of the fluid may be higher when the shear rate is below a certain value. If the shear rate is locally larger because of the coated wall, then the fluid may be able to shear droplets more easily, move with less energy (lower pumping requirements), and have better heat transfer properties than if the coating were not used. For the case of pseudoplastic (power law) fluid with yield may still have a yield stress, at the wall the yield stress may be greatly reduced with the use of the lipophobic coating. Heat transfer and frictional properties may be enhanced if the apparent yield is low when the coating is used as compared to when the coating is not used. The shear-related-effects may be more pronounced for non-Newtonian fluids than for Newtonian fluids. FIG. 73 shows the advantage of using a lipophobic surface energy reducing coating. In FIG. 73, drops of deionized water are deposited on uncoated stainless steel (left) and on stainless steel (right) coated with a lipophobic surface energy reducing coating. The drops of water do not wet the coated surface and are free flowing.

A Teflon coating is applied to an apertured substrate and tested for the formation of a wax-containing oil-in-water emulsion. The mean droplet size is reduced from more than 5 microns to less than 2 microns as a result of the change in the surface chemistry of the apertured substrate.

In one embodiment, the process microchannels (210, 640, 660, 660A), liquid channels (270) and heat exchange channels (290, 642, 662) may have square or rectangular cross sections and may be formed from parallel spaced sheets or plates. These channels may be aligned in side-by-side vertically oriented interleaved planes, or horizontally oriented interleaved planes stacked one above another. These configurations, which may be referred to as parallel plate configurations, have a number of advantages. In comparison with circular tubes, for example, parallel plate configurations incur less pressure drop while the same shear force is realized for the height or width, or diameter at the same continuous phase mass flux. When the aspect ratio of a rectangular channel approaches, for example, about 10, i.e., approaches a parallel sheet or plate configuration, its pressure drop may be only about 50% of that in a circular channel under the same conditions. Process microchannels, liquid channels and heat exchange channels having parallel plate configurations can be easily arranged in a compact device for scale-up. Also, a higher capacity per unit volume for the emulsion forming process can be achieved with parallel plate configurations as compared with circular tubes.

An advantage of using parallel plate configurations is that these configurations have larger fluid/wall material ratios as compared to circular tubes, and are thus more compact with the potential for higher capacity or output. A comparison may be made at the same velocity (thus, similar shear force and droplet size) and the same dimensions d, D, L and W as depicted in FIG. 7. The comparison results are: continuous phase flow rate G_{tube}=Dπ/[8(D+d)]Gₚₗₐₜₑ. When D=d, then G_{tube}=0.196 Gₚₗₐₜₑ. When d=D/2 then G_{tube}=0262Gₚₗₐₜₑ. This means that for the same flow rate/capacity and system volume, the tube inner diameter has to increase by a factor of (1/0.196)^{0.5}=2.25 times or (1/0.262)^{0.5}=1.954 times. However, an increase of tube diameter leads to much lower shear force and in turn larger droplet size. In this case, the packing density becomes lower as the emulsification area has the following relation: when D=d, then A_{tube}=0.39Aₚₗₐₜₑ; when d=D/2, then A_{tube}=0.52Aₚₗₐₜₑ.

In one embodiment, the process microchannels (210, 640, 660, 660A), liquid channels (270) and optionally heat exchange channels (290, 642, 662), may be in the form of circular tubes arranged concentrically. The process microchannels and liquid channels may be adjacent to each other with one channel being in the annular space and the other channel being in the center space or an adjacent annular space. In one embodiment, a microchannel mixer that is useful with the inventive process may comprise a plurality of alternating interleaved concentric tubular process microchannels, liquid channels, and optionally heat exchange channels, the microchannel mixer being in cylindrical form.

The apertures (244) may be of sufficient size to permit the flow of the second liquid through the apertured section (240). The apertured section may be referred to as a porous substrate. The apertures may be referred to as pores. The apertured section (240) may have a thickness in the range from about 0.01 to about 50 mm, and in one embodiment about 0.05 to about 10 mm, and in one embodiment about 0.1 to about 2 mm. The apertures (244) may have an average diameter in the range of up to about 50 microns, and in one embodiment in the range from about 0.001 to about 50 microns, and in one embodiment from about 0.05 to about 50 microns, and in one embodiment from about 0.1 to about 50 microns. In one embodiment, the apertures may have an average diameter in the range from about 0.5 to about 10 nanometers (nm), and in one embodiment about 1 to about 10 nm, and in one embodiment about 5 to about 10 nm. The number of apertures in the apertured sections may be in the range from about 10 to about 5×10⁸ apertures per square centimeter, and in one embodiment about 1 to about 1×10⁵ apertures per square centimeter. The apertures may or may not be isolated from each other. A portion or all of the apertures may be in fluid communication with other apertures within the apertured section. The ratio of the thickness of the apertured sections (240) to the length of the apertured sections along the flow path of the liquids flowing through the process microchannels (210) may be in the range from about 0.001 to about 1, and in one embodiment about 0.01 to about 1, and in one embodiment about 0.03 to about 1, and in one embodiment about 0.05 to about 1, and in one embodiment about 0.08 to about 1, and in one embodiment about 0.1 to about 1.

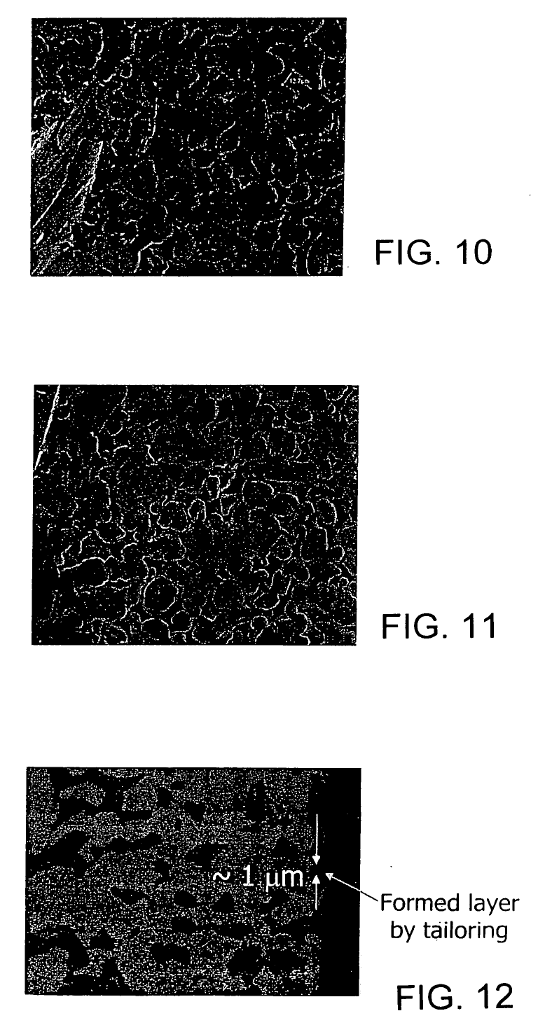

The apertured section (240) may be constructed of any material that provides sufficient strength and dimensional stability to permit the operation of the inventive process. These materials include: steel (e.g., stainless steel, carbon steel, and the like); monel; inconel; aluminum; titanium; nickel; platinum; rhodium; copper; chromium; brass; alloys of any of the foregoing metals; polymers (e.g., thermoset resins); ceramics; glass; composites comprising one or more polymers (e.g., thermoset resins) and fiberglass; quartz; silicon; microporous carbon, including carbon nanotubes or carbon molecular sieves; zeolites; or a combination of two or more thereof. The apertures may be formed using known techniques such as laser drilling, microelectro machining system (MEMS), lithography electrodeposition and molding (LIGA), electrical sparkling, photochemical machining (PCM), electrochemical machining (ECM), electrochemical etching, and the like. The apertures may be formed using techniques used for making structured plastics, such as extrusion, or membranes, such as aligned carbon nanotube (CNT) membranes. The apertures may be formed using techniques such as sintering or compressing metallic powder or particles to form tortuous interconnected capillary channels and the techniques of membrane fabrication. The aperatures may be reduced in size from the size provided by any of these methods by the application of coatings over the apertures internal side walls to partially fill the apertures. The selective coatings may also form a thin layer exterior to the porous body that provides the smallest pore size adjacent to the continuous flow path. The smallest average pore opening may be in the range from about one nanometer to about several hundred microns depending upon the desired droplet size for the emulsion. The aperatures may be reduced in size by heat treating as well as by methods that form an oxide scale or coating on the internal side walls of the apertures. These techniques may be used to partially occlude the aperatures to reduce the size of the openings for flow. FIGS. 10 and 11 show a comparison of SEM surface structures of a stainless steel porous substrate before and after heat treatment at the same magnification and the same location. FIG. 10 shows the surface before heat treating and FIG. 11 shows the surface after heat treating. The surface of the porous material after the heat treatment has a significantly smaller gap and opening size. The average distance between the openings is correspondingly increased.

In one embodiment, the droplet size of the emulsions may be reduced by producing raised features on the apertured section and at the same time eliminating or reducing the pores below the raised features. This may direct the flow of the second liquid through the porous raised features and into a shearing flow. By using a laser to etch down in certain areas on the apertured section (e.g., a metal porous substrate), the porosity of the unetched areas (raised features) may retain their pore size while the porosity of the etched areas may be either reduced or sealed off by the laser.

In one embodiment, electroless plating may be used in making the apertured section 240. The aperture or pore size of a laser drilled sheet or plate may be decreased from about 10 to about 15 microns to about two microns by plating it with a metal using electroless plating. Porous materials have been widely used for separation, filtration, weight reduction, controlled permeation, insulation, fluid dispersion, emulsion, etc. One common challenge is to provide a uniform pore size in the range of submicron to several microns. It is even more difficult to provide small holes with straight channels to provide apertured sections 240 that exhibit low pressure drops across the apertured sections. Laser drilling can provide straight channels, but the hole size is usually larger than 7.5 microns. Electroless plating of metals can be used to decrease the surface pore size to about 1 to about 2 microns. The smaller holes in the apertured section 240 may result in a smaller droplet size for the emulsion made by the inventive process. The metal used for the plating may be any transition metal, precious metal, noble metal, or metal from Group IIIB, IVB or VB of the Periodic Table. These include Pt, Pd, Ag, Au, Ni, Sn, Cu, and combinations of two or more thereof.

Electroless plating may involve the use of an aqueous solution comprising a metal compound and a reducing chemical. The reducing chemical may reduce the metal compound to metal under certain conditions. In the plating solution, a complexing agent may be added to prevent reduction of the metal ions in the solution, while permitting reduction of ions adsorbed on a substrate surface. The reduction process may be accelerated by higher temperature and/or higher concentration. The coating thickness may be controlled by the reduction rate and time. Generally the coating thickness may be varied from submicron to several hundred microns, depending on the plating conditions and the metal.

The substrate that may be electroless plated to form the apertured section 240 may be a porous ceramic or metallic material. These include stainless steels and Ni-based alloys. The surface of the material to be plated may be treated before the electroless plating process. This may involve aluminization and/or heat-treatment. The substrate may have a flat surface or a modified structure with various geometries (e.g., pores, microchannels, etc.). One surface of the substrate may be covered by tape, epoxy, wax, or any other removable material. After plating, the covering material may be removed. This surface hole size may not change, while the other side may be decreased due to plating. In this way, the hole size may decrease along the channels and the pressure drop increase may be minimized.

The metal compounds may be water soluble salts. The platinum compounds may include, for example, Pt(NH₃)₂(NO₂)₂, PtCl₂(NH₃)₂, Pt(NH₃)₂(OH)₂, (NH₄)₂PtCl₆, (NH₄)₂PtCl₄, Pt(NH₃)Cl₄, H₂PtCl₆, PtCl₂, K₂Pt(NO₂)₄, Na₂Pt(OH)₆, Pt(NH₃)₄(OH)₂, Pt(NH₃)₄(NO₃)₂, or a combination of two or more thereof. The complexing agent may include ammonium hydroxide, hydroxylamine chloride, hydrazine dichloride, or a mixture of two or more thereof. The reducing chemical may be a hydrazine compound (e.g., N₂H₄.H₂O), formaldehyde, sodium boron hydride, borane-amine related compounds (e.g., borane dimethyl amine), hypophosphites, or a combination of two or more thereof.

The reduction process may be catalyzed by a small amount of catalytic metal ions (e.g., Pd or Sn ions) in the solution or by some metals which are present or pre-deposited on the substrate surface. The catalytic metals may include Cu, Ni, Fe, Co, Au, Ag, Pd, Rh, and mixtures of two or more thereof. After plating, the substrate may be heat treated at a high temperature to sinter the plated metal to provide a smoother surface.

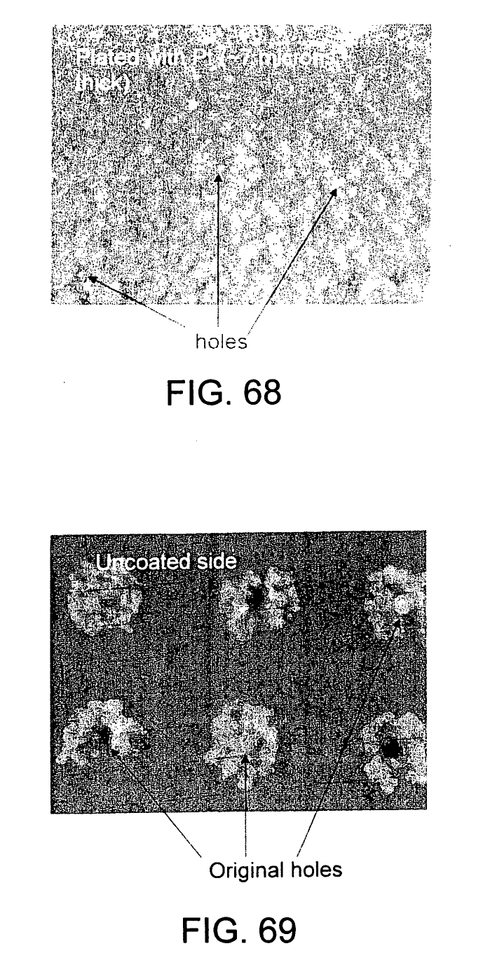

A laser drilled stainless steel disk with holes of about 10 to about 15 microns is plated with platinum using electroless plating. The disk is cleaned by sonication in hexane for 30 minutes, and then in 20% HNO₃ for 30 minutes. The disk is rinsed with water and methanol. The disk is cooled at 100° C. for 1 hour. The disk is calcined at 600° C. in air for 10 hours. The disk is cooled to room temperature. One surface of the disk is covered with a tape. The disk is placed in an aqueous plating bath containing Pt(NH₃)₄(OH)₂ (1% Pt) and 1% N₂H₄.H₂O. The pH is adjusted to 11-12.7 using acetic acid. The plating is performed for 1 day. The disk is rinsed with water and dried. This plating process is repeated 5 times. The tape is removed after plating. One side of the disk is coated with Pt. The disk is calcined in air at 500° C. for 2 hours. The thickness of the Pt plating is 7 microns. FIGS. 68 and 69 show microphotographs of the disk with the plating (FIG. 68) and without the plating (FIG. 69). The hole size for the plated disk is about 2 microns, whereas the hole size is 10-15 microns at the surface without plating.

The apertured sections (240) may be made from a metallic or nonmetallic porous material having interconnected channels or pores of an average pore size in the range from about 0.01 to about 200 microns. These pores may function as the apertures (244). The porous material may be made from powder or particulates so that the average inter-pore distance is similar to the average pore size. When very small pore sizes are used, the inter-pore distance may also be very small and the droplets may merge at the surface in the side of process microchannels (210) or liquid channels (270) to form unwanted larger droplets. The porous material may be tailored by oxidization at a high temperature in the range from about 300° C. to about 1000° C. for a duration of about 1 hour to about 20 days, or by coating a thin layer of another material such as alumina by SOL coating or nickel using chemical vapor deposition over the surface and the inside of pores to block the smaller pores, decrease pore size of larger pores, and in turn increase the inter-pore distance. As such, the merger of droplets may be reduced or eliminated and the formation of smaller droplets may be permitted. An SEM image of a tailored substrate or apertured section is shown in FIG. 12.

The making of substrates for use as apertured sections (240) with sufficiently small micro-scale apertures or pores (244) to provide emulsions having droplet sizes smaller than about one micron can be problematic. One of the reasons for this lies in the fact that relatively high surface roughness occurs with untreated regular porous materials such as a metallic porous substrates made from powder/particles by compression and/or sintering. These metallic porous substrates typically do not have the required pore size in the surface region when a given nominal pore size is lower than a certain value. While the bulk of the porous material may have the specified nominal pore size, the surface region is often characterized by merged pores and cavities of much larger sizes. This problem can be overcome by tailoring these substrates to provide for the desired pore size and inter-pore distance in the surface region. This may be done by removing a surface layer from the porous substrate and adding a smooth new surface with smaller openings. The droplet size in the emulsion that may be formed using these tailored substrates may be reduced without increasing the pressure drop across the substrate. Since direct grinding or machining of the porous surface may cause smearing of the surface structure and blockage of the pores, the porous structure may be filled with a liquid filler, followed by solidification and mechanical grinding/polishing. The filler is then removed to regain the porous structure of the material. The filler may be a metal with a low melting point such as zinc or tin or the precursor of a polymer such as an epoxy. The liquid filling and removing steps may be assisted by the use of a vacuum. Grinding/polishing may be effected using a grinding machine and a grinding powder. Metal filler removal may be effected by melting and vacuum suction, or by acid etching. Epoxies or other polymers may be removed by solvent dissolution or by burn-off in air.

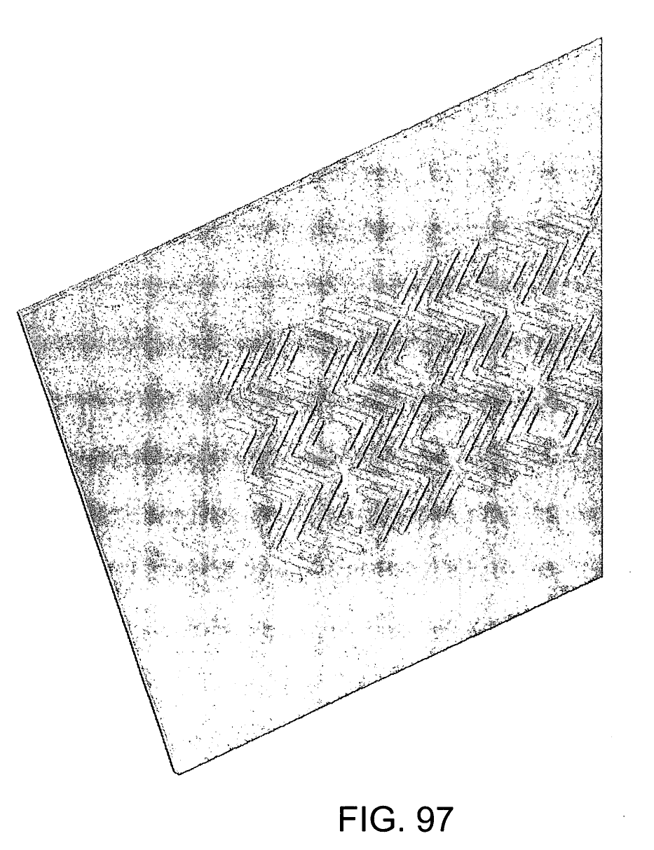

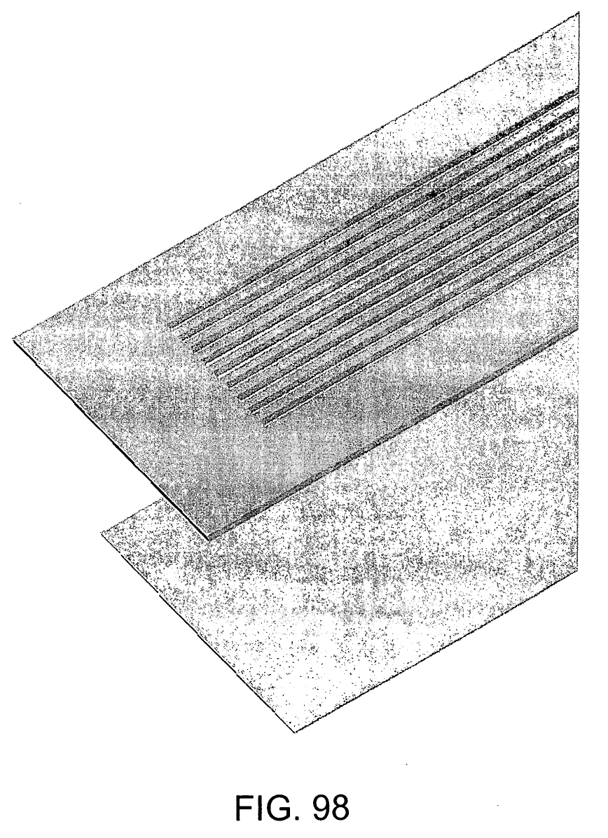

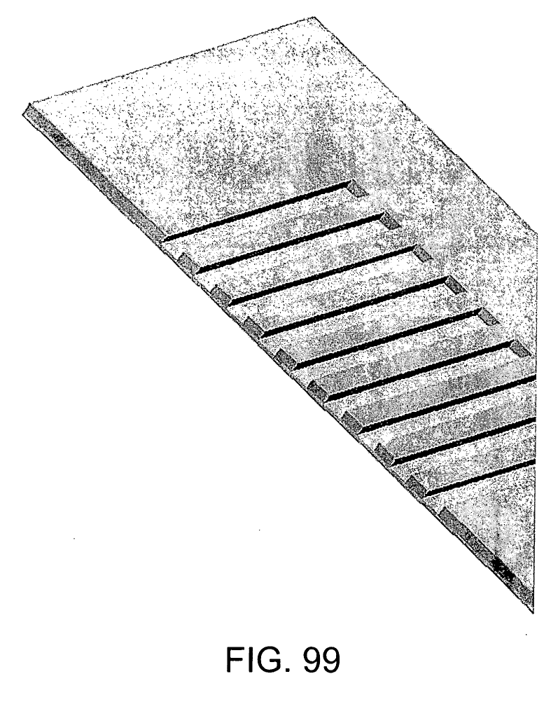

In one embodiment, the pressure drop of the second liquid flowing through the apertured section 240 may be greater than the mechanical strength of the material used to make the apertured section. In this case the apertured section may be supported by a support structure having sufficient mechanical strength to withstand the stresses created by the pressure drop. Suitable designs for these support structures are illustrated in FIGS. 97-99.

In one embodiment, the apertured sections (240) may have a nominal aperture or pore size of about 0.1 micron and a thickness of about 0.010 inch (0.254 mm). These apertured sections may be constructed of stainless steel 316L and supplied by Mott Corporation of Farmington, Conn. under Catalogue No. 1110-12-12-018-01-A.

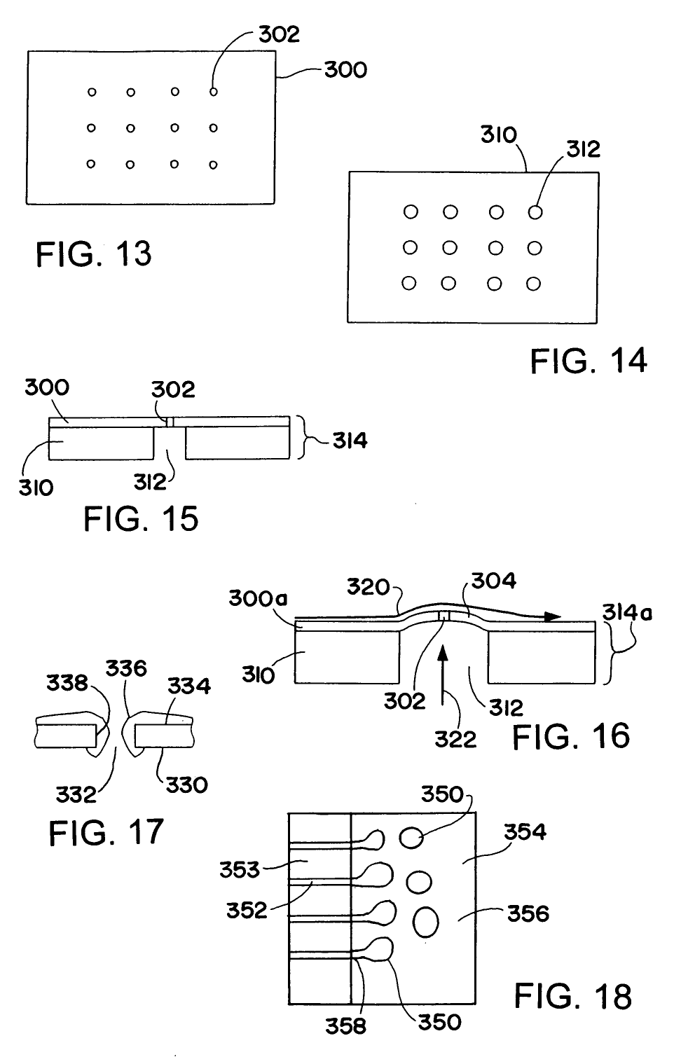

Referring to FIGS. 13-15, the apertured sections (240), in one embodiment, may be constructed of a relatively thin sheet 300 containing a plurality of relatively small apertures 302, and a relatively thick sheet or plate 310 containing a plurality of relatively large apertures 312 which are coaxially aligned with or connected to apertures 302. The relatively thin sheet 300 overlies and is bonded to the relatively thick sheet 310, the relatively thin sheet 300 facing the interior of process microchannel (210) and the relatively thick sheet 310 facing the interior of the liquid channel (270). The relatively thin sheet 300 may be bonded to the relatively thick sheet 310 using any suitable procedure (e.g., diffusion bonding) to provide a composite construction 314 with enhanced mechanical strength. The relatively thin sheet 300 may have a thickness in the range from about 0.001 to about 0.5 mm, and in one embodiment about 0.05 to about 0.2 mm. The relatively small apertures 302 may have any shape, for example, circular, triangular or rectangular. The relatively small apertures 302 may have an average diameter in the range from about 0.05 to about 50 microns, and in one embodiment about 0.05 to about 20 microns. The relatively thick sheet or plate 310 may have a thickness in the range from about 0.1 to about 5 mm, and in one embodiment about 0.1 to about 2 mm. The relatively large apertures 312 may have any shape, for example, circular, triangular or rectangular. The relatively large apertures 312 may have an average diameter in the range from about 0.1 to about 4000 microns, and in one embodiment about 1 to about 2000 microns, and in one embodiment about 10 to about 1000 micron. The number of apertures 302 in sheet 300 and the apertures 312 in sheet or plate 310 may each comprise from about 2 to about 10000 apertures per square centimeter, and in one embodiment from about 2 to about 1000 apertures per square centimeter. The sheet 300 and the sheet or plate 310 may be constructed of any of the materials described above as being useful for constructing the apertured sections (240). The apertures 302 and 312 may be coaxially aligned or connected in such a manner that liquid flowing through the apertured sections flows initially through apertures 312 then through apertures 302. The relatively short passageway for the liquid to flow through the relatively small apertures 302 enables the liquid to flow through the apertures 302 with a relatively low pressure drop as compared to the pressure drop that would occur if the passageway in the apertures had a length equal to the combined length of apertures 302 and 312.

In the embodiment illustrated in FIG. 16, composite construction 314a has the same design as illustrated in FIG. 15 with the exception that convex portion 304 of the relatively thin sheet 300 covering the aperture 312 is provided. Convex portion 304 provides increased local shear force in the adjacent channel. The directional arrow 320 in FIG. 16 shows the flow of liquid in the channel adjacent to the aperture 302. The higher shear force leads to a smaller droplet size for the liquid flowing through the aperture 302, as indicated by arrow 322.

In the embodiment illustrated in FIG. 17, a surface coating 336 is deposited on the surface of sheet or plate 330 and on the internal sidewalls 338 of aperture 332. This coating provides a facilitated way of reducing the diameter of the apertures (244). The coating material used to form coating 336 may be alumina, nickel, gold, or a polymeric material (e.g., Teflon). The coating 336 may be applied to the sheet or plate 330 using known techniques including chemical vapor deposition, physical vapor deposition, metal sputtering, metal plating, sintering, sol coating, and the like. The diameter of the apertures (244) may be controlled by controlling the thickness of the coating 336.

In one embodiment, the apertured sections (240) may be formed from an asymmetric porous material, for example, a porous material having multiple layers of sintered particles. The number of layers may be two, three, or more. An advantage of these multilayered substrates is that they provide enhanced durability and adhesion. Examples include sintered ceramics that have relatively large pores on one side and relatively small pores on the other side. The relatively small pores may have diameters in the range of about 2 to about 10 nm. The relatively small pores may be positioned in a relatively thin layer of the multilayered substrate. The relatively thin layer may have a thickness in the range of about 1 to about 10 microns. The side with the relatively small pores may be placed facing the continuous phase flow (i.e., the interior of the process microchannel) to take advantage of relatively high shear forces to remove the relatively small emulsion droplets as they are formed.

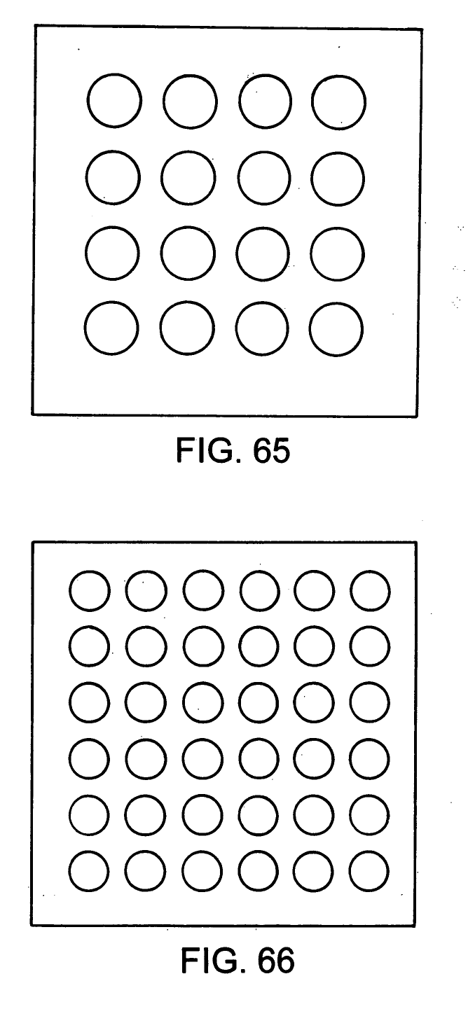

The porous substrates used for making the apertured section 240 may be limited by poor homogeneity of pore sizes and spacing and lack pore sizes that are sufficiently small. Traditional mechanical methods of manufacture may not yield small enough pore sizes and/or distribution uniformity. Conventional processes such as drilling or stamping, followed by a coating process that reduces the pore diameter, may yield acceptable structures. However, apertures or holes in the range of about 0.1 to about 5 microns typically can only be mechanically made in very thin materials, typically those having a thickness of greater than about one times the hole diameter. These thin structures need to be reinforced to provide rigidity. This may be achieved by bonding sheets that have successively larger aperture or hole pore sizes. While some holes may be closed off by solid areas in the sheet or shim with larger holes bonded to one side, a calculable number of hole openings can be determined. The net effect is a structure that on one side, has uniform pore spacing and sizes, is internally porous, is structurally rigid, can be used in a microchannel device and be subjected to pressure on one side that is greater than the pressure on the other side, and can be further processed via a chemical vapor deposition (CVD) process to close down the pore sizes throughout the structure. The spacing and pore size on each layer may vary as illustrated in FIGS. 65 and 66. Thus, in one embodiment, the apertured section may comprise at least two sheets overlying each other, a first sheet having a first array of apertures in it, a second sheet having a second array of apertures in it, the apertures in the first sheet being larger than the apertures in the section sheet, the second sheet at least partially blocking some of the apertures in the first sheet.

The formation of the liquid droplets during the inventive process is shown schematically in FIG. 18. Referring to FIG. 18, the second liquid in the form of liquid droplets 350, emerges from apertures 352 in apertured section 353 and flows into process microchannel 354 where the droplets are dispersed in the first liquid 356. While attached to the liquid stems 358 within the apertures 352, the liquid droplets may grow in size, for example, to about 10 times the size of the apertures or larger. Eventually, shear force at the base of the liquid stems 358 detaches the droplets from the apertures 352 and the droplets disperse in the first liquid 356. In one embodiment, a relatively high pressure drop through the apertures 352 or a correspondingly high second liquid flow rate through the liquid channel adjacent to the apertured section 353 may not be necessary to achieve dispersion of the second reactant in the first reactant. A low pressure drop or low flow rate may lead to smaller droplets, as lower inertia of the second liquid flowing through the apertured section may reduce droplet growth before the droplets detach from the apertures.

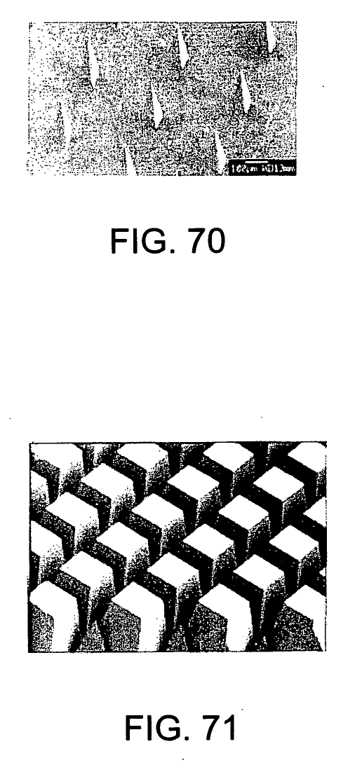

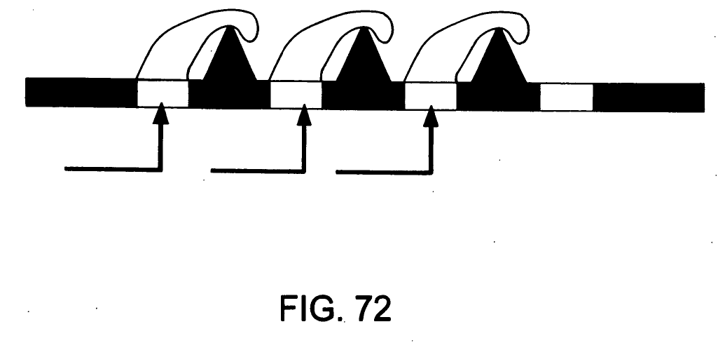

In one embodiment, the emulsion may be made by shearing off the second liquid as it is forced through the apertures in the apertured section 240. The second liquid may make its way through the apertures while a shear force may pull it at a 90° angle from the aperture opening. The second liquid may be pulled until it weakens and breaks making a droplet. Emulsion quality may be determined by droplet size with the smaller droplets having higher quality. Reducing droplet size by adding surface features on the interior wall of the apertured section may provide the droplets a backing to lean against making the shearing process easier by weakening a different portion of the second liquid. The surface features that may be used are illustrated in FIGS. 70 and 71. The flow of the second liquid through the apertures and leaning against the surface features is schematically illustrated in FIG. 72.

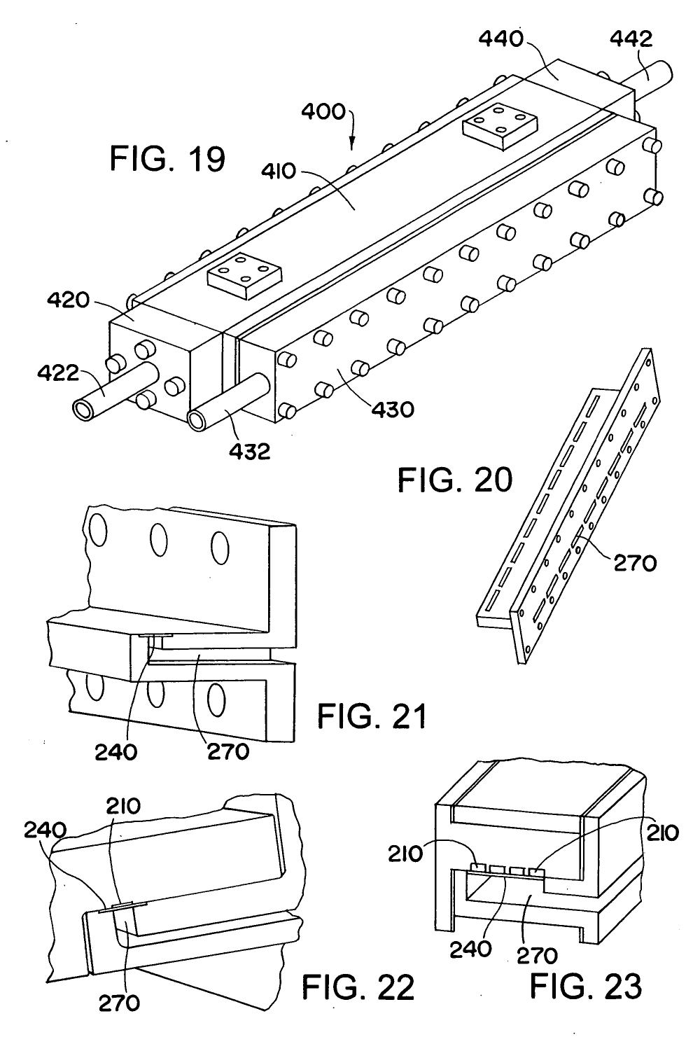

The microchannel repeating units 200, 200A, 200B, 200C, 200D or 200E may be employed in the emulsion process unit 400 illustrated in FIGS. 19-22. Microchannel repeating unit 200B is shown in these drawings. Emulsion process unit 400 includes microchannel core section 410, first liquid header 420, second liquid header 430, and product footer 440. The first liquid enters emulsion process unit 400 through conduit 422. The first liquid flows through header 420 and from header 420 into the process microchannel 210 in the microchannel core setion 410. The second liquid flows through conduit 432 into header 430. The second liquid flows from header 430 into liquid channel 270. The second liquid flows in liquid channel 270 to and through apertured section 240 into process microchannels 210. The first liquid and second liquid are mixed in the process microchannel 210 to form the desired emulsion. The emulsion flows from the process microchannel 210 to and through product footer 440 and from product footer 440 to and through conduit 442 and out of the microchannel mixer 400. FIG. 23 shows an alternate embodiment wherein four process microchannels 210 are employed with a single liquid channel 270 and a single apertured section 240. Specifications for the emulsion process unit may be as follows:

| | |
|---|---|
| Dispersed phase pressure: | 1200 psig |
| Continuous phase pressure: | 300 psig |
| Apertured section length: | Variable, maximum of 8 at 1.25 inches |
| Channel height: | Variable, 0-0.125 inch |
| Channel width: | Variable, 0-0.500 inch |
| Channel insert-two channels | 0.219 inch width × 0.015 inch height |
| Length: | 26.7 inches |
| Width: | 3.00 inches |
| Height: | 3.04 inches |
| Weight: | 50 pounds |
| Material: | 316/316 L stainless steel |
| Seals: | Buna-N and Viton seals |

The process microchannels (210, 640, 660, 660A), liquid channels (270) and heat exchange channels (290, 646, 662) along with the associated headers, footers, manifolds, etc., may be made of any material that provides sufficient strength, dimensional stability, corrosion resistance and heat transfer characteristics to permit the operation of the inventive process. These materials include: steel (e.g., stainless steel, carbon steel, and the like); monel; inconel; aluminum; titanium; nickel; platinum; rhodium; copper; chromium; brass; alloys of any of the foregoing metals; polymers (e.g., thermoset resins); ceramics; glass; composites comprising one or more polymers (e.g., thermoset resins) and fiberglass; quartz; silicon; or a combination of two or more thereof.

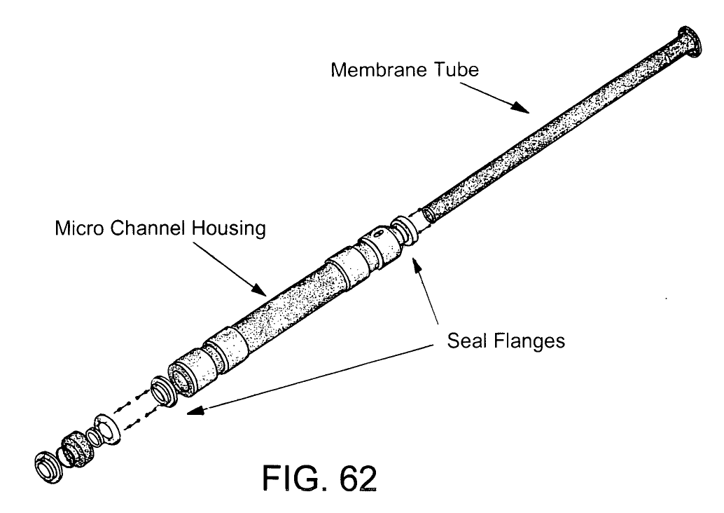

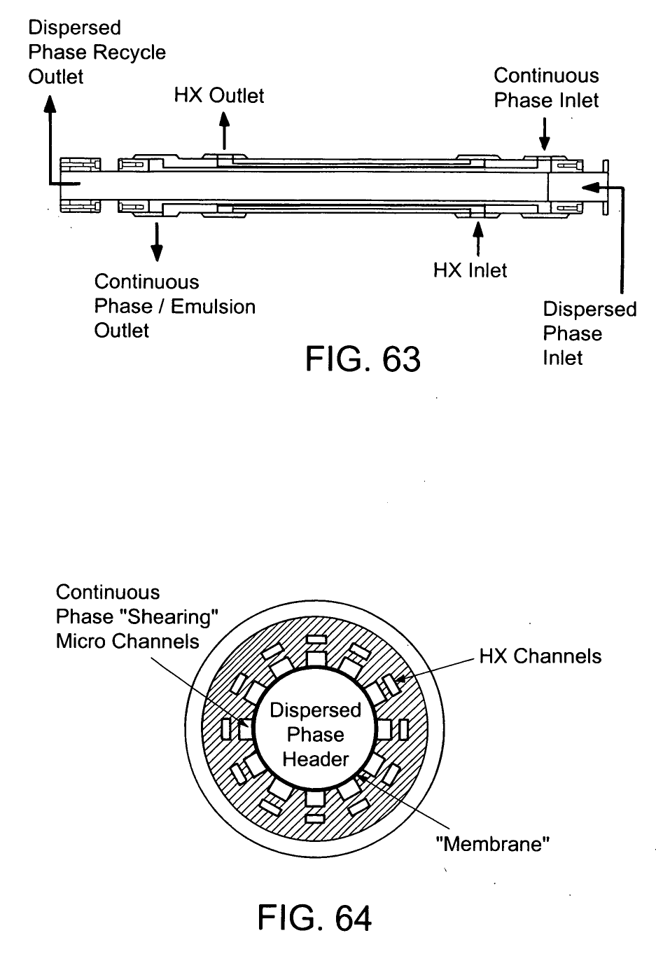

An emulsion process unit that may be used is illustrated in FIGS. 62-64. This unit employs a cylindrical apertured section or membrane and a simple strategy for “numbering up” process microchannels to increase capacity. This may be referred to as having a single-pass design. There are several variations on the concept but all consists of a fabricated housing and cylindrical membrane. Part sizes may be standardized and bulk capacity may be increased by adding emulsion process units in parallel. The cylindrical membrane core (porosity and or numbers of apertures) may be varied for specific applications. As depicted in FIGS. 62-64, the second liquid or dispersed phase flows into the core of the membrane. The first liquid or continuous phase flows over the outside of the membrane core and is contained by the outer sleeve. Shearing characteristics are controlled by the continuous phase microchannel dimensions. Sealing the membrane sufficiently on the dispersed phase side to prevent by-pass around the membrane is one of the problematic issues with flat membrane devices. The cylindrical nature of the membrane eliminates this problem. Components for food or pharmaceutical applications may be fabricated from a stainless steel alloys although other materials may be used. Flange styles may be dictated by the application. Food grade applications may use Tri-Clover style flanges for easy draining and cleaning. Screwed or tube fittings may be desirable for certain applications. Thermocouples/thermowells and pressure transmitters may be installed to monitor metal or fluid temperatures. In most cases however, it typically makes more sense to install process instrumentation in the immediate upstream or downstream process piping versus the emulsion process unit.

Droplets may be formed by forcing the dispersed phase through the membrane core. Additional distribution headers may be added internal to the membrane assembly to vary the flow and/or pressure drop along the length of the device if needed (not shown). Microchannels may be machined into the continuous phase housing (similar to a female spline). Flanges, alignment tube/header, and sealing flange may be welded to the continuous phase microchannel tube such that the continuous phase housing becomes a single fabricated assembly. A circumferential header for the continuous phase fluid may be created by spacing the “seal flange” within the alignment tube/header. There is a single O-ring seal between the membrane shaft and continuous phase housing assembly. There may be two methods for minimizing continuous phase by-pass. The first is a sealing boss that essentially blocks continuous phase flow in the clearance areas between the membrane and housing. The second method is to actually add a “seal” material to the ribs on continuous phase housing or conversely to the “inactive” locations of the membrane. The two primary components may be tapered to allow a precise metal to metal fit. The emulsion product exits through a single flange that also facilitates a transition from microchannel flow back to macropiping.

An assembly for distributed phase flow-by may be used that has many of the same features as the single pass design depicted in FIGS. 62-64. The inlet end is the same. The exit end is very similar to the inlet end. The difference is that the membrane is configured so the dispersed phase can be recycled back, allowing essentially independent pressure control for the dispersed phase. The membrane assembly passes completely though the continuous phase housing. A screw on flange with a back-up seal flange may be used to from a product discharge flange. Similar to the single pass design, the two primary components may be tapered to allow for a precise metal to metal fit.

Alternate configurations may be used for minimizing continuous phase by-pass and forming the continuous phase shearing channels. In one embodiment, a softer material such as aluminum may be used to form the process microchannel as well as form a metal to metal seal. Individual rectangular shaped ribs may be placed into the continuous phase housing before insertion of the membrane. The process microchannel may be formed by machining into both the continuous phase housing and the membrane part. The gasket material may be applied to the membrane rib prior to insertion into the housing. This configuration may be conducive to situations where the membrane holes are being laser drilled. In one embodiment, all the microchannel machining may be confined to the membrane part. Gasket material may be applied to the external membrane rib. These concepts may work with a tapered membrane and matching tapered housing.

In one embodiment, the membrane and housing area may be lengthened to incorporate flanges and headers for active heat exchange for the process microchannels. There are many potential approaches for fabricating the housing which is configured and functions similarly to a shell and tube heat exchanger. Similar to the process headers, circumferential heat exchange headers may be used to disperse and collect the cooling medium. Once the housing is welded, it may become a single part assembly with minimal seals.

In one embodiment, the inventive process may be used to form emulsion containing small, stable emulsion droplets. This process may be valuable for the cosmetic, food, and pharmaceutical industries. One means of generating a small emulsion is to pass the second liquid or dispersed phase through a capillary substrate into a flow-by first liquid or continuous phase. The shear stress force at the base of the capillary pore where a droplet stem is attached is a factor in determining the droplet size at the instant of formation. The shear rate determines the length of time droplets remain resident next to one-another, which in turn impacts the potential for droplet agglomeration. The invention concepts described below are designed to maximize shear rate and stress.

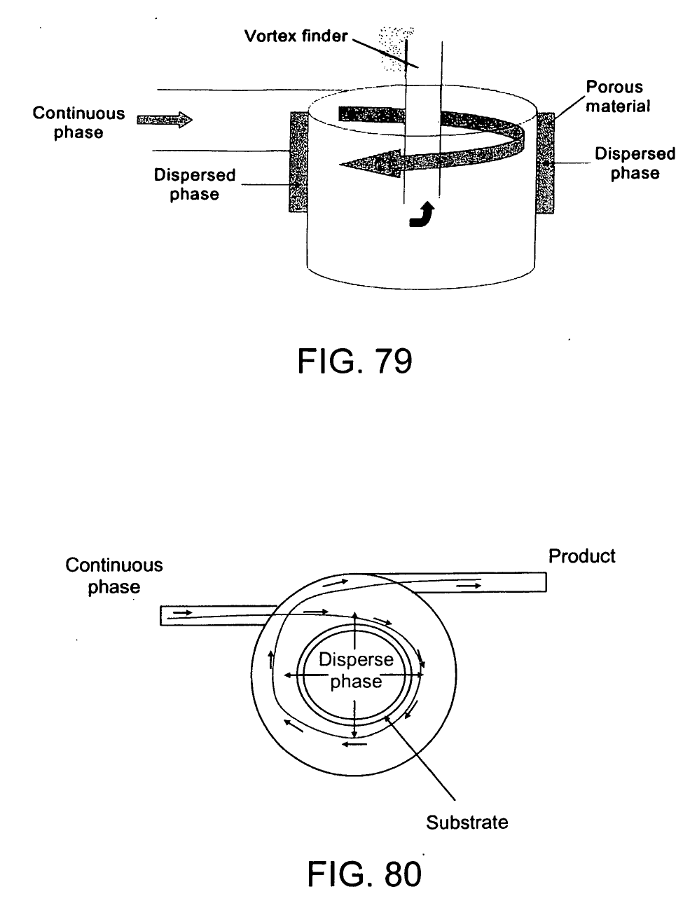

In one embodiment, the first liquid or continuous phase may be introduced tangentially into a cylindrical cavity (or microcyclone), with a vortex finder on the exit orifice in the center of the cylindrical cavity to force a rotating flow around the cylinder as shown in FIG. 79. The dispersed phase is passed through the porous walls and into the micro-cyclone cylindrical cavity as small droplets, where they are continually swept away by the rotating flow of the continuous phase. Eventually the emulsion is swept out of the microcyclone through the vortex finder. The rotating flow is caused by the applied pressure differential across the microcyclone (i.e. the inlet pressure is raised relative to the outlet pressure in the vortex finder) and the rotating flow causes shear force at the wall in proportion to the diameter of the microcyclone and the pressure differential. Because the flow is rotating, the shear against the wall is increased. In addition, the already emulsified portion of the flow is swept away from the wall as the rotating vortex closes in on the vortex finder before leaving the microcyclone, providing a form of mixing as fresh continuous phase is continually swept against the wall. The cylindrical cavity may be cut from the porous substrate material or only portions of the wall may be made of the porous substrate material or have porous material attached. Arrays of microcyclones with parallel feeds can be formed into a single layer and used with stacked plate microchannel fabrication techniques. Microcyclones may be used to segregate large and small droplets once an emulsion is formed, if a second exit is provided for the flow in addition to the vortex finder (which will attract the smaller, less dense droplets and/or particles). This is distinguished from the prior art because the use of a very small diameter cyclone (or microcyclone) leads to much higher shear forces at the wall, allowing smaller droplets to be formed in the emulsion than with conventional technology. The porous substrate at the wall may contain more than one pore size or more than one region each with a different pore size in order to optimize the droplet size distribution or adapt to different shear forces which may occur in different locations inside the microcyclone.

In one embodiment, tangential angular flow as illustrated in FIG. 80 may be used. This concept is a variation on the micro-cyclone concept whereby the first liquid or continuous phase is introduced into an annular region of a shell-and-tube design and rotates with high angular velocity. The second liquid or dispersed phase flows axially down the length of an apertured section or substrate fashioned into a hollow cylinder with the aperatures pointing radially outward from the centerline axis. The angular acceleration of the flow across the surface of the substrate induces increased tangential wall shear stress. The product emulsion stream removal system is so designed such that when the continuous phase achieves the correct viscosity by virtue of the target loading with dispersed phase its angular momentum may result in a flow trajectory that may deliver it precisely to the product removal slots.

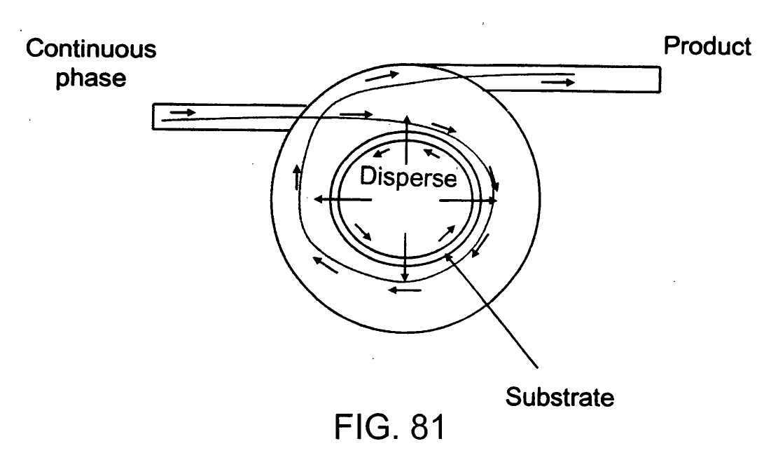

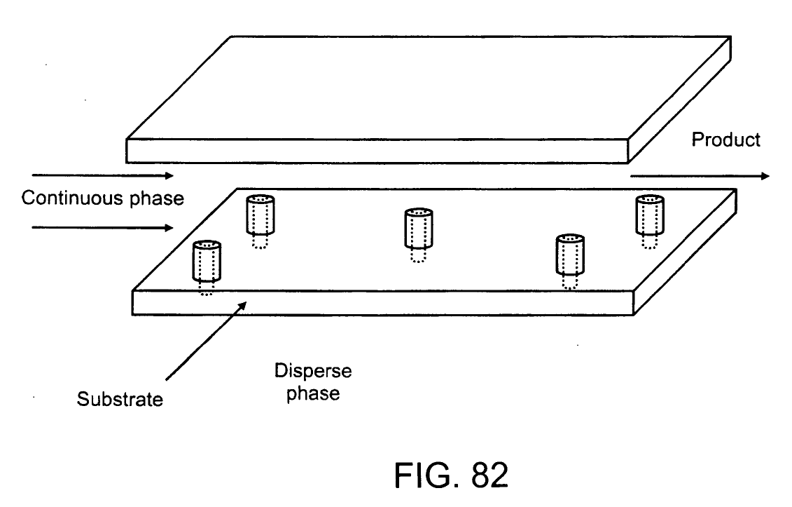

In one embodiment, a counter rotating apertured section or substrate as illustrated in FIG. 81 may be used. This is a variation on the tangential angular flow concept whereby the inner substrate radius rotates in the opposite direction of the annular flow of continuous phase.

In one embodiment, capillary apertured section or substrate posts such as illustrated in FIG. 82 may be used. Wall shear stress is driven by velocity gradient normal to the channel wall. In purely tangential flow, the developed boundary layer near the wall surface may have speeds on an order of magnitude or lower than the bulk flow in the center of the channel. If protrusions such as cylindrical posts extend into the high velocity magnitude region of the flow, then local shear stress may be greatly enhanced. This concept uses small posts with capillary pores buried inside which permit the injection of the dispersed phase into the high velocity region of flow. The small, compact, and rounded features of the post present little perturbation of the flow at the tip of the post, thereby obtaining high flow-by velocities. The presence of the tip surface may provide for a high local velocity gradient. Both of these factors may lead to high local shear stress.

One way of generating a very small uniform emulsion droplet size is to pass the dispersed phase (e.g., mineral oil) through an aperatured substrate into a flow-by continuous phase (e.g., water with optionally a surfactant). The continuous phase flow induces as shear stress force on the base of the droplet stem. Eventually, the cumulative applied force and thinning of the neck may result in detachment of the droplet and advection downstream. Both a fundamental force balance model on the droplet as well as experiments demonstrate that increasing the shear stress at the surface of the substrate at the interface between continuous and dispersed phases results in smaller emulsion droplet formation. Higher local shear rate at the substrate surface may result in lower probability of droplet agglomeration. This follows from the fact that the residence time of two droplets in close proximity may be proportional to the inverse of shear rate. In order to successfully form small, stable emulsions to the highest degree possible, it is desirable to provide a microchannel device that maximizes both local wall shear stress and shear rate at the substrate surface. A series of individual concepts are described below with the objective of maximizing shear stress and shear rate.

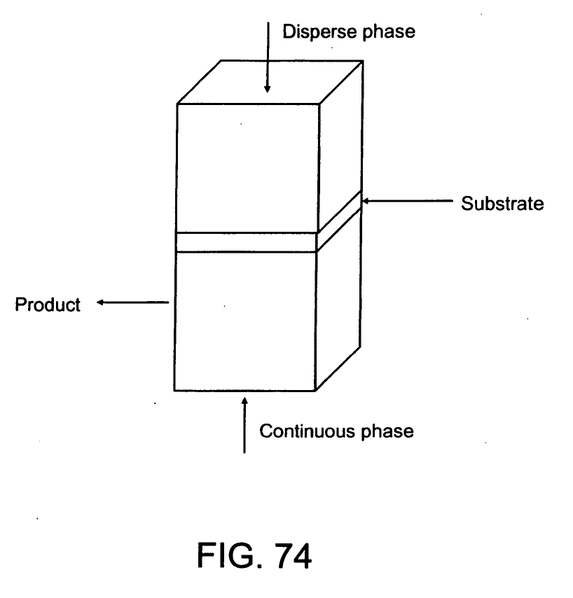

In one embodiment, the cell concept illustrated in FIG. 74 may be used. The continuous phase fluid flow is localized into a small region thereby increasing the local wall shear stress. The continuous phase may either be impinging onto an apertured section or substrate as shown in FIG. 74 or flow tangentially to the apertured section or substrate. The cells may either be arranged in a parallel network whereby the total continuous and dispersed phase flow is divided amongst all the individual cells or arranged in series such that the product stream of one cell can be used as the input stream continuous phase for the next cell.

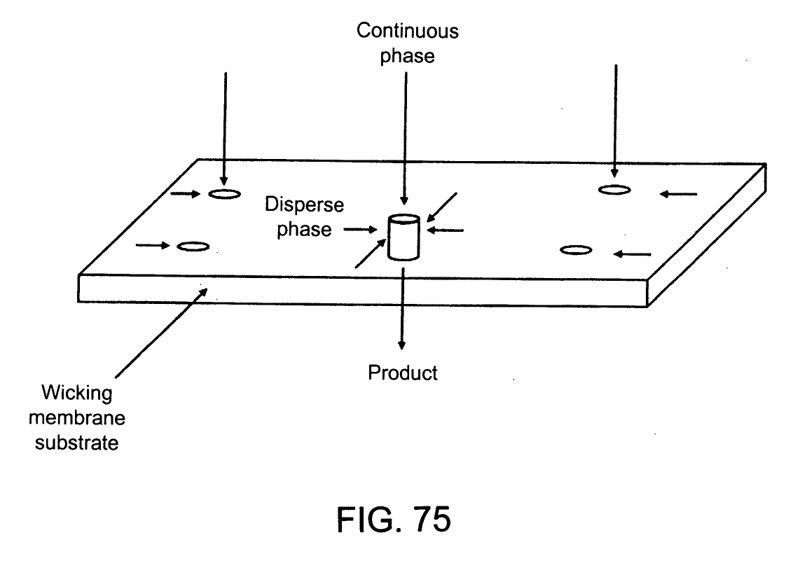

In one embodiment, a wicking membrane with capillary jet orifices as illustrated in FIG. 75 may be used. The dispersed phase is “wicked” (i.e., superficial flow is induced) via capillary action through a porous or fibrous membrane. Small jet channels may be fabricated (e.g., laser drilling) normal to the faces of the substrate separating a continuous phase reservoir or channel from a product channel. The continuous phase flow may be locally accelerated through the jet pore and detaches very small droplets of dispersed phase passing out laterally through the membrane into the jet channel.

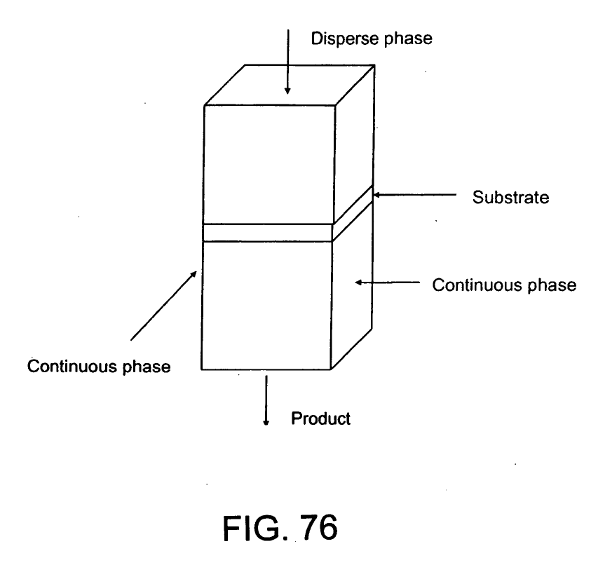

In one embodiment, angled jets may be used as illustrated in FIG. 76. This concept is a variation on the cell concept discussed above whereby a jet (not shown in FIG. 76) is used to introduce a continuous phase into the cell by any desirable angle. The jet orifice may be circular, square, rectangular, a slot with rounded features, or any other geometry that may lead to a large impinging jet plume on the substrate wall inducing high local shear stress.

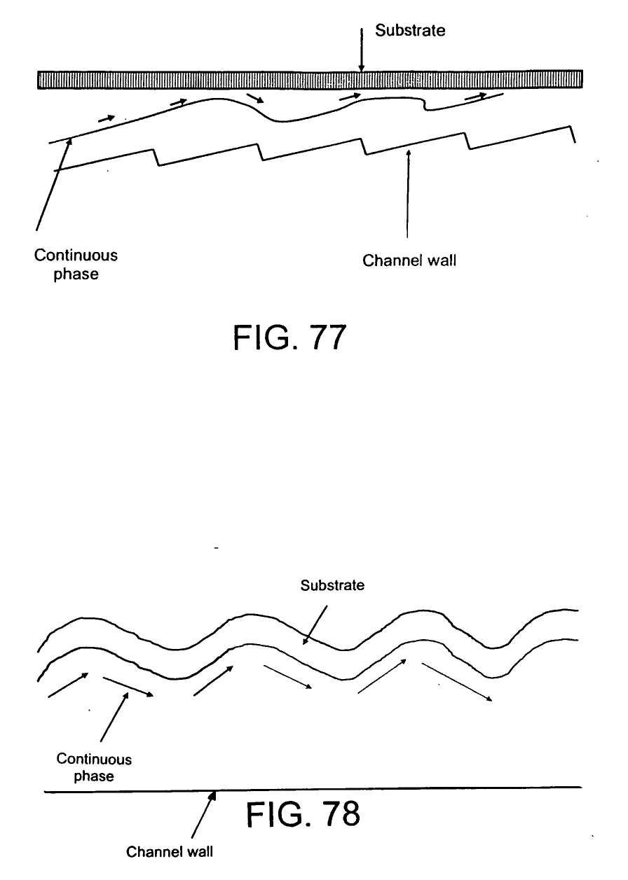

In one embodiment, a ramped channel such as the channel illustrated in FIG. 77 may be used. The ramped channel concept is similar to a tiered or layered surface on the continuous phase channel wall opposite the substrate. The overlaying layers may be oriented as shown in FIG. 77 so that the flow may be directed toward the surface of the substrate, thereby increasing local wall shear.

In one embodiment, a rippled apertured section or substrate such as illustrated in FIG. 78 may be used. The “wavy” or “corrugated” topology of the apertured section may be used so that the fluid flow may be directed toward the apertured section rather than simply pass tangentially to the surface for the entire length of the apertured section.

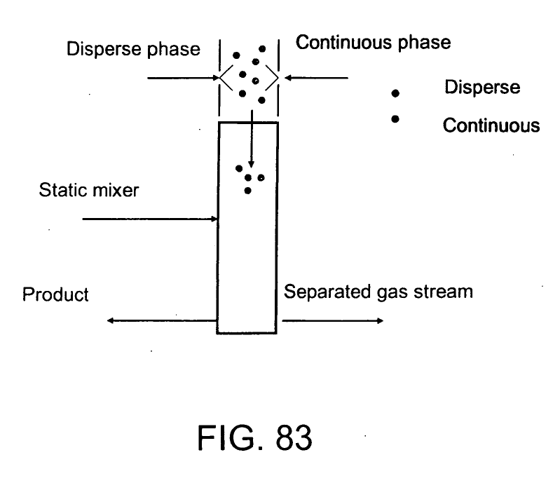

In one embodiment, a spray droplet mixer such as illustrated in FIG. 83 maybe used. Microsprays generate micron-sized droplets of both continuous and dispersed phase in an inert gas medium (e.g., nitrogen). The two streams may be combined using, for example, impinging jets or static mixers. Thereafter the gas may be separated from the liquid product and recycled for more processing, for example, by centrifugal separation.

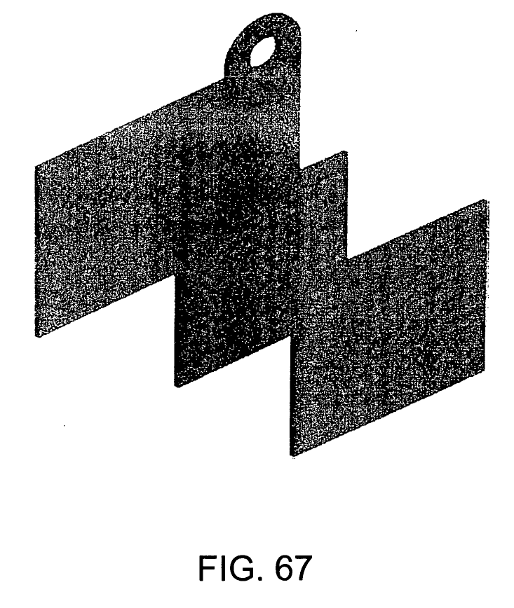

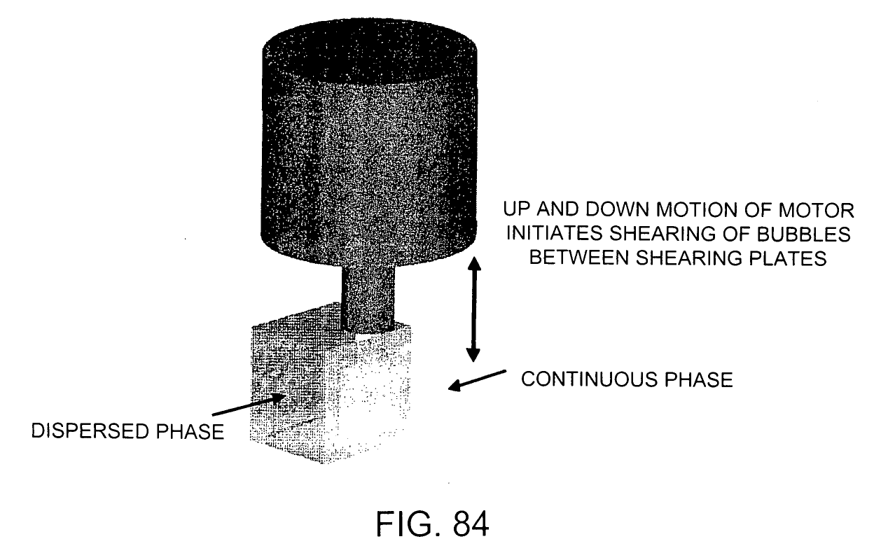

In one embodiment, the droplet size of the emulsions may be reduced by forcing the dispersed phase through openings created by moving apertured parallel plates such as illustrated in FIG. 67. The openings on at least two plates are offset such that when one plate moves in one direction it opens a hole for the second liquid or dispersed phase to flow through. When it moves in the opposite direction it cuts off the flow and makes the droplet. FIG. 84 illustrates an emulsion process unit for making emulsions using the moving plates, the unit employing a motor for moving the plates up and down.

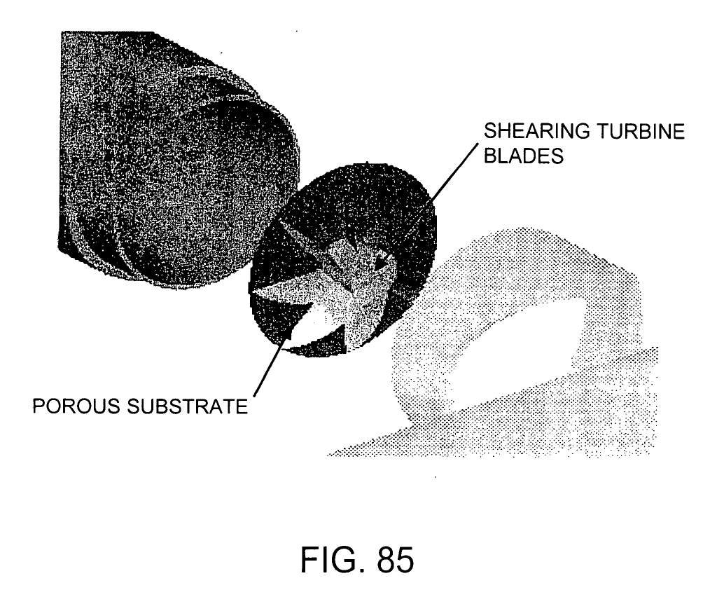

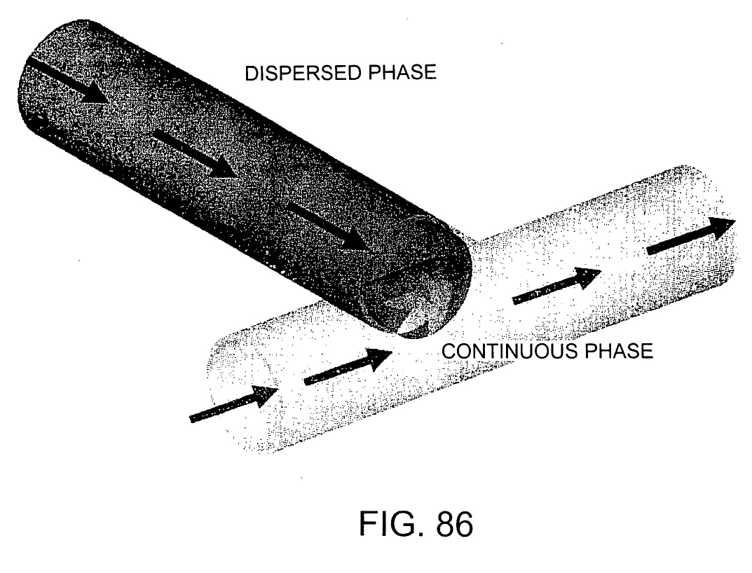

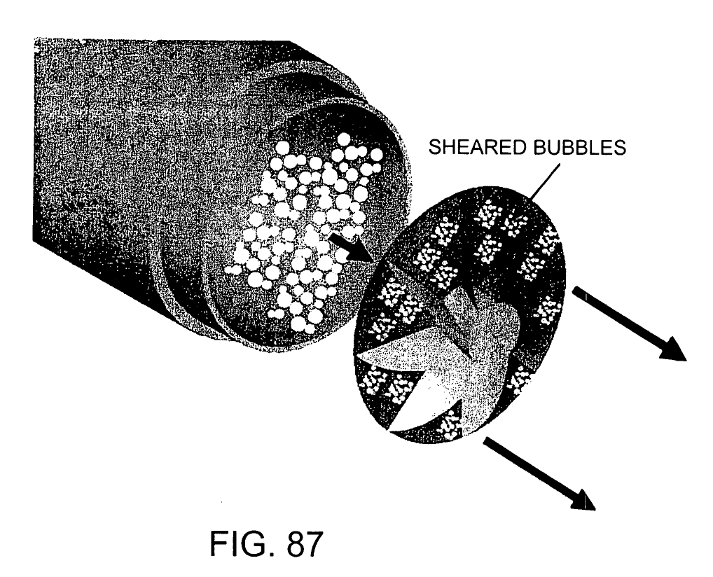

In one embodiment, the droplet size of emulsion may be reduced using a rotating tool or blade to cut the dispersed phase into small droplets after it is forced through a porous substrate or plate. This is illustrated in FIGS. 85-87. In this embodiment, the droplet size may be determined by the flow rate of the dispersed phase, the size of the holes in the porous plate, the distance between the porous plate and the cutting blades, the number and distance between cutting blades, and the rate at which the turbine rotates.

The first liquid and the second liquid may be immiscible relative to each other. The first liquid and/or the second liquid may be a non-Newtonian fluid. Each liquid may be organic, aqueous, or a combination thereof. For example, the first liquid may be benzene and the second liquid may be glycerol, or vice versa. One of the liquids may be an ionic liquid (e.g., a salt of 1-butyl-3-methylimidazolium) while another may be an organic liquid. One of the liquids may comprise water, and another liquid may comprise a hydrophobic organic liquid such as an oil. The emulsions made by the inventive process may be referred to as water-in-oil (w/o) or oil-in-water (o/w) emulsions. Throughout the specification and in the claims the term “oil” is sometimes used to refer to an organic phase of an emulsion although the organic material may or may not be an oil. The first liquid may be present in the emulsion made by the inventive process at a concentration in the range from about 0.1 to about 99.9% by weight, and in one embodiment about 1 to about 99% by weight, and in one embodiment about 5 to about 95% by weight. The second liquid may be present in the emulsion made by the inventive process at a concentration in the range from about 99.9 to about 0.1% by weight, and in one embodiment about 99 to about 1% by weight, and in one embodiment about 95 to about 5% by weight.

The first and/or second liquid may comprise one or more liquid hydrocarbons. The term “hydrocarbon” denotes a compound having a hydrocarbon or predominantly hydrocarbon character. These hydrocarbon compounds include the following:

(1) Purely hydrocarbon compounds; that is, aliphatic compounds, (e.g., alkane or alkylene), alicyclic compounds (e.g., cycloalkane, cycloalkylene), aromatic compounds, aliphatic- and alicyclic-substituted aromatic compounds, aromatic-substituted aliphatic compounds and aromatic-substituted alicyclic compounds, and the like. Examples include hexane, dodecane, cyclohexane, ethyl cyclohexane, benzene, toluene, the xylenes, ethyl benzene, styrene, etc.

(2) Substituted hydrocarbon compounds; that is, hydrocarbon compounds containing non-hydrocarbon substituents which do not alter the predominantly hydrocarbon character of the compound. Examples of the non-hydrocarbon substituents include hydroxy, acyl, nitro, halo, etc.

(3) Hetero substituted hydrocarbon compounds; that is, hydrocarbon compounds which, while predominantly hydrocarbon in character, contain atoms other than carbon in a chain or ring otherwise composed of carbon atoms. The hetero atoms include, for example, nitrogen, oxygen and sulfur.

The first and/or second liquid may comprise a natural oil, synthetic oil, or mixture thereof. The natural oils include animal oils and vegetable oils (e.g., castor oil, lard oil) as well as mineral oils such as liquid petroleum oils and solvent treated or acid-treated mineral oils of the paraffinic, naphthenic or mixed paraffinic-naphthenic types. The natural oils include oils derived from coal or shale. The oil may be a saponifiable oil from the family of triglycerides, for example, soybean oil, sesame seed oil, cottonseed oil, safflower oil, and the like. The oil may be a silicone oil (e.g., cyclomethicone, silicon methicones, etc.). The oil may be an aliphatic or naphthenic hydrocarbon such as Vaseline, squalane, squalene, or one or more dialkyl cyclohexanes, or a mixture of two or more thereof. Synthetic oils include hydrocarbon oils such as polymerized and interpolymerized olefins (e.g., polybutylenes, polypropylenes, propylene isobutylene copolymers, etc.); poly(1-hexenes), poly-(1-octenes), poly(1-decenes), etc. and mixtures thereof; alkylbenzenes (e.g., dodecylbenzenes, tetradecylbenzenes, dinonylbenzenes, di-(2-ethylhexyl)benzenes, etc.); polyphenyls (e.g., biphenyls, terphenyls, alkylated polyphenyls, etc.); alkylated diphenyl ethers and alkylated diphenyl sulfides and the derivatives, analogs and homologs thereof and the like. Alkylene oxide polymers and interpolymers and derivatives thereof where the terminal hydroxyl groups have been modified by esterification, etherification, etc., are synthetic oils that may be used. The synthetic oil may comprise a poly-alpha-olefin or a Fischer-Tropsch synthesized hydrocarbon.

The first and/or second liquid may comprise a normally liquid hydrocarbon fuel, for example, a distillate fuel such as motor gasoline as defined by ASTM Specification D439, or diesel fuel or fuel oil as defined by ASTM Specification D396.

The first and/or second liquid may comprise a fatty alcohol, a fatty acid ester, or a mixture thereof. The fatty alcohol may be a Guerbet alcohol. The fatty alcohol may contain from about 6 to about 22 carbon atoms, and in one embodiment about 6 to about 18 carbon atoms, and in one embodiment about 8 to about 12 carbon atoms. The fatty acid ester may be an ester of a linear fatty acid of about 6 to about 22 carbon atoms with linear or branched fatty alcohol of about 6 to about 22 carbon atoms, an ester of a branched carboxylic acid of about 6 to about 13 carbon atoms with a linear or branched fatty alcohol of about 6 to about 22 carbon atoms, or a mixture thereof. Examples include myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. The fatty acid ester may comprise: an ester of alkyl hydroxycarboxylic acid of about 18 to about 38 carbon atoms with a linear or branched fatty alcohol of about 6 to about 22 carbon atoms (e.g., dioctyl malate); an ester of a linear or branced fatty acid of about 6 to about 22 carbon atoms with a polyhydric alcohol (for example, propylene glycol, dimer diol or trimer triol) and/or a Guerbet alcohol; a triglyceride based on one or more fatty acids of about 6 to about 18 carbon atoms; a mixture of mono-, di- and/or triglycerides based on one or more fatty acids of about 6 to about 18 carbon atoms; an ester of one or more fatty alcohols and/or Guerbet alcohols of about 6 to about 22 carbon atoms with one or more aromatic carboxylic acids (e.g., benzoic acid); an ester of one or more dicarboxylic acids of 2 to about 12 carbon atoms with one or more linear or branched alcohols containing 1 to about 22 carbon atoms, or one or more polyols containing 2 to about 10 carbon atoms and 2 to about 6 hydroxyl groups, or a mixture of such alcohols and polyols; an ester of one or more dicarboxylic acids of 2 to about 12 carbon atoms (e.g., phthalic acid) with one or more alcohols of 1 to about 22 carbon atoms (e.g., butyl alcohol, hexyl alcohol); an ester of benzoic acid with linear and/or branched alcohol of about 6 to about 22 carbon atoms; or mixture of two or more thereof.

The first and/or second liquid may comprise: one or more branched primary alcohols of about 6 to about 22 carbon atoms; one or more linear and/or branched fatty alcohol carbonates of about 6 to about 22 carbon atoms; one or more Guerbet carbonates based on one or more fatty alcohols of about 6 to about 22 carbon atoms; one or more dialkyl (e.g., diethylhexyl) naphthalates wherein each alkyl group contains 1 to about 12 carbon atoms; one or more linear or branched, symmetrical or nonsymmetrical dialkyl ethers containing about 6 to about 22 carbon atoms per alkyl group; one or more ring opening products of epoxidized fatty acid esters of about 6 to about 22 carbon atoms with polyols containing 2 to about 10 carbon atoms and 2 to about 6 hydroxyl groups; or a mixture of two or more thereof.

The first and/or second liquid may comprise water. The water may be taken from any convenient source. The water may be deionized or purified using osmosis or distillation.

Although emulsifiers and/or surfactants are not required for one or more embodiments of the invention, it is possible to use one or more emulsifiers and/or surfactants in forming the emulsions prepared by the inventive process. The emulsifiers and/or surfactant can be premixed with either the first and/or second liquid. The emulsifiers and/or surfactants may comprise ionic or nonionic compounds having a hydrophilic lipophilic balance (HLB) in the range of zero to about 18 in Griffin's system, and in one embodiment about 0.01 to about 18. The ionic compounds may be cationic or amphoteric compounds. Examples include those disclosed in McCutcheons Surfactants and Detergents, 1998, North American & International Edition. Pages 1-235 of the North American Edition and pages 1-199 of the International Edition are incorporated herein by reference for their disclosure of such emulsifiers. The emulsifiers and/or surfactants that may be used include alkanolamines, alkylarylsulfonates, amine oxides, poly(oxyalkylene) compounds, including block copolymers comprising alkylene oxide repeat units, carboxylated alcohol ethoxylates, ethoxylated alcohols, ethoxylated alkyl phenols, ethoxylated amines and amides, ethoxylated fatty acids, ethoxylated fatty esters and oils, fatty esters, fatty acid amides, glycerol esters, glycol esters, sorbitan esters, imidazoline derivatives, lecithin and derivatives, lignin and derivatives, monoglycerides and derivatives, olefin sulfonates, phosphate esters and derivatives, propoxylated and ethoxylated fatty acids or alcohols or alkyl phenols, sorbitan derivatives, sucrose esters and derivatives, sulfates or alcohols or ethoxylated alcohols or fatty esters, sulfonates of dodecyl and tridecyl benzenes or condensed naphthalenes or petroleum, sulfosuccinates and derivatives, and tridecyl and dodecyl benzene sulfonic acids. The emulsifiers and/or surfactants may comprise: one or more polyalkylene glycols; one or more partial esters of glycerol or sorbitan and fatty acids containing about 12 to about 22 carbon atoms; or a mixture thereof. The emulsifier and/or surfactant may comprise a pharmaceutically acceptable material such as lecithin. The concentration of these emulsifiers and/or surfactants in the emulsions made by the inventive process may range up to about 20% by weight of the emulsion, and in one embodiment in the range from about 0.01 to about 5% by weight, and in one embodiment from about 0.01 to about 2% by weight. In one embodiment, the concentration may be up to about 2% by weight, and in one embodiment up to about 1% by weight, and in one embodiment up to about 0.5% by weight.

The emulsions made by the inventive process may contain one or more of the following additives. These additives may be premixed with the first and/or second liquid. These additives include: UV protection factors (e.g., 3-benzylidene camphor and derivatives thereof, 4-aminobenzoic acid derivatives, esters of salicylic acid, derivatives of benzophenone, esters of benzalmalonic acid, triazine derivatives, 2-phenylbenzimidazole-5-sulfonic acid and salts thereof, sulfonic acid derivatives of benzophenone and salts thereof, derivatives of benzoyl methane); waxes (e.g., candelilla wax, carnauba wax, Japan wax, cork wax, rice oil wax, sugar cane wax, beeswax, petrolatum, polyalkylene waxes, polyethylene glycol waxes); consistency factors (e.g., fatty alcohols, hydroxy fatty alcohols; partial glycerides, fatty acids, hydroxy fatty acids); thickeners (e.g., polysaccharides such as xanthan gum, guar-guar and carboxymethyl cellulose, polyethylene glycol monoesters and diesters, polyacrylates, polyacrylamides, polyvinyl alcohol, polyvinyl pyrrolidone); superfatting agents (e.g., lanolin, lecithin, polyol fatty acid esters, monoglycerides, fatty acid alkanolamides); stabilizers (e.g., metal salts of fatty acids, such as magnesium, aluminum or zinc stearate or ricinoleate); polymers (e.g., catonic polymers such as cationic cellulose derivatives, cationic starch, copolymers of diallyl ammonium salts and acrylamides, quaternized vinyl pyrrolidone/vinyl imidazole polymers, polyethyeneimine, cationic silicone polymers, polyaminopolyamides; anionic, zwitterionic, amphoteric and nonionic polymers); silicone compounds (e.g., dimethyl polysiloxanes; methyl phenyl polysiloxanes; cyclic silicones; amino-, fatty acid-, alcohol-, polyether-, epoxy-, fluorine-, glycoside- and/or alkyl-modified silicone compounds; simethicones; dimethicones); fats; waxes; lecithins; phospholipids; biogenic agents (e.g., tocopherol, ascorbic acid, deoxyribonucleic acid, retinol, amino acids, plant extracts, vitamin complexes); antioxidants (e.g., amino acids, imidazoles, peptides, carotinoids, carotenes, liponic acid and derivatives thereof, aurothioglucose, propylthiouracil, dilaurylthiodipropionate, sulfoximine compounds, metal chelators such as alpha-hydroxy fatty acids, alpha-hydroxy acids such as citric or lactic acid, humic acid, bile acid, EDTA, EGTA, folic acid and derivatives thereof, vitamin complexes such as vitamins A, C or E, stilbenes and derivatives thereof); deodorants; antiperspirants; antidandruff agents; swelling agents (e.g., montmorillonites, clay minerals); insect repellents; self-tanning agents (e.g., dihydroxyacetone); tyrosine inhibitors (depigmenting agents); hydrotropes (e.g., ethanol, isopropyl alcohol, and polyols such as glycerol and alkylene glycols used to improve flow behavior); solubilizers; preservatives (e.g., phenoxyethanol, formaldehyde solution, parabens, pentane diol, sorbic acid), perfume oils (e.g., extracts of blossoms, fruit peel, roots, woods, herbs and grasses, needles and branches, resins and balsams, and synthetic perfumes including esters, ethers, aldehydes, ketones, alcohols and hydrocarbons); dyes; and the like. The concentration of each of these additives in the inventive emulsions may be up to about 20% by weight, and in one embodiment from about 0.01 to about 10% by weight, and in one embodiment about 0.01 to about 5% by weight, and in one embodiment about 0.01 to about 2% by weight, and in one embodiment about 0.01 to about 1% by weight.

The inventive emulsions may contain one or more particulate solids. These may be premixed with the first liquid. The particulate solids may be organic, inorganic, or a combination thereof. The particulate solids may comprise catalysts (e.g., combustion catalysts such as CeO₂/BaAl₁₂O₁₉, Pt/Al₂O₃, etc., polymerization catalysts, and the like), pigments (e.g., TiO₂, carbon black, iron oxides, etc.), fillers (e.g., mica, silica, talcum, barium sulfate, polyethylenes, polytetrafluroethylene, nylon powder, methyl methacrylate powder), etc. The particulate solids may comprise nanosize particles. The particulate solids may have a mean particle diameter in the range of about 0.001 to about 10 microns, and in one embodiment about 0.01 to about 1 micron. The concentration of the particulate solids in the emulsions may range up to about 70% by weight, and in one embodiment from about 0.1 to about 30% by weight based on the weight of the emulsion.

In one embodiment, the emulsions made using the inventive process may have a narrow distribution of droplet sizes when compared to emulsions made using conventional emulsification processes. The benefits of narrow droplet size distribution include, for example, uniform spread of active ingredients on an applied surface such as skin, and exclusions of unwanted small droplet penetration into small scale surface structures that may occur using an emulsion having a wide distribution. Another advantage relates to reducing the use of surfactants, as excess surfactant is often used to maintain a stable emulsion due to the presence of the smallest droplets if the emulsion droplet size distribution has a wide range, for example, from about 2 to about 20 microns. A narrow droplet size distribution enables a more accurate determination of the amount of surfactant that is just required, and in turn reduces or eliminates the use of unnecessary surfactant. In one embodiment of the present invention, when the droplet size distribution is sufficiently narrow, for example a span of less than about 0.5, the amount of surfactant that may be used can be reduced significantly since the emulsion does not contain unwanted small droplets that may require a higher surfactant concentration in the whole emulsion after production has been completed.

In one embodiment, the emulsion made by the inventive process comprises a discontinuous phase dispersed in a continuous phase. The discontinuous phase may comprise droplets having a volume-based mean diameter of up to about 200 microns, and in one embodiment about 0.01 to about 200 microns, and in one embodiment about 0.01 to about 100 microns, and in one embodiment about 0.01 to about 50 microns, and in one embodiment about 0.01 to about 25 microns, and in one embodiment about 0.01 to about 10 microns, and in one embodiment about 0.01 to about 5 microns, and in one embodiment about 0.01 to about 2 microns, and in one embodiment about 0.01 to about 1 micron, and in one embodiment about 0.01 to about 0.5 micron, and in one embodiment about 0.01 to about 0.2 micron, and in one embodiment about 0.01 to about 0.1 micron, and in one embodiment about 0.01 to about 0.08 micron, and in one embodiment about 0.01 to about 0.05 micron, and in one embodiment about 0.01 to about 0.03 micron, and in one embodiment about 0.1 to about 200 microns, and in one embodiment about 0.1 to about 100 microns, and in one embodiment about 0.1 to about 50 microns, and in one embodiment about 0.1 to about 25 microns. In one embodiment, the discontinuous phase comprises water and the continuous phase comprises an organic liquid. In one embodiment, the discontinuous phase comprises an organic liquid and the continuous phase comprises water or another organic liquid. The continuous phase may contain particulate solids dispersed or suspended in the continuous phase. The discontinuous phase may contain particulate solids and/or droplets encapsulated within droplets in the discontinuous phase. An advantage of the inventive process is that at least in one embodiment the droplets may be characterized by having a relatively narrow distribution of droplet sizes. In one embodiment, the droplet sizes in the dispersed phase may be plotted with the result being a normal distribution curve.

“Relative span” is often referred to as “span.” It is a dimensionless parameter calculated from volume distribution. As with volume median droplet size (VMD), D[v,0.1] and D[v,0.9] are diameters representing the points at which 10% and 90%, respectively, of the volume of liquid dispersed is in droplets of smaller diameter. The span may be defined as D[v,0.9] minus D[v,0.1] which is then divided by the VMD (D[v,0.5]). The span for the droplets in emulsions made by the inventive process may be in the range from about 0.005 to about 10, and in one embodiment about 0.01 to about 10, and in one embodiment about 0.01 to about 5, and in one embodiment about 0.01 to about 2, and in one embodiment about 0.01 to about 1, and in one embodiment about 0.01 to about 0.5, and in one embodiment about 0.01 to about 0.2, and in one embodiment about 0.01 to about 0.1. In one embodiment, the inventive process may be conducted in a single process microchannel and the span may be in the range of from about 0.01 to about 0.5. In one embodiment, the inventive process may be conducted in a scaled-up emulsification process employing multiple process microchannels and the span may be in the range from about 0.01 to about 1.

In one embodiment, the volume-based diameter for the droplets in the emulsions made by the inventive process may be in the range up to about 200 microns, and the span may be in the range from about 0.005 to about 10. In one embodiment, the volume-based mean droplet diameter may be in the range from about 0.01 to about 100 microns, and the span may be in the range from about 0.01 to about 5. In one embodiment, the volume-based mean droplet diameter may be in the range from about 0.01 to about 50 microns, and the span may be in the range from about 0.02 to about 5. In one embodiment, the volume-based mean droplet diameter may be in the range from about 0.01 to about 10 microns, and the span may be in the range from about 0.05 to about 2.5. In one embodiment, the volume-based mean droplet diameter may be in the range from about 0.01 to about 5 microns, and the span may be in the range from about 0.01 to about 2. In one embodiment, the volume-based mean droplet diameter may be in the range of about 0.01 to about 1 micron, and the span may be in the range of about 0.005 to about 1. In one embodiment, the volume-based mean droplet diameter may be in the range from about 0.1 to about 25 microns, and the span may be in the range from about 1 to about 5.

In one embodiment, the emulsion produced by the inventive process may be terminally filtered or filtered in-line. The use of such filtering is particularly suitable for producing emulsions such as pharmaceutical compositions where sterilization issues are significant. With such filtering relatively large particles of contaminants (e.g., biological materials) may be removed. In one embodiment, the inventive process includes providing for the filtering of the product emulsion in-line in a continuous closed (i.e., antiseptic) process.

An advantage of the inventive process, at least in one embodiment, is that the gap distances between the process microchannels, liquid channels and heat exchange channels may be the same whether the process is intended for laboratory or pilot plant scale or for full production scale. As a result, the particle size distribution of the emulsions produced by the microchannel mixers used with the inventive process may be substantially the same whether the microchannel mixer is built on a laboratory or pilot plant scale or as a full scale plant unit.

Shear force or stress on a liquid control element (in discretized form) in the direction of velocity u may be calculated by the formula Fx=mu*du/dy, where mu is viscosity, and du/dy is the velocity gradient for the liquid flow normal to the apertured section. However, as in a location of liquid (represented by a control element) the velocity generally has three components, and shear force also has three components. For a channel flow near and at the surface, a one dimensional assumption can be made and Fₓ can approximate the net shear stress at an element surface of the liquid. The use of computational fluid dynamics, including commercial software packages such as Fluent or FEMLAB, may be used to solve the required transport equations such that the surface shear force may be calculated. The surface shear force or stress may be calculated along the channel length, parallel to the direction of flow. Shear force or stress may also be calculated between parallel channels, where flow distribution effects are included to determine the mass flux into each parallel channel as a function of the detailed channel and manifold geometry. Additional calculation methods can be found, for example, in “Fundamentals of Fluid Mechanics,” 3^{rd} Ed., B. R. Munson, D. F. Young and T. H. Okiishi, John Wiley & Son, Inc., Weinheim, 1998.

In one embodiment, the shear force deviation factor (SFDF) for a process employing a single process microchannel may be within about 50% of the SFDF for a scaled-up process involving multiple process microchannels. SFDF may be calculated using the formula
SFDF=(Fₘₐₓ−Fₘᵢₙ)/(2Fₘₑₐₙ)
wherein: Fₘₐₓ is the maximum shear stress force in a process microchannel for a specific liquid; Fₘᵢₙ is the minimum shear stress force in the process microchannel for the liquid; and Fₘₑₐₙ is the arithmetic average shear force for the liquid at the surface of the apertured section (140, 140a, 240, 415, 425, 435, 445, 511, 521, 531, 541) within the process microchannel. Within a single process microchannel, operated in accordance with the inventive process, the SFDF may be less than about 2, and in one embodiment less than about 1, and in one embodiment less than about 0.5, and in one embodiment less than about 0.2.

In one embodiment, the inventive process may provide for a relatively uniform shear force while employing multiple process microchannels. To measure the shear force uniformity among multiple process microchannels, the average shear force is calculated for each channel and compared. Fₘₐₓ is the largest value of the average channel shear force, and Fₘᵢₙ is the smallest value of the average shear force. Fₘₑₐₙ is the mean of the average shear forces of all the channels. SFDF may be calculated from these values. Among multiple process microchannels, at least with one embodiment of the inventive process, the SFDF may be less than about 2, and in one embodiment less than about 1, and in one embodiment less than about 0.5, and in one embodiment less than about 0.2.

While not wishing to be bound by theory, it is believed that, in one embodiment, the inventive process generates the dispersed phase droplets at the surface of the apertured section 240 within the process microchannel 210. With the inventive process the shear force at the wall of the apertured section 240 where droplet formation and detachment takes place may be intensified. This process also may enhance the shear rate in the bulk flow of the process microchannel resulting in lower residence time of droplets in close proximity and thereby reducing the potential for droplet coalescence. The resulting shear profile may offer a number of advantages over conventional processes including: (1) reducing the potential for over-shearing of the emulsion, (2) reducing the overall energy consumption for the same or smaller average droplet size, and (3) increasing the shear rate gradient across the process microchannel height or width which in turn forces the transport of droplets towards the center of the process microchannel and in turn reduces the chance of droplet collision near the apertured section surface. The roles of shear stress and shear rate may be as follows. The full equation for stress in a fluid may be given by the formula (as a vector quantity)
\overline{τ}=μ(T,\dot{γ})\overline{∇}×\overline{u} (1)
where
\overline{τ}=shear vector (Pa)
μ=viscosity (Pa·s)
\overline{u}=local velocity (m/s)
T=local temperature (K)
\dot{γ}=shear rate (described below).

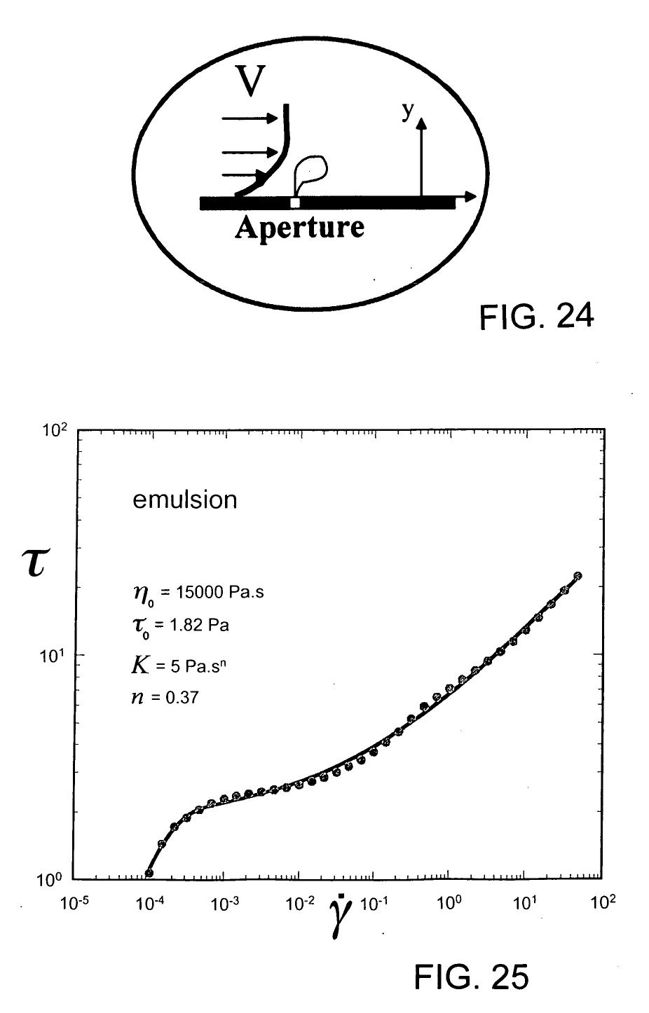

The tangential component (parallel to the apertured section surface where emulsion takes place) of shear stress may be the component of stress that causes successive parallel layers of liquid flow to move in their own planes (i.e., the plane of shear), relative to each other. This component of shear stress may be relevant to emulsion droplet formation and may be calculated as follows:

$${τ}_{yx} = - μ ( T , \dot{γ} ) \frac{\partial {u}_{x}}{\partial y}$$

where μₓ is the velocity component in the x (axial) direction of flow and y is the dimension in the channel gap measured in the positive sense as one proceeds away from the emulsification surface into the channel bulk flow. This may be shown as illustrated in FIG. 24.

The second liquid or dispersed phase may pass through an apertured section with pores of dimensions on the order of tenths to hundredths of a micron in diameter. The first liquid or continuous phase may flow normal to the direction of flow of the dispersed phase through the individual capillary pores and force detachment of the droplet near the attachment point out of the pore. The shear force, which may contribute to the overall drag force on the droplet, may be a primary mechanism by which droplet formation takes place.

An element of shear stress may be the associated shear rate (rate of shear strain), specifically the tangential velocity gradient normal to the surface of the channel wall. Shear rate may be denoted by the symbol

$$\dot{γ} = \frac{\partial {u}_{x}}{\partial y} .$$

Many of the formulations used for emulsions are non-Newtonian, namely fluids for which the ratio of shear stress to shear rate is not a constant, as exemplified in FIG. 25. The viscosity of a fluid, which represents the tendency (or lack thereof) for two adjacent molecules to flow by one-another, may be the ratio of shear stress to shear rate. A non-Newtonian fluid may be one in which the viscosity changes with applied shear force. Thus, rather than representing a fixed constant, viscosity may be a function of shear rate and temperature. Concentrated emulsions, such as oftentimes used in the cosmetic or food industries, may be characterized by a certain class of non-Newtonian fluids known as viscoplastic or yield-stress liquids. These liquids may possess lower and upper bounds on yield stress below which they behave as high viscosity liquids and above which they exhibit shear thinning behavior.

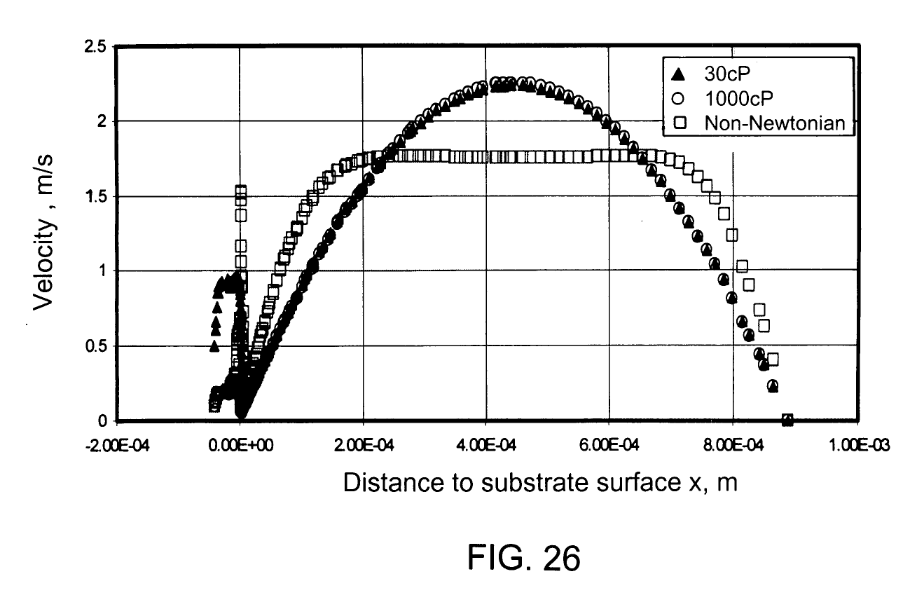

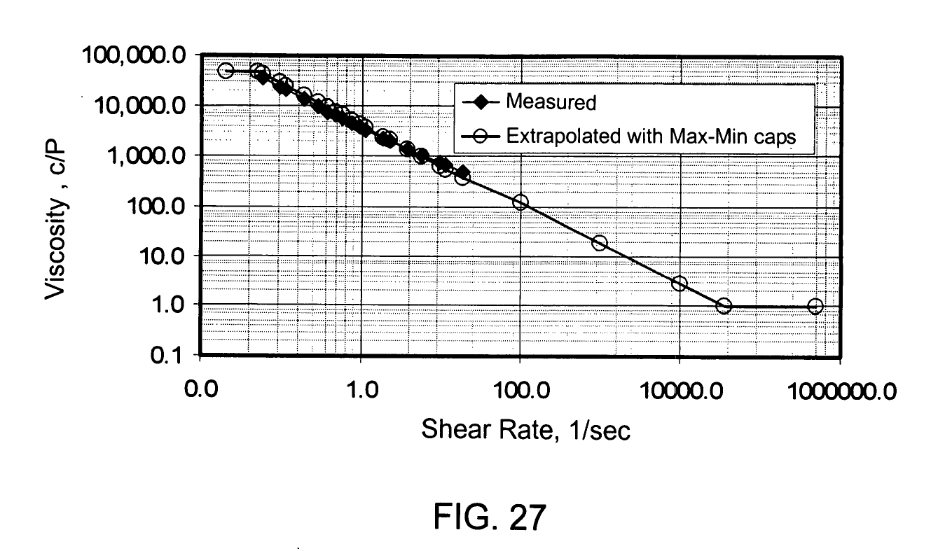

FIG. 26 illustrates the difference in axial velocity component magnitude, μₓ as a function of distance from the substrate surface, y, for a Newtonian and non-Newtonian fluid. The microchannel has a height or width of 0.9 mm and length of 2.5 cm and the continuous phase is flowing at an average rate of 1.7 m/s. The product may have the rheogram (viscosity as a function of shear rate for constant temperature) illustrated in FIG. 27. Because of the relatively small height or width sizes possessed by microchannels as compared to their conventional counterparts, the resulting gradient in velocity normal to the surface may be greater for the same average flow rate. The velocity profile for the laminar, Newtonian flows (30 and 1000 cP) are virtually identical and have the characteristic parabolic profile. The non-Newtonian fluid may have a more constant velocity profile in the bulk flow and may exhibit a steeper velocity gradient in the vicinity of the process microchannel walls. This increase in velocity gradient may lead to higher local shear forces leading to prompter droplet detachment and correspondingly smaller mean droplet sizes. For the microchannel mixer the wall shear stress within the process microchannel where the emulsion is formed may be larger than the shear stress in the bulk fluid. The wall shear stress may be at least a factor of two greater than the shear stress along the centerline of the process microchannel, and in some cases more than a factor of five greater at the wall than the process microchannel centerline.

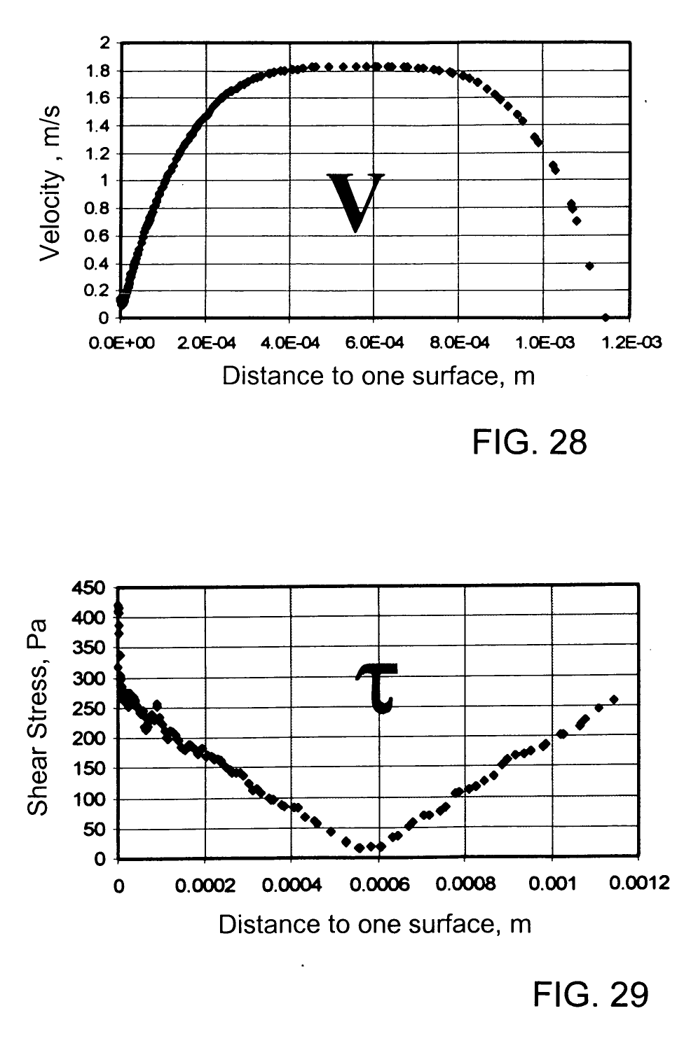

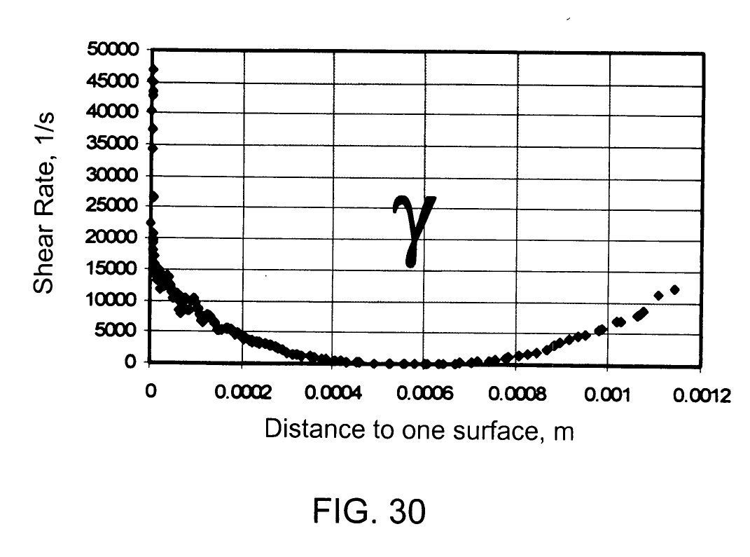

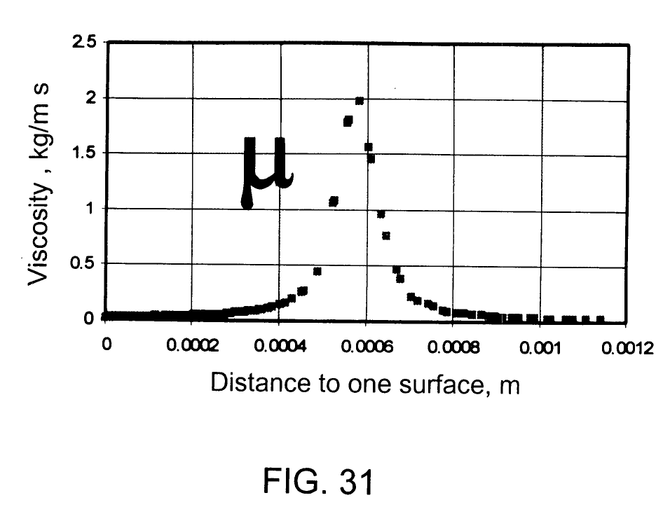

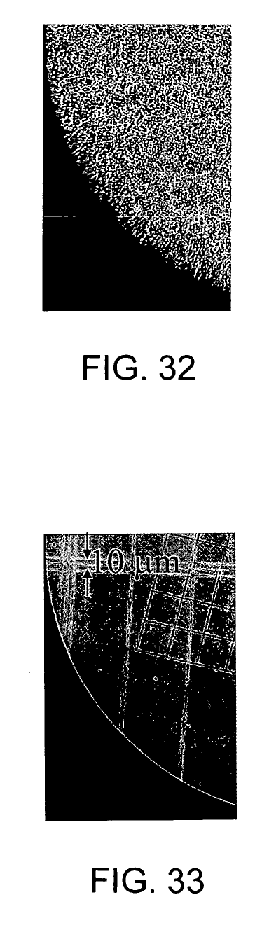

The velocity profile and rheology of the fluid may determine the final shear force profile. Calculation of the profiles of shear rate, velocity and shear stress based on test flow rates of continuous phase (first liquid) and dispersed phase (second liquid) liquids are plotted in FIGS. 28-31. The resulting profiles show that the shear force at the wall of the apertured section may be higher than that in the flow bulk. A microscopic image of the emulsion in FIGS. 32-33 demonstrates that the emulsion is of a small and uniform droplet size.

In one embodiment, numerical models may be developed to predict droplet size based on the process parameters. Two different levels of model may be used, namely

An analytical force balance model to predict droplet diameter at the instant of detachment from the substrate capillary pore, and

A computational fluid dynamics (CFD) model using the volume of fluid method for performing time-dependent simulations of droplet formation and morphology.

In one embodiment, the force model may have the virtue of incorporating most of the relevant physical phenomenology into a simple analytical tool for assessing droplet detachment size as a function of (1) microchannel configuration: hydraulic diameter, apertured section roughness characteristics and average pore size, wall adhesion contact angle; (2) process flow conditions: flow rate of continuous and dispersed phase; and (3) fluidic properties: viscosity, density, interfacial surface tension. The CFD model focuses on the performance of one single pore and represents a higher level of sophistication in terms of the impact of the fluid dynamics of the microchannel flow on emulsion formation.

The list of primary forces impacting droplet detachment size in decreasing order of relative magnitude may be as follows:
1) Drag force: the hydrodynamic force exerted by the flow-by continuous phase liquid on the surface of the droplet.
2) Interfacial tension force: the cohesive intermolecular force that acts on the interface between the emulsion droplet and the surrounding continuous phase to maintain the droplet in one cohesive fluid particle.
3) Capillary force: the viscous drag force resisting the flow of liquid through the individual capillary pores.
4) Dynamic lift force: hydrodynamic lift forces due to passage of the continuous phase between the body of the suspended droplet and the attachment neck at the base of the capillary pore.
5) Inertial force: the force associated with the initial linear momentum imparted to the dispersed phase as it flows out of the capillary pore (generally much smaller in magnitude than the previous four forces).

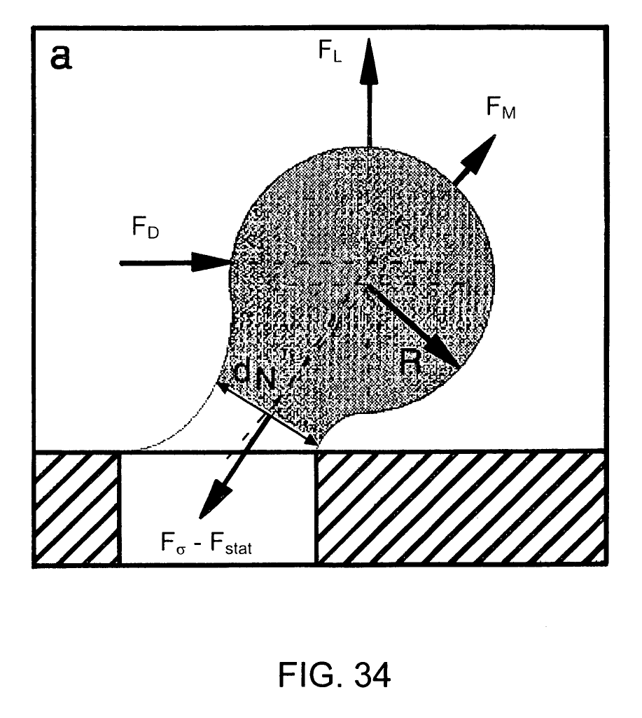

A sketch of the force diagram on a single droplet is illustrated in FIG. 34. The mathematical description of each force is given below followed by a complete list of variables and their explanation:
Drag Force

$${F}_{D} = 3 π {k}_{x} {d}_{d} {μ}_{c} {v}_{c}^{∞} \approx \frac{3}{2} π {k}_{x} {d}_{d} {D}_{H} {τ}_{w}$$

As an approximation, the wall shear, τ_{w}, can be estimated from the expression for wall shear for laminar, Newtonian flow through a duct (Hagen-Poiseuille equation):

$${τ}_{w} = \frac{2 {μ}_{c} {v}_{c}^{∞}}{{D}_{H}}$$

Interfacial Tension Force
F_{σ}=πdₙσ(t)cos θ
Capillary Force

$${F}_{stat} = {F}_{σ} ( \frac{{d}_{n}}{{d}_{d}} )$$

Dynamic Lift Force

$${F}_{L} = ( \frac{0.761 {τ}_{w}^{3 / 2} {ρ}_{c}^{1 / 2}}{{μ}_{c}} ) {d}_{d}^{3}$$

The droplet neck diameter, d_{d}, can be estimated based on an approximation model:

$$\frac{{d}_{n}}{{d}_{d}} = \{ \begin{matrix} 1 for \frac{{d}_{d}}{{d}_{p}} \leq 4 \\ \sqrt{8 ( \frac{{d}_{d}}{{d}_{p}} ) - {( \frac{{d}_{d}}{{d}_{p}} )}^{2} - 15} for 4 < \frac{{d}_{d}}{{d}_{p}} \leq 5\end{matrix}$$

In the event these conditions do not apply, then it is assumed that d_{d} is identical to the average pore diameter, dₚ.
Linear Momentum Force

$${F}_{M} = \frac{1}{4} {πρ}_{d} {v}_{p}^{2} {d}_{n}^{2}$$

The flowing is a list of variables for the Force Balance Model:

Fluid Properties

ρ_{c}=continuous phase density (kg/m³)
μ_{c}=continuous phase molecular viscosity (Pa·s)
σ=interfacial surface tension (N/m)
   Flow Variables
t=time (s)
vc=continuous phase average velocity magnitude (m/s)
vₚ=dispersed phase average velocity through a single pore (m/s)
D_{H}=process channel hydraulic diameter (m)
kₓ=wall correction factor (about 1.7); dimensionless
   Shear/Stress/Wall Adhesion Variables
τ_{w}=wall shear stress (Pa)
\dot{γ}=local shear rate (Hz)
θ=wall adhesion contact angle (θ=0 [symbol] substrate is hydrophobic; θ=180 [symbol] substrate is hydrophilic)
   Droplet Variables
d_{d}=droplet diameter (m)
dₙ=droplet neck diameter (m)
dₚ=pore diameter (m)

The droplet diameter d_{d} may be solved for by using a torque balance equation to relate each of these forces. In the case where drag, interfacial tension, capillary, and lift forces are considered, the droplet diameter at the instant of attachment satisfies expression
F_{D}d_{d}=(F_{σ}+Fₛₜₐₜ+F_{L})dₚ
The equation above can be solved for d_{d} to obtain the detachment droplet size.

Model results are studied for a process microchannel having the dimensions of 0.01 inch (0.254 mm) by 0.125 inch (3.175 mm) by 10 inches (25.4 cm). The viscosity of the continuous phase fluid may be described by a power law vicsocity equation
μ=kγⁿ
In which, n=0.33 and k=2150.5. The shear rate γ in sec⁻¹ and the viscosity μ is in centipoise (cp). The shear rate may be calculated using the following velocity profile for fully developed laminar flow of a power law fluid:

$$I \frac{v ( r )}{V} = ( \frac{3 n + 1}{n + 1} ) [ 1 - {( \frac{r}{R} )}^{\frac{n + 1}{n}} ]$$

V is the velocity of the bulk cross flow. R is half of the microchannel gap.

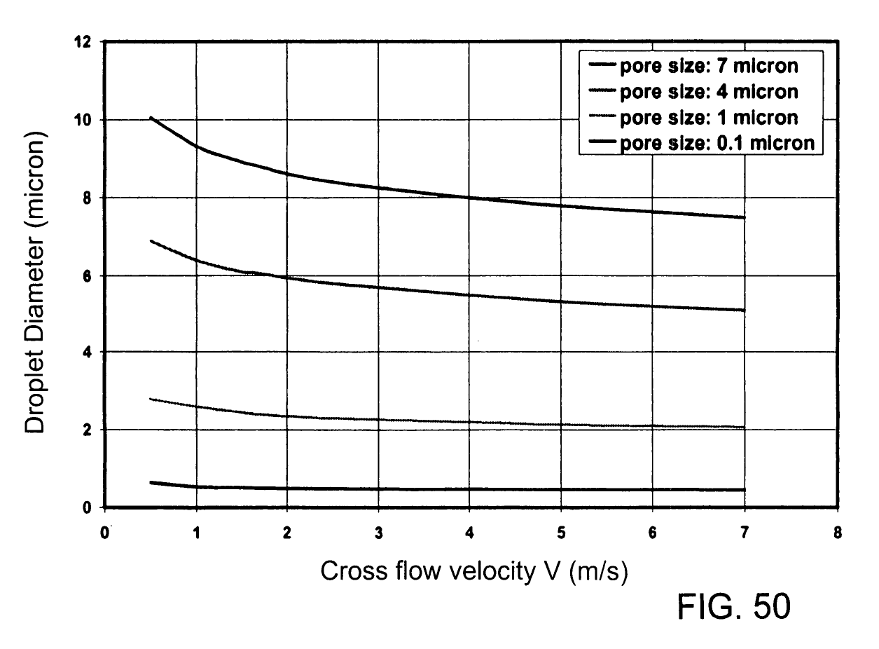

FIG. 50 shows the droplet size predictions under different cross flow velocities for four different pour size levels. The droplet size decreases as the cross flow velocity increases. The range of the droplet sizes is on the same order of magnitude of pore size.

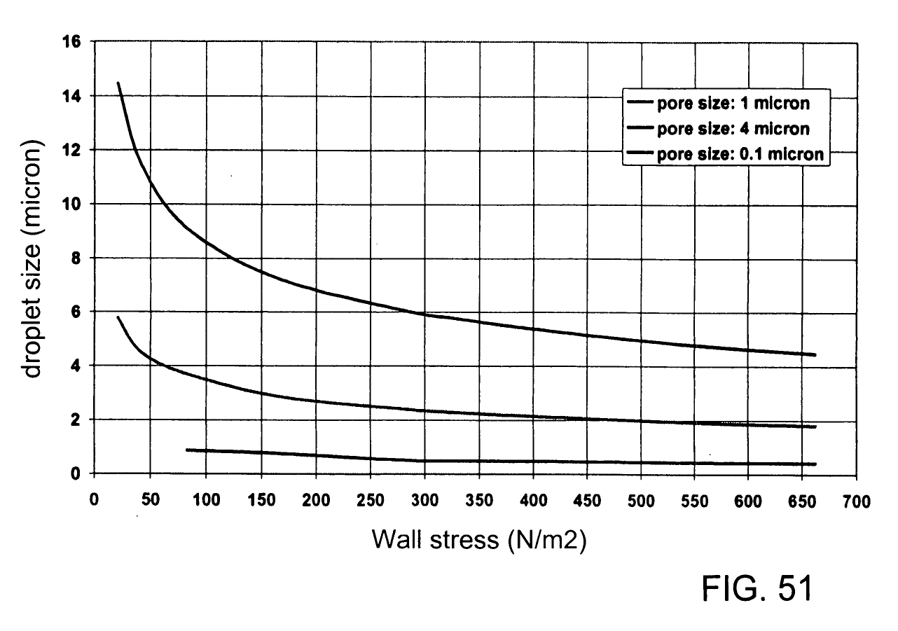

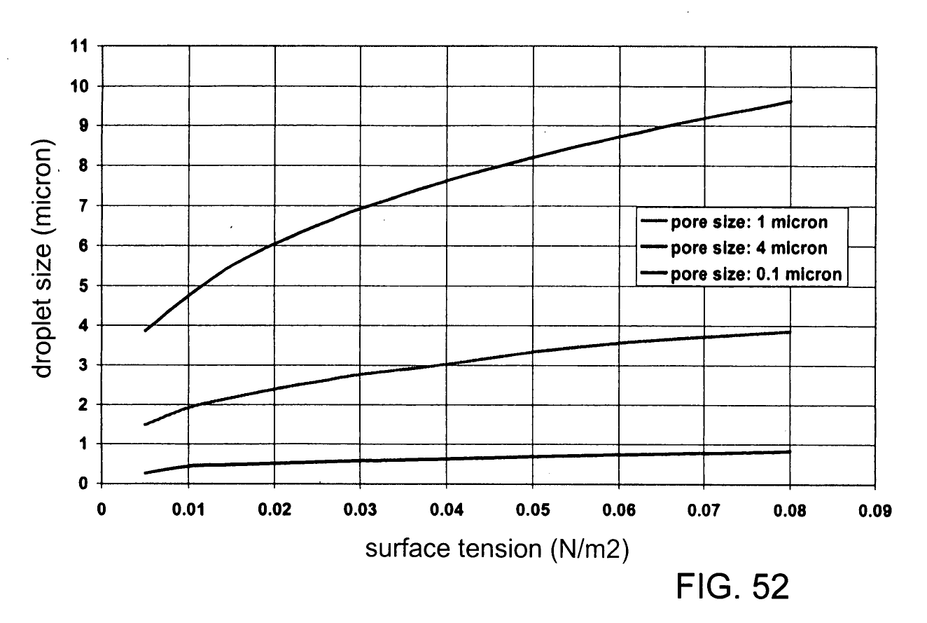

FIG. 51 shows the impact of wall shear stress on the predicted droplet sizes. The cross flow velocity is fixed at 1.67 m/s. Shear stress variation is realized by varying the k value in the power law viscosity model. The results show that the droplet size decreases as the wall shear stress increases. Impact of the surface tension on the droplet size is illustrated in FIG. 52. The droplet size increases as the surface tension increases.

In one embodiment, the minimum droplet size may be no less than three times that of the pore size. This may be validated for Newtonian fluids. For non-Newtonian fluids, as the power law fluid used herein may indicate, droplets with smaller sizes than those predicted may be observed. For power law fluids, the boundary layer may be thinner than that of its Newtonian counterpart for the same flow rate and the same zero shear rate viscosity. This may be manifested by flatter velocity profiles near the center of the flow channels for power law fluids. The droplets, before detachment from the wall, may sit in the boundary layer with the top part of the droplet subjecting to the shear stress, possibly different from that of the lower part of the droplet. This may affect the overall drag force on the droplet which in turn affects the overall force balance on the droplet. The droplet detaching from the wall into the non-Newtonian fluid may have a different size in comparison to the Newtonian fluid.

The relative accuracy of the torque balance condition against experimental data may be analyzed when the following combinations of forces are included:
SM1: Drag and interfacial tension forces only.
SM2: Drag, interfacial tension, and capillary forces.
SM3: Drag, interfacial tension, capillary, and dynamic lift forces.

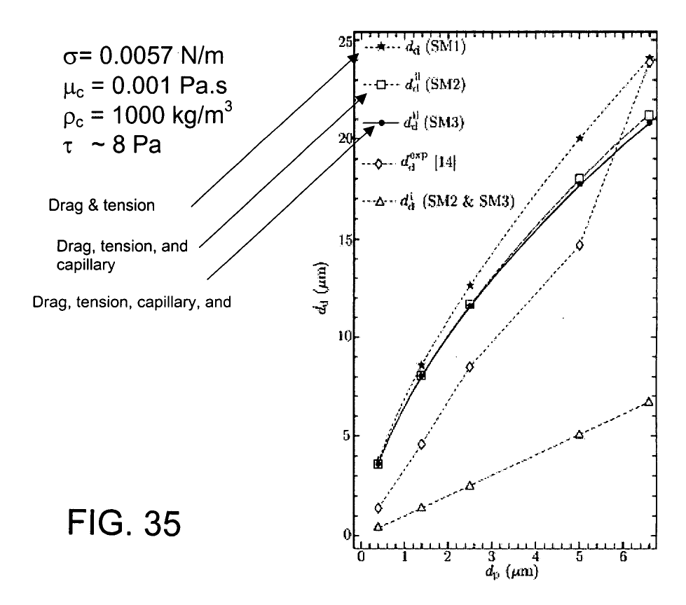

A comparison of each successive level of detail in the force balance approach may be compared to an example data set in FIG. 35. All of the results are believed to be conservative (i.e., they over-predict the droplet diameter) in large part due to the fact that only a constant average value is used for interfacial surface tension. In most applications, surfactant is added to one or both of the phases to reduce the overall surface tension. As surfactant diffuses into the emulsion droplets, the surface tension decreases and the droplet size decreases.

The CFD model uses the volume-of-fluid (VOF) model in the FLUENT software, a surface-tracking technique applied to a fixed Eulerian mesh. It is designed for two or more immiscible fluids where the position of the interface between the fluids is calculated as a function of time following some specified initial conditions. In the current simulations, the initial condition is fully developed flow of only continuous phase in the flow-by process microchannel zone and dispersed phase flowing into the capillary pore of the apertured section and reaching the outlet of the pore into the process microchannel. In the VOF model, a single set of momentum equations is shared by the fluids, and the volume fraction of each of the fluids in each computational cell is tracked throughout the domain.

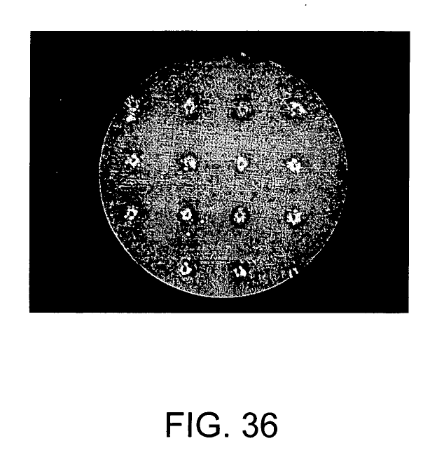

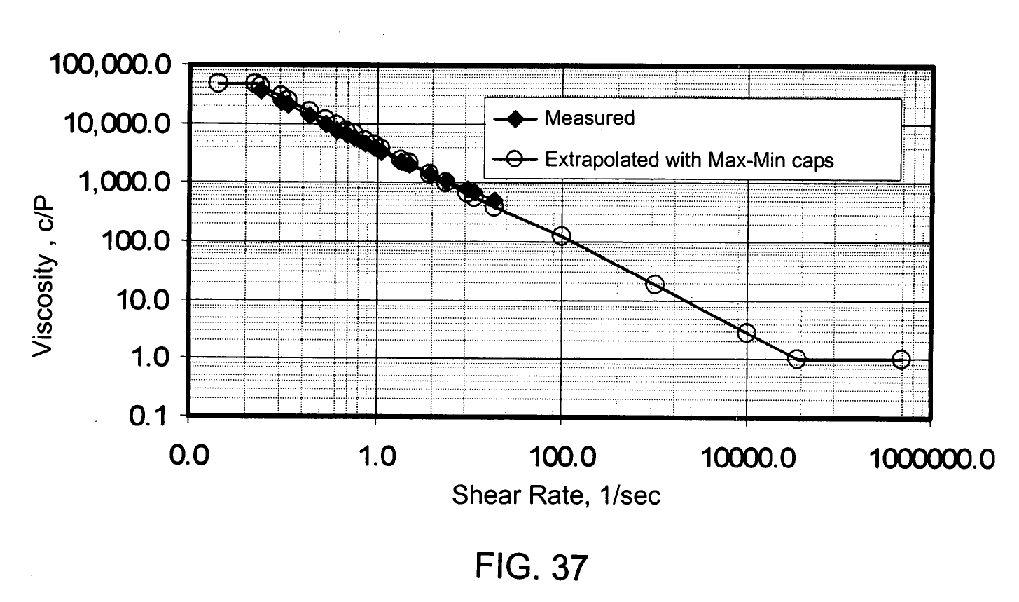

A list of input parameters for the CFD analysis based on test conditions are listed in Table 1. The apertured section used in the test is a thin laser drilled plate shown in the microscopic picture in FIG. 36. The modeled fluid has the property measured from a hand cream emulsification process. The product emulsion is non-Newtonian as is plotted in FIG. 37. This is a typical pseudo elastic (shear-thinning).

TABLE 1

| Type of emulsion | O/W | |
|---|---|---|
| Continuous phase flow rate | 1.156 | LPM |
| Continuous phase liquid density | 990 | kg/m3 |
| Continuous phase liquid viscosity | Curve available | kg/m s |
| | 0.6-21 1/s)* | |
| Dispersed phase flow rate | 30/15/5 | ml/min |
| Dispersed phase liquid density | 850 | kg/m3 |
| Dispersed phase liquid viscosity | 0.026 | kg/m s |
| Process channel height | 0.045 | inch |
| Process channel width | 0.5** | inch |
| Process channel length | 0.95 | inch |
| Substrate dimension | 0.5 × 1.0 | Inch2 |
| Pore size | 7.5/15 | μm |
| Number of the pore | 18380 | → double checked |
| Interfacial tension | 0.001-0.02** | N/m |
| Droplet size | 0.5-2.5 | μm, SMD |
| | | *other factors |

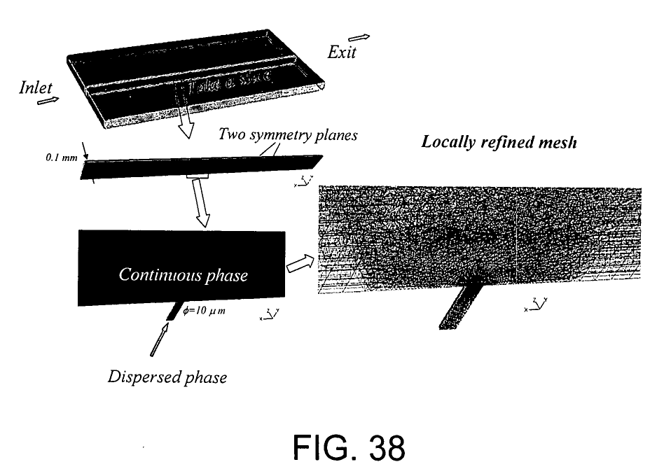

The single pore modeling approach is illustrated in FIG. 38. The physical scale of interest ranges several orders of magnitude: from approximately 0.1 μm in the close proximity of the capillary pore to length scales on the order of one millimeter (1000 μm) for the process microchannel height or width. A non-uniform computational mesh is used with refined cell elements near the droplet formation region and a relatively coarse mesh for the rest of flow field, as is illustrated in FIG. 38. Successive mesh adaptation (refinement of the mesh based on results of a previous solution) using concentration gradients between the continuous and dispersed phase as a metric to determine which cells to refine, may be used to establish grid-independence of the final predicted results (i.e., results are not an artifact of the level of mesh refinement).

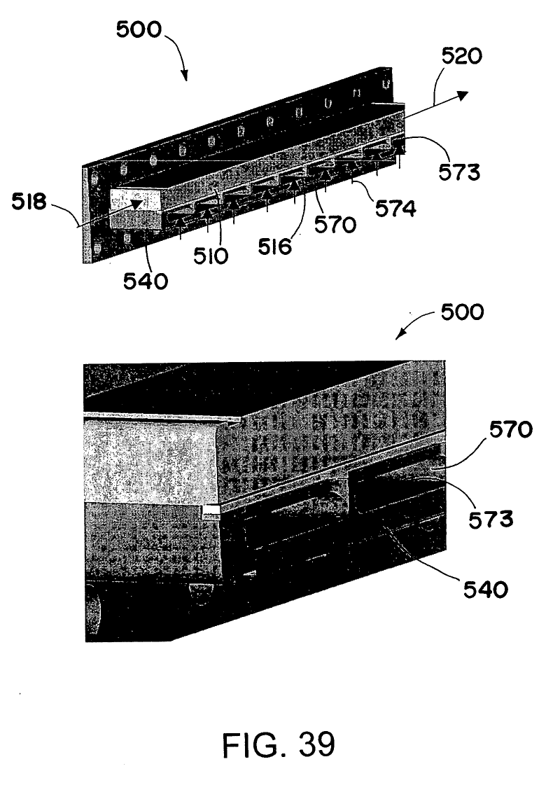

The emulsion process unit 500 depicted in FIG. 39 includes process microchannel 510, apertured section 540 and liquid channels 570. The process microchannel includes mixing zone 516. The apertured section has the dimensions of 0.010 inch (0.254 mm) by 0.125 inch (3.175 mm) by 10 inches (25.4 cm). In operation, the first liquid flows into process microchannel 510, as indicated by directional arrow 518, and into the mixing zone 516. A second liquid flows into liquid channel 570 and then flows through apertured section 540, as indicated by arrows 574, into the mixing zone 516. In mixing zone 516, the second liquid contacts and mixes with the first liquid to form an emulsion. The second liquid may form a discontinuous phase or droplets within the first liquid. The first liquid may form a continuous phase. The emulsion flows from the mixing zone 516 out of the process microchannel 510, as indicated by arrow 520.

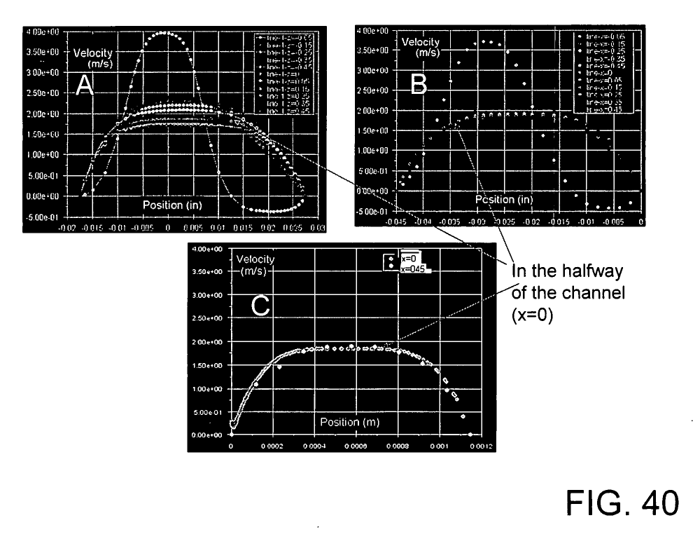

The emulsion process unit 500 uses ribs 573 to provide mechanical support for the aperatured section 540. These ribs divide the liquid channel 570 into 9 individual subchannels as illustrated in FIG. 39. A flow distribution analysis is conducted to ensure nearly equal amounts of dispersed phase flow through each of the 9 subchannels to ensure one set of flow conditions as being representative of the entire device. A comparison between the actual channel and selected slice flow region (any one of the 9 subchannels) is shown in FIG. 40. The cross-channel velocity profile results that the slice (subchannel) flow domain sufficiently is believed to represent the most portion of actual process microchannel. By virtue of its design, only 5 of the 9 channels can exhibit appreciably different flow rates due to inequalities in flow distribution. Table 2 provides a tabulation of the flow distribution through the five unique subchannels by means of a quality factor defined as

$${Q}_{j} = \frac{{max}_{1 \leq i \leq 5} \{ {\dot{m}}_{i} \} - {\dot{m}}_{j}}{{max}_{1 \leq i \leq 5} \{ {\dot{m}}_{i} \} - {min}_{1 \leq i \leq 5} \{ {\dot{m}}_{i} \}}$$

where \dot{m}ⱼ represents the mass flow rate through channel j and Qⱼ is its associated quality factor. As seen from Table 2, all quality factors are well below 1%, which is judged to be good flow distribution. A single slot CFD model may be adequate for representing the flow for the dispersed and continuous phase.

TABLE 2
Flow Quality Factors for Dispersed phase Subchannels.

| Slot # | Q Factor (%) |
|---|---|
| 1 | 0.55 |
| 2 | 0.82 |
| 3 | 0.58 |
| 4 | 0.0 |
| 5 | 0.41 |

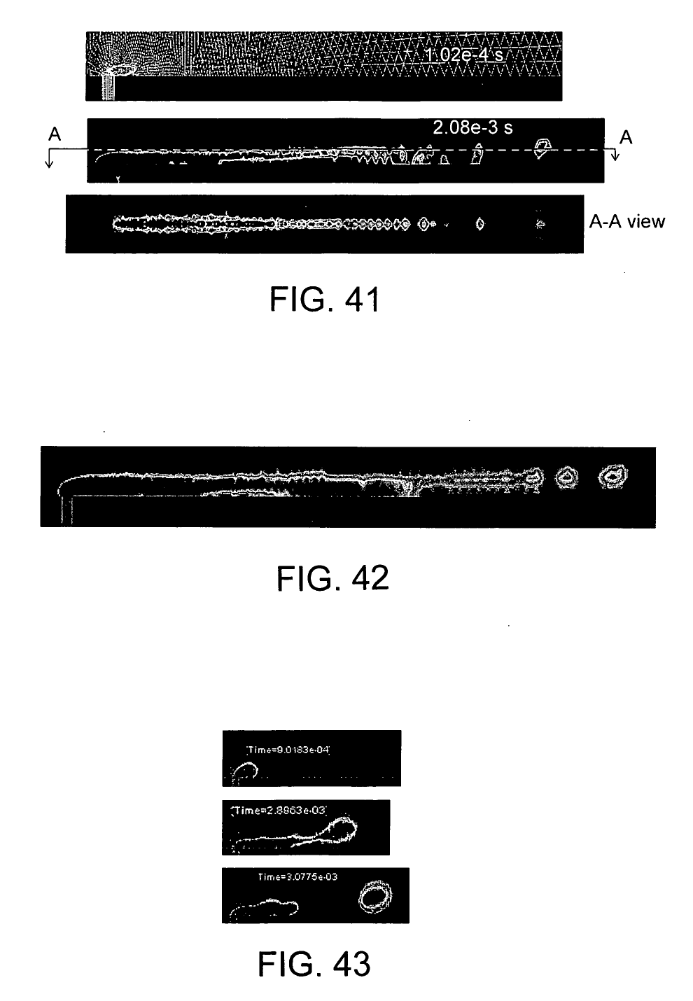

In FIG. 41, a set of results of droplet formation is shown in the form of phase contours for the dispersed phase and continuous phase. These results are given for select times at the lower range of oil velocity corresponding to the lower bound oil phase flow rate of 5 ml/min in Table 1. The capillary hole diameter is 7.5 μm. By computing the cell volume occupied by the predicted droplets illustrated in FIG. 41 in pure dispersed phase, an average diameter below 1.0 μm is obtained.

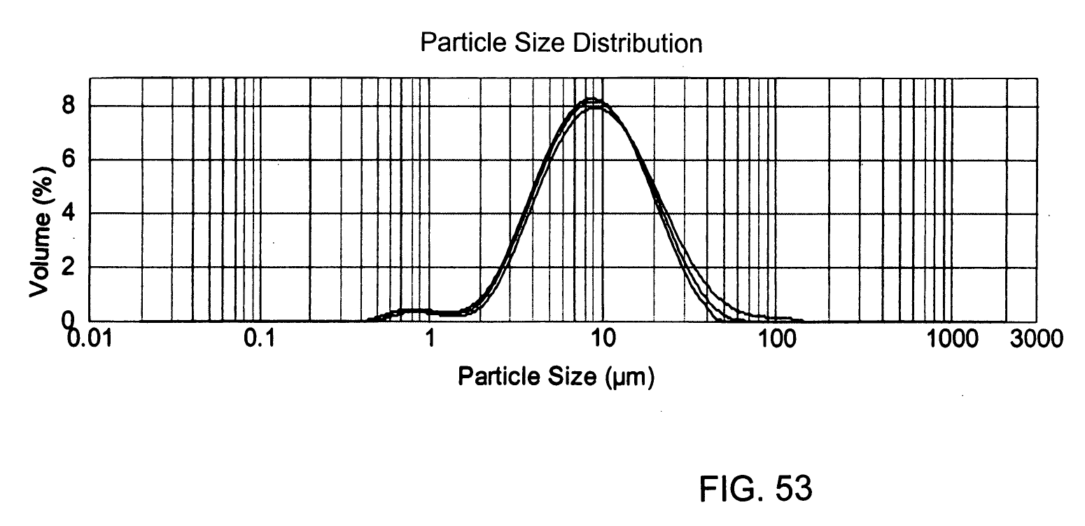

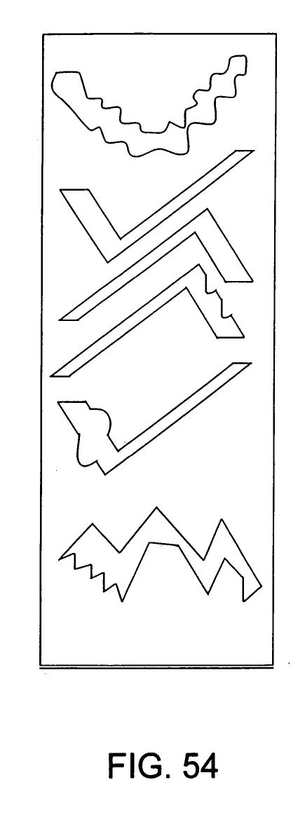

In FIG. 42 a set of results of droplet formation is shown in the form of phase contour for a given time at the oil velocity that corresponds to the maximum oil phase flow rate of 30 ml/min in Table 1. All other conditions remain the same as for lower oil flow rate case. The droplet sizes may be larger, namely in the range of 2-20 microns. This finding is consistent with the results for three different test runs in an experimental microchannel mixer which are reported in FIG. 53. The test results reported in FIG. 53 are obtained in a process microchannel having the construction illustrated in FIG. 39 under the following conditions:

| | |
|---|---|
| Emulsion Type: | Hand cream |
| Channel gap: | 10 mm |
| Apertured section pore size: | 0.2 micron |
| Average metal temperature: | 25° C. |
| First liquid (continuous phase) flow rate: | 95.9 ml/min |
| Feed temperature: | 25° C. |
| Feed pressure: | 270-300 psig (18.4-20.4 |
| | atm gauge pressure) |
| Liquid type: | aqueous |
| Second liquid (dispersed phase) flow rate: | 40 ml/min |
| Feed temperature: | 25° C. |
| Feed pressure: | 270-300 psig (18.4-20.4 atm) |
| Liquid type: | oil |
| Mean droplet size: | 10.564 microns |
| Median droplet size: | 8.597 microns |
| Mode droplet size: | 8.71 microns |
| Droplet size distribution type: | single-modal |

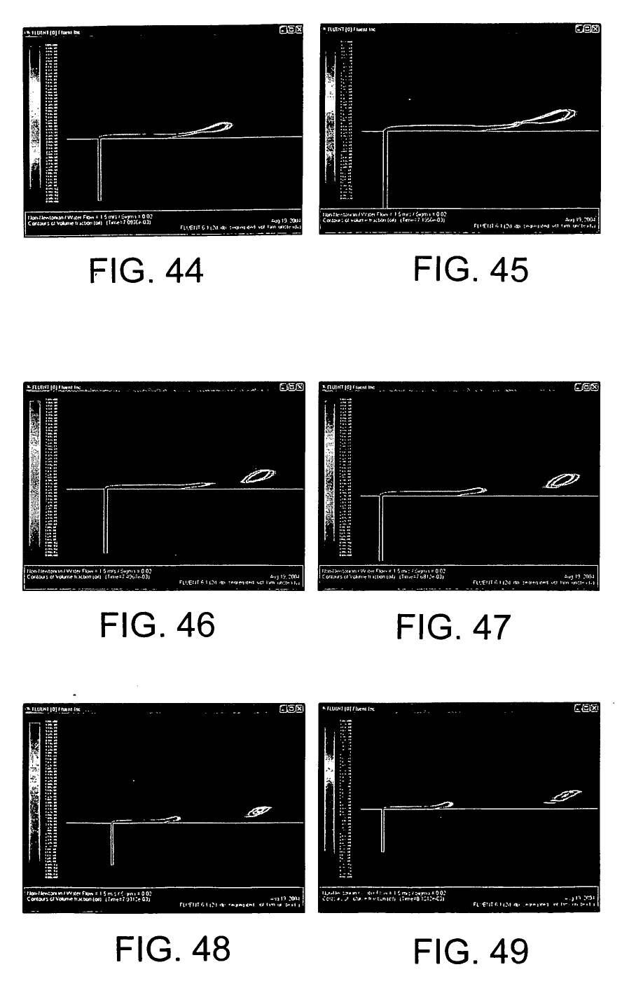

The above results use a relatively low value for surface tension of 0.001 N/m. In FIG. 43, phase contours for the same flow conditions but with a significantly higher value for interfacial surface tension, namely 0.02 N/m, are shown. The model predicts that higher surface tension (water phase to oil phase) may cause significantly larger droplets (on the order of 20 μm or greater). Advection of the droplet into the bulk flow of the channel where the shear rate is low, however, may be a relatively slow process, especially for larger-sized droplets. Therefore, the large droplet may persist in a region of locally high shear where droplet breakup may be more prone to take place. The simulation for successively longer times is shown in FIGS. 44-49. The progression illustrated in FIGS. 44-49 shows inception of detachment (FIG. 44), extension of droplet (FIG. 45), complete detachment (FIG. 46), downstream advection of droplet (FIG. 47), breakup of droplet (bifurcation) (FIG. 48), and diffusion of droplet into continuous phase (FIG. 49). These droplet sizes after breakup may be relatively large (3 to 5 microns). This value of interfacial surface tension may be representative of a formulation using little to no surfactant. In one embodiment, the inventive process may be used to generate high quality emulsions with the addition of less surfactant—normally a critical ingredient in emulsification processes. In one embodiment, the emulsions may be characterized by the absence of added surfactant.

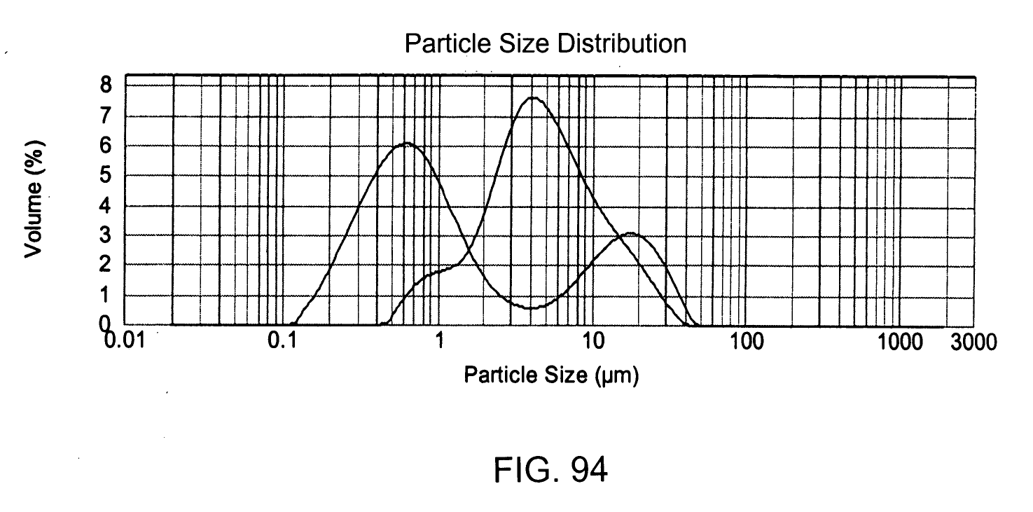

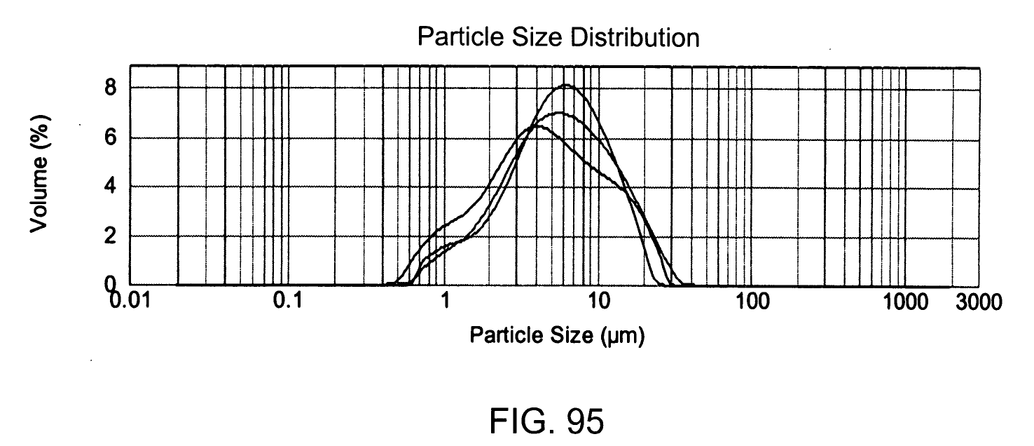

Plots showing particle (i.e., droplet) size distributions for emulsions made using the emulsion process unit disclosed in FIGS. 19-22 are provided in FIGS. 94 and 95.

In one embodiment, the emulsion process unit may be started up in a manner that prevents contamination as well as prevents overpressure of the system. This method may be used to ensure the device is sanitized prior to use and to ensure a successful run. This method may clean the lines, device, and apertured section or porous substrate of the second liquid or dispersed phase if there is any remaining from a previous run. It will also keep the system from overpressure. For example, if a run has been completed, the system has been shut down and now it is desired to run again. If the dispersed phase used was an oil mixture that is a solid at low temperatures and it is also immiscible with water and if there is any remaining in the lines that is solid. This process uses hot mineral oil, a liquid that is miscible with the dispersed phase, in the emulsion system to start the system for a new run.

The start up procedure may be used whether the emulsion process unit is being started for the first time, started after a run has already been performed, or started after a standby mode. For the first time or after a run has already been performed, the start up is similar with the difference being in how long the procedure may take (i.e. how long the pressures will need to stabilize).

For start up, all the temperatures of the lines and device should be steady at the appropriate temperature so no oil remains as a solid and so the oil is not burning. First begin by closing a valve to block the continuous phase lines from the rest of the system. This may prevent the dispersed phase from contaminating the continuous phase lines. Turn on the dispersed phase pump and pump hot mineral oil. This may flow into the continuous phase channel and out the outlet. Allow the pressures to stabilize and check to see if the oil at the outlet does not contain dispersed phase. This may indicate that the system is clean enough to continue. At the same time, open the valve and turn on the continuous phase pump flowing hot deionized water, this may clear out the continuous phase channel from excessive dispersed phase. Allow the pressures and temperatures to stabilize. The temperature should be high enough so that the dispersed phase does not phase change to a solid. The pressure on the dispersed side should be higher than that of the continuous side so that no back flow across the apertured section or porous substrate may occur. Switch both feeds to the actual phases to be run for testing. Allow pressures to stabilize. The pressures on the dispersed side should be higher than the continuous side.

When a warm standby is desirable, the heaters may be turned down to a temperature that may keep the dispersed phase as a liquid but not burn it. To start up for the next run, turn heaters back up to the appropriate temperature and proceed with the process described above.

This procedure may clear all remaining dispersed phase from lines, device, and porous substrate and allow the new dispersed phase to be in the proper locations. It may prevent contamination of the apertured section or substrate or of the continuous phase lines.

In one embodiment, the emulsion process unit may be cleaned between runs. This may be used for troubleshooting the device when pressures are higher than expected or for sanitizing the device when different chemicals may be used. This method may be used to clean the lines, device, and apertured section or porous substrate of the dispersed phase. For example, if the dispersed phase used was an oil mixture that is a solid at low temperatures and it is also immiscible with water, the process employs the use of hot mineral oil, a liquid that is miscible, in the emulsion system. The procedure may be used at the end of an emulsification run. In this case, the dispersed phase may be is an oil mixture that becomes a solid at lower temperatures and is not miscible with water. Both the oil and water phases may be flowing and all parts of the device are at a temperature sufficient to make all phases liquid. Throughout the cleaning all fluids and system components should be kept at this temperature. The first step would be to turn off the first liquid (e.g., water) phase flow and block off the first liquid inlet to the devise (i.e., with a ball valve). The second liquid (e.g., oil) phase pump may continue to pump but the feed would be switched to hot mineral oil (or other fluid the dispersed phase is miscible with). The mineral oil flow rate should initially be greater than the flow rate of the second liquid during the emulsification run. Pressure on the second liquid side should be monitored. When pressures are lowered and are stable for at least five minutes the majority of the dispersed phase may be cleaned out. At that point a ball valve blocking off the inlet to the first liquid phase may be opened and hot deionized water can be pumped into the first liquid side of the devise and out the product side. The pressures should be monitored to ensure that the pressure on the second liquid side is either twice the first liquid side pressure or at least about 20 psi greater so backflow through the apertured section or porous substrate does not occur. Once pressures on both sides have stabilized, the process may be shut down.

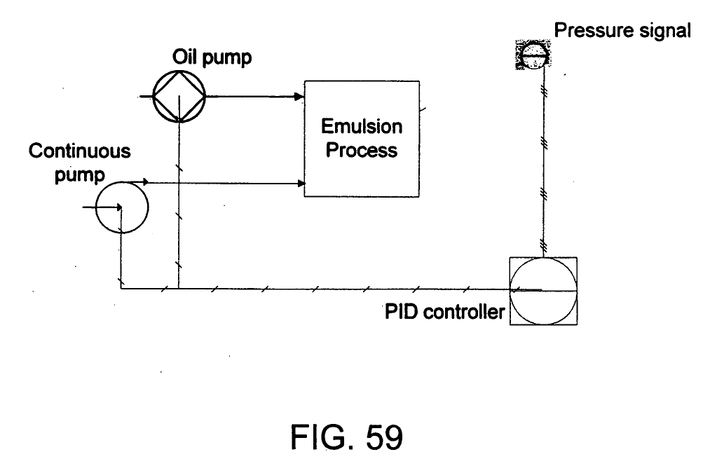

In one embodiment, the inventive process may be used to form emulsions with specific predetermined droplet sizes. The process for controlling droplet size is illustrated in FIG. 59. The process allows the operator to dial-in on a droplet size. This may be accomplished by employing a constant and specific shear stress by controlling the absolute pressure. The first liquid or continuous feed flowrate determines the pressure in the system, essentially by pressure drop. The continuous feed flowrate is controlled to achieve a specific pressure and hence shear stress. This is done by using pressure feedback in a PID control loop to continually adjust the continuous flowrate. After the above has been achieved, then the second liquid (e.g., oil) feed rate is set in a feedback loop where it is tied in a constant rtio to the continues feed rate setting. This allows the second liquid loading to be constant. A PID controller with two outputs may be used.

The heat exchange fluid may be any fluid. These include air, steam, liquid water, gaseous nitrogen, liquid nitrogen, other gases including inert gases, carbon monoxide, carbon dioxide, molten salt, oils such as mineral oil, gaseous hydrocarbons, liquid hydrocarbons, and heat exchange fluids such as Dowtherm A and Therminol which are available from Dow-Union Carbide.

The heat exchange fluid may comprise the first, second or third liquid used in making the emulsions. The product emulsion may be used as a heat exchange fluid. This may provide process pre-heat or pre-cooling and increase overall thermal efficiency of the process.

In one embodiment, the heat exchange channels may comprise process channels wherein an endothermic or exothermic process is conducted. These heat exchange process channels may be microchannels. Examples of endothermic processes that may be conducted in the heat exchange channels include steam reforming and dehydrogenation reactions. In one embodiment, the incorporation of a simultaneous endothermic reaction to provide an improved heat sink may enable a typical heat flux of roughly an order of magnitude or more above the convective cooling heat flux. Examples of exothermic processes that may be conducted in the heat exchange channels include water-gas shift reactions, methanol synthesis reactions and ammonia synthesis reactions.

In one embodiment, the heat exchange fluid undergoes a phase change as it flows through the heat exchange channels. This phase change provides additional heat addition or removal from the process microchannels or liquid channels beyond that provided by convective heating or cooling. For a liquid heat exchange fluid being vaporized, the additional heat being transferred from the process microchannels would result from the latent heat of vaporization required by the heat exchange fluid. An example of such a phase change would be an oil or water that undergoes nucleate boiling. In one embodiment, the vapor mass fraction quality of the boiling of the phase change fluid may be up to about 100%, and in one embodiment up to about 75%, and in one embodiment up to about 50%.

The use of enhanced heat transfer from phase change or a chemical reaction may be more advantageous when emulsion generation occurs in coordination with a chemical reaction in the process channels. In one embodiment, the emulsion may be, for example, a reactive monomer for a polymerization reaction or other and as such require additional heat exchange.

The heat flux for convective heat exchange or convective cooling in the microchannel mixer may be in the range from about 0.01 to about 125 watts per square centimeter of surface area of the process microchannels (W/cm²) in the microchannel mixer, and in one embodiment about 0.1 to about 50 W/cm², and in one embodiment about 1 to about 25 cm², and in one embodiment from about 1 to about 10 W/cm². The heat flux for phase change heat exchange may be in the range from about 1 to about 250 W/cm², and in one embodiment, from about 1 to about 100 W/cm², and in one embodiment from about 1 to about 50 W/cm², and in one embodiment from about 1 to about 25 W/cm², and in one embodiment from about 1 to about 10 W/cm².

The heat exchange channels may be used to provide sterile conditions during formation of the emulsions using the inventive process. Unlike batch mixers, the inventive process may be closed to the environment and does not need an inert gas blanket for isolation from the environment. The heat exchange channels, which may be adjacent to the process microchannels or liquid channels may provide relatively short heat transport and diffusion distances which permits rapid heating and cooling of the liquids in the microchannel mixer with decreased temperature gradients. As a result, emulsions that are not suitable for prolonged heating or would degrade under large temperature gradients may be prepared using the inventive process. In one embodiment, the temperature gradients between the process microchannel walls and the bulk flow within the process microchannels at the same axial position in the process microchannels may be less than about 5° C., and in one embodiment less than about 2° C., and in one embodiment less than about 1° C.

Heat exchange channels in close proximity to the process microchannels and/or liquid channels with controlled heating and/or cooling may provide for uniform temperature profiles between multiple process microchannels. This enables uniform heating and cooling at more rapid rates than can be obtained with conventional processing equipment such as mixing tanks. In a multichannel microchannel mixer, at least some axial position along the process flow length the temperature difference between the process microchannels may be less than about 5° C., and in one embodiment less than about 2° C., and in one embodiment less than about 1° C.

The heat exchange channels adjacent to either the process microchannels, liquid channels or both, may employ temperature zones along the length of such channels. In one embodiment, the temperature in a first zone near the entrance to the process channel is maintained at a temperature above a second temperature in a second zone near the end of the process microchannel. A cool down or quench zone may be incorporated into the process microchannel to quickly cool and stabilize the emulsion. Numerous combinations of thermal profiles are possible, allowing for a tailored thermal profile along the length of the process microchannel including the possibility of sections both before and/or after the mixing zone in the process microchannel to heat and/or cool the feed and or emulsion products.

The flow rate of liquid flowing in the process microchannels (210) may be in the range from about 0.001 to about 500 lpm, and in one embodiment about 0.001 to about 250 lpm, and in one embodiment about 0.001 to about 100 lpm, and in one embodiment about 0.001 to about 50 lpm, and in one embodiment about 0.001 to about 25 lpm, and in one embodiment about 0.01 to about 10 lpm. The velocity of liquid flowing in the process microchannels may be in the range from about 0.01 to about 100 m/s, and in one embodiment about 0.01 to about 75 m/s, and in one embodiment about 0.01 to about 50 m/s, and in one embodiment about 0.01 to about 30 m/s, and in one embodiment about 0.02 to about 20 m/s. The Reynolds Number for the liquid flowing in the process microchannels may be in the range from about 0.0001 to about 100000, and in one embodiment about 0.001 to about 10000. The temperature of the liquid entering the process microchannels may be in the range from about 0° C. to about 300° C., and in one embodiment about 20° C. to about 200° C. The pressure within the process microchannels may be in the range from about 0.01 to about 100 atmospheres, and in one embodiment about 1 to about 10 atmospheres. In the inventive process, a relatively high pressure drop across the apertured section (240) or a correspondingly high dispersion phase liquid flow rate through the liquid channel (270) may not be a necessary requirement to achieve the desired weight loading of the dispersed phase as is often the case in, for example, high pressure homogenizers. A low flow rate or low pressure drop may lead to a smaller droplet size with the inventive process, as lower inertia of the dispersion phase flow through the aperture reduces droplet growth before droplet breakup.

In one embodiment, the superficial velocity for liquid flowing in the process microchannels may be at least about 0.01 meters per second (m/s), and in one embodiment in the range from about 0.01 to about 50 m/s, and in one embodiment in the range from about 0.01 to about 10 m/s, and in one embodiment in the range from about 0.01 to about 1 m/s, and in one embodiment in the range from about 0.05 to about 0.5 m/s.

The flow rate of liquid flowing in the liquid channels (270) may be in the range from about 0.05 to about 5000 ml/s, and in one embodiment about 0.1 to about 500 ml/s. The velocity of the liquid flowing in the liquid channels may be in the range from about 0.0001 to about 0.1 m/s, and in one embodiment about 0.0001 m/s to about 0.05 m/s. The Reynolds Number for the liquid flowing in the liquid channels may be in the range from about 0.0000001 to about 1000, and in one embodiment about 0.0001 to about 100. The temperature of the liquid entering the liquid channels may be in the range from about −20° C. to about 250° C., and in one embodiment about 20° C. to about 100° C. The pressure within the liquid channels may be in the range from about 1 to about 200 atmospheres, and in one embodiment about 1 to about 100 atmospheres. The pressure drop for the liquid flowing through the apertures (244) may be in the range from about 0.05 to about 200 atmospheres, and in one embodiment about 1 to about 150 atmospheres.

The pressure differential across the apertured section 240 between the liquid channel 270 and the process microchannel 210 may be in the range up to about 40 atmospheres, and in one embodiment from about 1 to about 40 atmospheres, and in one embodiment from about 2 to about 20 atmospheres.

The emulsion exiting the process microchannels (210) may be at a temperature in the range from about −20° C. to about 300° C., and in one embodiment about 0° C. to about 200° C.

The heat exchange fluid entering the heat exchange channels (290) may have a temperature in the range from about −50° C. to about 300° C., and in one embodiment about −10 to about 200° C., and in one embodiment about 0° C. to about 100° C. The heat exchange fluid exiting the heat exchange channels may have a temperature in the range from about 0° C. to about 200° C., and in one embodiment about 10° C. to about 200° C. The pressure drop for the heat exchange fluid as it flows through the heat exchange channels may be in the range from about 0.01 to about 20 atmospheres, and in one embodiment from about 0.1 to about 20 atmospheres. The flow of the heat exchange fluid in the heat exchange channels may be laminar or in transition, and in one embodiment it is laminar. The Reynolds Number for the flow of heat exchange fluid flowing in the heat exchange channels may be in the range up to about 100000, and in one embodiment up to about 10000, and in one embodiment in the range from about 20 to about 10000, and in one embodiment about 100 to about 5000.

The first and/or second liquids may be preheated in the microchannel mixer or prior to entering the microchannel mixer using any type of heat exchange device, including a microchannel heat exchanger or heat pipe. In one embodiment, the first liquid may be preheated in a non-apertured region of the process microchannel (210) upstream of the mixing zone (216). The emulsion produced in the microchannel mixer may be cooled in the microchannel mixer or upon exiting the microchannel mixer using any type of heat exchange device, including a microchannel heat exchanger. In one embodiment, the emulsion may be quenched to stabilize the emulsion or lock it in. In one embodiment, the emulsion may be quenched in a non-apertured region of the process microchannel (210) downstream of the mixing zone (216). In one embodiment, the emulsion may be cooled to room temperature or quenched in a period in the range of up to about 10 minutes, and in one embodiment up to about 5 minutes, and in one embodiment up to about 1 minute, and in one embodiment up to about 30 seconds, and in one embodiment up to about 10 seconds, and in one embodiment in less than about 1 second.

An advantage of one embodiment of the inventive process is that the emulsion can be heated or cooled in the process microchannel relatively quickly. This provides the advantage of being able to heat the emulsion to a desired temperature to provide the emulsion with desired properties (e.g., droplet size reduction, enhanced dispersion of the droplets, etc.) and then be able to cool the emulsion quickly or quench the emulsion to lock in such properties. In one embodiment, the temperature of the emulsion may be increased or decreased by at least about 10° C. within a time span of up to about 750 milliseconds (ms), and in one embodiment at least about 20° C. within a time span of up to about 500 ms.

The inventive process may be used to make an emulsion at a rate of at least about 0.01 liter per minute, and in one embodiment at least about 1 liter per minute. In one embodiment, the process may be used to make an emulsion at a rate of at least about 1 liter per second.

In one embodiment, multiple dispersed phase liquid reservoirs or chambers may be built around the process microchannels 210. The individual reservoirs or chambers may be separated and have their own inlet control mechanism such as valves. In this configuration the volumetric ratio of the two phases (packing density) may be controlled and changed according to different formulations of the desired product emulsions without changing other components such as aperture or pore size of the apertured section or individual flow rates of the continuous phase or the dispersed phase. This is useful for an “lone pass process” (i.e., without recirculation). With this embodiment it is possible to produce emulsions having multi-modal droplet size distributions and/or multi-component dispersed phases. With this embodiment it is possible to provide for two or more second liquids entering the process microchannel through different apertured sections. This arrangement may be used to provide for multiple feed points for sequential additions of ingredients.

In one embodiment, optical or thermal-optical features may be adjusted in the process microchannel. Examples of techniques for measuring and/or adjusting these optical or thermal-optical features include: in-line LSD (laser scattering diffraction) detection for emulsion quality control and analysis including mean droplet size and span; viscometers for assessing product viscosity and solids loading; optical measurement using photographs for droplet size measurement; holographic imaging including interferometry via adjusting emulsion properties; and the like.

In one embodiment, a liquid adsorption process, a liquid-gas adsorption process, a liquid separation process, a solidification process, or a gasification process may be conducted in the process microchannel.

In one embodiment, an emulsion may be produced in the process microchannels for applications wherein charged particles are tacked.

In one embodiment, a chemical reaction may be conducted in the process microchannel. Examples of the chemical reactions that may be conducted include polymerization reactions (e.g., methyl methacrylate emulsion polymerization reactions), catalytic polymerization reactions (e.g., ethylene polymerization in aqueous solution with neutral nickel (II) complexes as catalysts), production of copolymers and terpolymers, catalyzed and non-catalyzed reactions of liquid phase oxidations (e.g., the production of adipic acid) or gas-liquid phase reactions and catalyzed and non-catalyzed liquid-liquid reactions (e.g., nitration of benzene or olefin alkylation).

In one embodiment, a biological process may be conducted in the process microchannel. Examples of such biological processes include bioremediation (cleaning) processes using emulsified detergents.

In one embodiment, emulsions prepared in accordance with the inventive process provide the advantage of enabling the manufacturer to supply the emulsions in concentrate form, thus enabling the end user to add additional ingredients, such as water or oil, to obtain the final fully formulated product.

The emulsions made by the inventive process have numerous applications. These include personal skin care products wherein reduced concentrations of emulsifiers or surfactants are desirable (e.g., waterproof sun screen, waterproof hand creams or lotions).

The emulsions made by the inventive process may be useful as paints or coatings. These include water-resistant latex paints with strong weatherability characteristics. The emulsions may be useful as adhesives, glues, caulks, waterproof sealants, and the like. As a result of the inclusion of an aqueous phase in these compositions, the problem of volatile organic compounds (VOC) in these products can be reduced.

The inventive process may be used in various food processing applications, particularly continuous processing operations.

The inventive process may be used in the production of agricultural chemicals where the use of a dispersed phase with a narrow distribution of droplet sizes is advantageous for spreading the chemicals on leafs, and providing enhanced waterproofing with smaller concentrations of chemicals. In one embodiment, the inventive process may be used in the production of agricultural chemicals such as pesticides wherein it may be desired to employ a droplet size for the dispersed phase that is smaller than the wavelength of visible light.

The inventive process may be used for the production of emulsified lubricants and fuels. These may include on-board fuel emulsification systems such as those used for diesel engines.

The inventive process may be used in emulsion polymerization processes. For example, it may be possible to solublize monomers in a surfactant with a catalyst.

The inventive process may be used to make rapid setting emulsions containing bitumen. These emulsions may be used as surface dressings for cement or asphalt surfaces such as roads, driveways, and the like. These emulsions may contain from about 60 to about 70% by weight bitumen and may be sprayed onto the surface being treated. Chippings may be spread on top of these surface dressings and rolled to ensure proper embedding and alignment. This provides a water impervious surface seal and also an improved surface texture.

The emulsions made using the inventive process may be silicone emulsions. These emulsions may be used for treating fibers and other substrates to alter their water repellant properties.

The inventive process may be used in a crystallization process, for example, a continuous crystallization process. This process may be used to isolate, purify and/or produce powders of a specified size. An example of such crystals include highly refined sugar. In emulsion crystallization, a melt may be crystallized within droplets of the emulsion so that homogeneous nucleation may occur at a lower rate than in a bulk melt. This process may be conducted without solvents, and thus may provide the advantage of low capital and operating costs.

The inventive process may be used to make liquid crystals. The liquid crystals formed in the process may help to reduce the use of emulsifiers and/or surfactants, as the dispersed phase may be “locked” in place.

The inventive process may be used to make wax emulsions for adhesives, liquid soaps, laundry detergents, coatings for textiles or fabrics, and the like.

The inventive process may be used in the manufacture of pharmaceuticals wherein the provision of a dispersed oil phase with a narrow distribution of droplet sizes is advantageous. These may include oral or injectable compositions as well as dermatological creams, lotions and opthalmics. The droplet size and distribution achieved with the inventive process may increase the efficacy of the drug and provide for reduced levels of use of the drug for required treatments. This also provides the advantage of avoiding or limiting the use of non-aqueous solvent components which tend to solubilize organic substances used in packaging materials. The droplet size for the dispersed oil phase for these applications may be up to about 0.5 micron, in order to avoid being eliminated by the spleen or liver, and in one embodiment in the range from about 0.01 to about 0.2 micron, and in one embodiment 0.01 to about 0.1 micron. The emulsions produced by the inventive process may function as emulsion vehicles for insoluble or poorly soluble drugs (e.g., ibuprofen, diazepam, griseofulvin, cyclosporin, cortisone, proleukin, etoposide, paclitaxel, cytotoxin, vitamin E, alpha-tocopherol, and the like). Many of the pharmaceutical compounds or drugs, oils and surfactants disclosed in U.S. Patent Application Publication No. 2003/0027858A1 may be used in making pharmaceutical compositions using the inventive process; this patent publication is incorporated herein by reference for its disclosure of such compounds or drugs, oils and surfactants. An advantage of using the inventive process relates to the fact that many of the problems associated with using conventional high-shear mixing equipment for attempting to achieve small droplets with a narrow droplet size distribution while maintaining a sterile environment are avoided.

While the invention has been explained in relation to specific embodiments, it is to be understood that various modifications thereof will become apparent to those skilled in the art upon reading the specification. Therefore, it is to be understood that the invention disclosed herein is intended to cover such modifications as fall within the scope of the appended claims.

1. A process, comprising:
flowing an emulsion in a process microchannel, the emulsion comprising a continuous phase and a dispersed phase, the continuous phase comprising a first liquid, the dispersed phase comprising a second liquid; and
exchanging heat between the process microchannel and a heat source and/or heat sink to increase or decrease the temperature of the emulsion by at least about 10° C. within a period of up to about 750 milliseconds.

2. The process of claim 1 wherein the dispersed phase is in the form of liquid droplets, the liquid droplets having a volume-based mean diameter in the range up to about 200 microns, and a span in the range from about 0.005 to about 10.

3. The process of claim 1 wherein the flow rate of the emulsion in the process microchannel is at least about 0.01 liters per minute.

4. The process of claim 1 wherein the superficial velocity of the emulsion flowing in the process microchannel is at least about 0.01 meter per second.

5. The process of claim 1 wherein the first liquid and the second liquid are mixed to form the emulsion in the process microchannel.

6. The process of claim 1 wherein the process microchannel comprises at least one side wall and at least one apertured section extending along at least part of the axial length of the side wall, the second liquid flowing through the apertured section into the process microchannel in contact with the first liquid to form the emulsion.

7. The process of claim 6 wherein the second liquid flows from a liquid channel through the apertured section.

8. The process of claim 1 wherein the process is conducted in an emulsion process unit, the emulsion process unit comprising a plurality of the process microchannels and at least one header for distributing the liquids to the process microchannels, the process further comprising mixing the first liquid and the second liquid to form the emulsion in the header, the emulsion flowing from the header into the process microchannels.

9. The process of claim 8 wherein the header comprises at least one first liquid zone, at least one second liquid zone, and an apertured section positioned between the first liquid zone and the second liquid zone, the second liquid flowing from the second liquid zone through the apertured section into the first liquid zone in contact with the first liquid to form the emulsion, the emulsion flowing from the first liquid zone into the process microchannels.

10. The process of claim 8 wherein a stream of the second liquid contacts a stream of the first liquid in the header to form the emulsion.

11. The process of claim 5 wherein a stream of the second liquid contacts a stream of the first liquid in the process microchannel to form the emulsion.

12. The process of claim 1 wherein the process microchannel comprises surface features formed in and/or on one or more interior walls for modifying flow and/or mixing within the process microchannel.

13. The process of claim 7 wherein the liquid channel comprises surface features formed in and/or on one or more interior walls of the liquid channel for modifying flow and/or mixing within the liquid channel.

14. The process of claim 1 wherein the heat source and/or heat sink comprises at least one heat exchange channel, the heat exchange channel comprising surface features formed in and/or on one or more interior walls of the heat exchange channel for modifying flow and/or mixing within the heat exchange channel.

15. The process of claim 12 wherein the surface features are in the form of depressions in and/or projections from one or more of the microchannel interior walls that are oriented at angles relative to the direction of flow of fluid through the process microchannel.

16. The process of claim 12 wherein the surface features comprise at least two surface feature regions where mixing of the first liquid and second liquid is conducted in a first surface feature region followed by flow in a second surface feature region where the flow pattern in the second surface feature region is different than the flow pattern in the first surface feature region.

17. The process of claim 6 wherein the apertured section comprises an interior portion that forms part of one or more of the interior walls of the process microchannel and surface features positioned in and/or on the interior portion of the apertured section.

18. The process of claim 12 wherein the surface features comprise two or more layers stacked on top of each other and/or intertwined in a three-dimensional pattern.

19. The process of claim 12 wherein the surface features are in the form of circles, oblongs, squares, rectangles, checks, chevrons, wavy shapes, or combinations thereof.

20. The process of claim 12 wherein the surface features comprise sub-features where the major walls of the surface features further contain smaller surface features in the form of notches, waves, indents, holes, burrs, checks, scallops, or combinations thereof.

21. The process of claim 1 wherein the process microchannel has an internal dimension of width or height of up to about 10 mm.

22. The process of claim 1 wherein the process microchannel has an internal dimension of width or height of up to about 2 mm.

23. The process of claim 1 wherein the process microchannel is made of a material comprising: steel; monel; inconel; aluminum; titanium; nickel; copper; brass; an alloy of any of the foregoing metals; a polymer; ceramics; glass; a composite comprising a polymer and fiberglass; quartz; silicon; or a combination of two or more thereof.

24. The process of claim 7 wherein the liquid channel comprises a microchannel.

25. The process of claim 7 wherein the process microchannel is adjacent to the liquid channel, the process microchannel and the liquid channel having a common wall with the apertured section in the common wall.

26. The process of claim 6 wherein the apertured section comprises a relatively thin sheet overlying a relatively thick sheet or plate, the relatively thin sheet containing an array of relatively small apertures, and the relatively thick sheet or plate containing an array of relatively large apertures, at least some of the relatively small apertures being aligned with the relatively large apertures.

27. The process of claim 6 wherein the apertured section comprises apertures that are partially filled with a coating material.

28. The process of claim 6 wherein the apertured section is heat treated.

29. The process of claim 6 wherein the apertured section is made from a porous material.

30. The process of claim 29 wherein the porous material is metallic, nonmetallic and/or oxidized.

31. The process of claim 29 wherein the porous material is coated with an organic or an inorganic material.

32. The process of claim 6 wherein the apertured section is made from a porous material, the surface of the porous material being treated by filling the pores on the surface with a liquid filler, solidifying the filler, grinding or polishing the surface, and removing the filler.

33. The process of claim 6 wherein the apertured section extends along about 1% to about 100% of the axial length of the process microchannel.

34. The process of claim 1 wherein the heat source and/or heat sink is adjacent to the process microchannel.

35. The process of claim 1 wherein the heat source and/or heat sink is remote from the process microchannel.

36. The process of claim 1 wherein the heat source and/or heat sink comprises at least one heat exchange channel.

37. The process of claim 36 wherein the heat exchange channel comprises a microchannel.

38. The process of claim 1 wherein the heat source and/or heat sink comprises at least one electric heating element, resistance heater and/or non-fluid cooling element.

39. The process of claim 36 wherein a heat exchange fluid is in the heat exchange channel.

40. The process of claim 39 wherein the heat exchange fluid undergoes a phase change in the heat exchange channel.

41. The process of claim 1 wherein the heat flux between the heat source and/or heat sink and the process microchannel is in the range from about 0.01 to about 250 watts per square centimeter of surface area of the process microchannel.

42. The process of claim 36 wherein an endothermic process is conducted in the heat exchange channel.

43. The process of claim 36 wherein an exothermic process is conducted in the heat exchange channel.

44. The process of claim 36 wherein the emulsion flows in the process microchannel in a first direction, and a heat exchange fluid flows in the heat exchange channel in a second direction, the second direction being cross current relative to the first direction.

45. The process of claim 36 wherein the emulsion flows in the process microchannel in a first direction, and a heat exchange fluid flows in the heat exchange channel in a second direction, the second direction being cocurrent or counter current relative to the first direction.

46. The process of claim 36 wherein a heat exchange fluid is in the heat exchange channel, the heat exchange fluid comprising the first liquid, the second liquid, or the emulsion.

47. The process of claim 36 wherein a heat exchange fluid is in the heat exchange channel, the heat exchange fluid comprising one or more of air, steam, liquid water, carbon monoxide, carbon dioxide, gaseous nitrogen, liquid nitrogen, inert gas, gaseous hydrocarbon, oil, and liquid hydrocarbon.

48. The process of claim 1 wherein the emulsion is quenched in the process microchannel.

49. The process of claim 1 wherein the process microchannel is formed from parallel spaced sheets, plates or a combination of such sheets and plates.

50. The process of claim 6 wherein the second liquid flows in a liquid channel and from the liquid channel through the apertured section into the process microchannel, the liquid channel being formed from parallel spaced sheets, plates, or a combination of such sheets and plates, the liquid channel being adjacent to the process microchannel.

51. The process of claim 1 wherein the heat source and/or heat sink comprises a heat exchange channel, the heat exchange channel being formed from parallel spaced sheets, plates, or a combination of such sheets and plates.

52. The process of claim 1 wherein the process is conducted in an emulsion process unit, the emulsion process unit comprising a plurality of the process microchannels, the process microchannels having walls with apertured sections and adjacent liquid channels, the second liquid flowing in the liquid channels and from the liquid channels through the apertured sections into the process microchannels in contact with the first liquid, the process microchannels and liquid channels being formed from parallel spaced sheets, plates, or a combination of such sheets and plates, the process microchannels and liquid channels being adjacent to each other and aligned in interleaved side-by-side vertically oriented planes or interleaved horizontally oriented planes stacked one above another.

53. The process of claim 52 wherein the emulsion process unit further comprises a plurality of heat exchange channels formed from parallel spaced sheets, plates, or a combination of such sheets and plates, the heat exchange channels exchanging heat with the process microchannels, the liquid channels, or both the process microchannels and the liquid channels.

54. The process of claim 6 wherein the second liquid flows in a liquid channel and from the liquid channel through the apertured section into the process microchannel, the process microchannel and the liquid channel comprising circular tubes aligned concentrically.

55. The process of claim 54 wherein the process microchannel is in an annular space and the liquid channel is in the center space or an adjacent annular space.

56. The process of claim 54 wherein the process microchannel is in the center space and the liquid channel is in an adjacent annular space.

57. The process of claim 1 wherein the process is conducted in an emulsion process unit, the emulsion process unit comprising a plurality of the process microchannels wherein separate emulsions are formed in each of the process microchannels, the emulsions formed in at least two of the process microchannels being different from each other.

58. The process of claim 6 wherein the process microchannel comprises two or more apertured sections and separate second liquids flow through each of the apertured sections.

59. The process of claim 6 wherein the process microchannel has a mixing zone adjacent to the apertured section and a non-apertured region extending from the entrance to the process microchannel to the mixing zone.

60. The process of claim 6 wherein the apertured section has a wall thickness, the ratio of the wall thickness to the axial length of the apertured section being in the range from about 0.001 to about 1.

61. The process of claim 1 wherein the emulsion comprises a water-in-oil emulsion.

62. The process of claim 1 wherein the emulsion comprises an oil-in-water emulsion.

63. The process of claim 1 wherein the emulsion comprises at least one organic liquid.

64. The process of claim 1 wherein the emulsion comprises a skin care product, a paint or coating composition, an adhesive composition, a glue composition, a caulk composition, a sealant composition, a food composition, an agricultural composition, a pharmaceutical composition, a fuel composition, a lubricant composition, a surface dressing composition, a silicone emulsion, a crystal containing composition, a liquid crystal composition, or a wax emulsion.

65. The process of claim 1 wherein the emulsion comprises at least one emulsifier and/or surfactant.

66. The process of claim 1 wherein solids are dispersed in the emulsion.

67. The process of claim 1 wherein a catalyst is dispersed in the emulsion.

68. A process for making an emulsion, comprising:
flowing a first liquid in a process microchannel, the process microchannel having an axial length extending parallel to the direction of flow of the first liquid, the process microchannel having at least one wall with at least one apertured section, the apertured section having an axial length extending parallel to the axial length of the process microchannel;
flowing a second liquid through the apertured section into the process microchannel in contact with the first liquid to form the emulsion, the first liquid forming a continuous phase, the second liquid forming droplets dispersed in the continuous phase; and
maintaining the flow of the second liquid through the apertured section at a rate that is substantially constant along the axial length of the apertured section.

69. The process of claim 68 wherein the second liquid flows in a liquid channel and from the liquid channel through the apertured section, the liquid channel being parallel to the process microchannel, the apertured section being positioned between the liquid channel and the process microchannel, the first liquid undergoing a pressure drop as it flows in the process microchannel, the second liquid undergoing a pressure drop as it flows in the liquid channel, the pressure drop for the first liquid flowing in the process microchannel being substantially the same as the pressure drop for the second liquid flowing in the liquid channel.

70. The process of claim 69 wherein the liquid channel comprises a microchannel.

71. The process of claim 68 wherein the second liquid flows in a liquid channel and from the liquid channel through the apertured section, the liquid channel being parallel to the process microchannel, the apertured section being positioned between the liquid channel and the process microchannel, the first liquid undergoing a pressure drop as it flows in the process microchannel, the internal pressure within the liquid channel being reduced along the length of the liquid channel to provide a pressure differential across the apertured section that is substantially constant along the length of the apertured section.

72. The process of claim 71 wherein the liquid channel comprises one or more internal flow restriction devices to reduce the internal pressure within the liquid channel along the length of the liquid channel.

73. The process of claim 71 wherein the liquid channel comprises one or more internal zones positioned along the length of the liquid channel, the second liquid flowing from the liquid channel through the internal zones and through the apertured section, the pressure within the internal zones being reduced along the length of the liquid channel to provide the substantially constant pressure differential across the apertured section along the length of the apertured section.

74. The process of claim 68 wherein heat is exchanged between the process microchannel and a heat source and/or heat sink.

75. The process of claim 68 wherein the second liquid flows in a liquid channel and from the liquid channel through the apertured section, and heat is exchanged between the process microchannel and a heat source and/or heat sink, the liquid channel and a heat source and/or heat sink, or both the process microchannel and the liquid channel and a heat source and/or heat sink.

76. The process of claim 68 wherein the first liquid and the second liquid contact each other in a mixing zone in the process microchannel.

77. The process of claim 76 wherein heat is exchanged between the heat source and/or heat sink and the mixing zone.

78. The process of claim 76 wherein heat is exchanged between the heat source and/or heat sink and the process microchannel upstream of the mixing zone.

79. The process of claim 76 wherein heat is exchanged between the heat source and/or heat sink and the process microchannel downstream of the mixing zone.

80. The process of claim 76 wherein the emulsion is quenched in the process microchannel downstream of the mixing zone.

81. The process of claim 76 wherein the process microchannel has a restricted cross section in the mixing zone.

82. The process of claim 68 wherein the process microchannel is formed from parallel spaced sheets, plates or a combination of such sheets and plates.

83. The process of claim 82 wherein the second liquid flows in a liquid channel and from the liquid channel through the apertured section into the process microchannel, the liquid channel being formed from parallel spaced sheets, plates, or a combination of such sheets and plates, the liquid channel being adjacent to the process microchannel.

84. The process of claim 83 wherein the first liquid and/or second liquid exchange heat with a heat exchange channel, the heat exchange channel being formed from parallel spaced sheets, plates, or a combination of such sheets and plates, the heat exchange channel being adjacent to the process microchannel, the liquid channel, or both the process microchannel and the liquid channel.

85. The process of claim 68 wherein the process is conducted in an emulsion process unit, the emulsion process unit comprising a plurality of the process microchannels, the process microchannels having walls with apertured sections and adjacent liquid channels, the second liquid flowing in the liquid channels and from the liquid channels through the apertured sections into the process microchannels in contact with the first liquid, the process microchannels and liquid channels being formed from parallel spaced sheets, plates, or a combination of such sheets and plates, the process microchannels and liquid channels being adjacent to each other and aligned in interleaved side-by-side vertically oriented planes or interleaved horizontally oriented planes stacked one above another.

86. The process of claim 85 wherein the emulsion process unit further comprises a plurality of heat exchange channels formed from parallel spaced sheets, plates, or a combination of such sheets and plates, the heat exchange channels exchanging heat with the process microchannels, the liquid channels, or both the process microchannels and the liquid channels.

87. The process of claim 68 wherein the second liquid flows in a liquid channel and from the liquid channel through the apertured section into the process microchannel, the process microchannel and the liquid channel comprising circular tubes aligned concentrically.

88. The process of claim 87 wherein the process microchannel is in an annular space and the liquid channel is in the center space or an adjacent annular space.

89. The process of claim 87 wherein the process microchannel is in the center space and the liquid channel is in an adjacent annular space.

90. The process of claim 68 wherein the process is conducted in a microchannel mixer, the microchannel mixer comprising a plurality of the process microchannels wherein separate emulsions are formed in each of the process microchannels, the emulsions formed in at least two of the process microchannels being different from each other.

91. The process of claim 90 wherein the emulsions formed in at least two of the process microchannels are different in composition.

92. The process of claim 90 wherein the emulsions formed in at least two of the process microchannels have one or more different physical properties.

93. The process of claim 68 wherein the process microchannel comprises two or more apertured sections and separate second liquids flow through each of the apertured sections.

94. The process of claim 93 wherein the separate second liquids flowing through each of the apertured sections have different compositions.

95. The process of claim 93 wherein the separate second liquids flowing through each of the apertured sections have different properties.

96. The process of claim 68 wherein the process microchannel has a mixing zone adjacent to the apertured section and a non-apertured region extending from the entrance to the process microchannel to the mixing zone.

97. The process of claim 68 wherein the apertured section comprises at least one sheet or plate with a plurality of apertures in the sheet or plate.

98. The process of claim 68 wherein the apertured section comprises a relatively thin sheet overlying a relatively thick sheet or plate, the relatively thin sheet containing a plurality of relatively small apertures, and the relatively thick sheet or plate containing a plurality of relatively large apertures, the relatively small apertures being aligned with the relatively large apertures sufficiently to permit liquid to flow from the relatively large apertures through the relatively small apertures.

99. The process of claim 98 with a coating overlying at least part of the sheet or plate and filling part of the apertures.

100. The process of claim 98 wherein the sheet or plate is heat treated.

101. The process of claim 68 wherein the apertured section has a wall thickness, the ratio of the wall thickness to the axial length of the apertured section being in the range from about 0.001 to about 1.

102. The process of claim 68 wherein the apertured section is made from a porous material.

103. The process of claim 102 wherein the porous material is metallic, nonmetallic and/or oxidized.

104. The process of claim 102 wherein the porous material is coated with an organic or inorganic material.

105. The process of claim 68 wherein the apertured section is made from a porous material, the surface of the porous material being treated by filling the pores on the surface with a liquid filler, solidifying the filler, grinding and/or polishing the surface, and removing the filler.

106. The process of claim 68 wherein the droplets having a volume-based mean diameter in the range up to about 200 microns, and a span in the range from about 0.01 to about 10.

107. The process of claim 68 wherein the process microchannel has an internal dimension perpendicular to the flow of liquid through the process microchannel of up to about 10 mm.

108. The process of claim 68 wherein the process microchannel has an internal dimension perpendicular to the flow of liquid through the process microchannel of up to about 2 mm.

109. The process of claim 68 wherein the process microchannel is made of a material comprising: steel; monel; inconel; aluminum; titanium; nickel; copper; brass; an alloy of any of the foregoing metals; a polymer; ceramics; glass; a composite comprising a polymer and fiberglass; quartz; silicon; or a combination of two or more thereof.

110. The process of claim 68 wherein the second liquid flows in a liquid channel and from the liquid channel through the apertured section, the liquid channel having an internal dimension perpendicular to the flow of the second liquid in the liquid channel of up to about 100 cm.

111. The process of claim 74 wherein the heat source and/or heat sink comprises at least one heat exchange channel, a heat exchange fluid being in the heat exchange channel.

112. The process of claim 111 wherein the heat exchange fluid undergoes a phase change in the heat exchange channel.

113. The process of claim 111 wherein an endothermic process is conducted in the heat exchange channel.

114. The process of claim 111 wherein an exothermic process is conducted in the heat exchange channel.

115. The process of claim 111 wherein the heat exchange fluid comprises air, steam, liquid water, carbon monoxide, carbon dioxide, gaseous nitrogen, liquid nitrogen, a gaseous hydrocarbon or a liquid hydrocarbon.

116. The process of claim 111 wherein the heat exchange fluid comprises the first liquid, the second liquid, or the emulsion.

117. The process of claim 74 wherein the heat source and/or heat sink comprises an electric heating element, resistance heater and/or non-fluid cooling element.

118. The process of claim 74 wherein the heat source and/or heat sink is adjacent to the process microchannel.

119. The process of claim 74 wherein the heat source and/or heat sink is remote from the process microchannel.

120. The process of claim 68 wherein the process is conducted in an emulsion process unit, the emulsion process unit comprising a plurality of the process microchannels connected to at least one first liquid manifold, the first liquid flowing through the at least one first liquid manifold to the process microchannels.

121. The process of claim 120 wherein liquid channels are adjacent to the process microchannels, the emulsion process unit further comprising at least one second liquid manifold connected to the liquid channels, the second liquid flowing through the at least one second liquid manifold to the liquid channels.

122. The process of claim 120 wherein heat exchange channels are adjacent to the process microchannels and/or liquid channels, the emulsion process unit further comprising at least one heat exchange manifold connected to the heat exchange channels, a heat exchange fluid flowing through the at least one heat exchange manifold to the heat exchange channels.

123. The process of claim 68 wherein the emulsion is an oil-in-water emulsion.

124. The process of claim 68 wherein the emulsion is a water-in-oil emulsion.

125. The process of claim 68 wherein the emulsion comprises a skin care product, a paint or coating composition, an adhesive composition, a glue composition, a caulk composition, a sealant composition, a food composition, an agricultural composition, a pharmaceutical composition, a fuel composition, a lubricant composition, a surface dressing composition, a silicone emulsion, a crystal containing composition, a liquid crystal composition, or a wax emulsion.

126. The process of claim 68 wherein the second liquid flows in a liquid channel, part of the second liquid flowing from the liquid channel through the apertured section, and part of the second liquid flowing through the liquid channel and out of the liquid channel.

127. The process of claim 68 wherein the apertured section extends along about 1% to about 100% of the axial length of the process microchannel.

128. The process of claim 68 wherein the process microchannel comprises surface features formed in and/or on one or more interior walls for modifying flow and/or enhancing mixing within the process microchannel.

129. The process of claim 69 wherein the liquid channel comprises surface features formed in and/or on one or more interior walls for modifying flow and/or enhancing mixing within the liquid channel.

130. The process of claim 111 wherein the heat exchange channel comprises surface features formed in and/or on one or more interior walls for modifying flow and/or enhancing mixing within the heat exchange channel.

131. The process of claim 128 wherein the surface features are in the form of depressions in and/or projections from one or more of the microchannel interior walls and are oriented at angles relative to the direction of flow of liquid through the process microchannel.

132. The process of claim 128 wherein the surface features comprise at least two surface feature regions where mixing of the first liquid reactant and second liquid is conducted in a first surface feature region followed by flow in a second surface feature region where the flow pattern in the second surface feature region is different than the flow pattern in the first surface feature region.

133. The process of claim 132 wherein the emulsion is formed in the first surface feature region and flows in the second surface feature region where one or more liquids and/or gases are separated from the emulsion.

134. The process of claim 68 wherein the apertured section comprises an interior portion that forms part of one or more of the interior walls of the process microchannel and a surface feature sheet overlies the interior portion of the apertured section, and wherein surface features are in and/or on the surface feature sheet.

135. The process of claim 128 wherein the surface features comprise two or more layers stacked on top of each other and/or intertwined in a three-dimensional pattern.

136. The process of claim 128 wherein the surface features are in the form of circles, oblongs, squares, rectangles, checks, chevrons, wavy shapes, or combinations thereof.

137. The process of claim 128 wherein the surface features comprise sub-features where the major walls of the surface features further contain smaller surface features in the form of notches, waves, indents, holes, burrs, checks, scallops, or combinations thereof.

138. The process of claim 68 wherein the emulsion comprises at least one emulsifier and/or surfactant.

139. The process of claim 68 wherein solids are dispersed in the emulsion.

140. The process of claim 68 wherein a catalyst is dispersed in the emulsion.

141. The process of claim 68 wherein the superficial velocity of the emulsion flowing in the process microchannel is at least about 0.01 meter per second.

142. The process of claim 68 wherein the process further comprises exchanging heat between the process microchannel and a heat source and/or heat sink to increase or decrease the temperature of the emulsion by at least about 10° C. within a period of up to about 750 milliseconds.

143. A process, comprising: flowing an emulsion in a process microchannel in contact with surface features formed in and/or on one or more interior walls of the process microchannel, the emulsion comprising a continuous phase and a dispersed phase, the continuous phase comprising a first liquid, the dispersed phase comprising droplets of a second liquid, the flow of the emulsion being at a superficial velocity sufficient to reduce the average size of the droplets.

144. The process of claim 143 wherein the liquid droplets have a volume-based mean diameter in the range up to about 200 microns, and a span in the range from about 0.005 to about 10.

145. The process of claim 143 with the step of exchanging heat between the process microchannel and a heat source and/or heat sink.

145. The process of claim 143 wherein the superficial velocity of the emulsion flowing in the process microchannel is at least about 0.01 meter per second.

146. The process of claim 143 wherein the first liquid and the second liquid are mixed to form the emulsion in the process microchannel.

147. The process of claim 143 wherein the process microchannel comprises at least one side wall and at least one apertured section extending along at least part of the axial length of the side wall, the second liquid flowing through the apertured section into the process microchannel in contact with the first liquid to form the emulsion.

148. The process of claim 147 wherein the second liquid flows from a liquid channel through the apertured section.

149. The process of claim 143 wherein the process is conducted in an emulsion process unit, the emulsion process unit comprising a plurality of the process microchannels and at least one header for distributing the first liquid and the second liquid to the process microchannels, the process further comprising mixing the first liquid and the second liquid to form the emulsion in the header, the emulsion flowing from the header into the process microchannels.

150. The process of claim 149 wherein the header comprises a first liquid zone, at least one second liquid zone, and an apertured section positioned between the first liquid zone and the second liquid zone, the second liquid flowing from the second liquid zone through the apertured section into the first liquid zone in contact with the first liquid to form the emulsion, the emulsion flowing from the first liquid zone into the process microchannels.

151. The process of claim 149 wherein a stream of the second liquid contacts a stream of the first liquid in the header to form the emulsion.

152. The process of claim 146 wherein a stream of the second liquid contacts a stream of the first liquid in the process microchannel to form the emulsion.

153. The process of claim 148 wherein the liquid channel comprises surface features formed in and/or on one or more interior walls for modifying flow and/or mixing within the liquid channel.

154. The process of claim 145 wherein the heat source and/or heat sink comprises at least one heat exchange channel, the heat exchange channel comprising surface features formed in and/or on one or more interior walls of the heat exchange channel for modifying flow and/or mixing within the heat exchange channel.

155. The process of claim 143 wherein the surface features are in the form of depressions in and/or projections from one or more of the interior walls of the process microchannel, the surface features being oriented at angles relative to the direction of flow through the process microchannel.

156. The process of claim 143 wherein the surface features comprise at least two surface feature regions where mixing of the first liquid and second liquid is conducted in a first surface feature region followed by flow in a second surface feature region where the flow pattern in the second surface feature region is different than the flow pattern in the first surface feature region.

157. The process of claim 147 wherein the apertured section comprises an interior portion that forms part of one or more of the interior walls of the process microchannel and surface features positioned in and/or on the interior portion of the apertured section.

158. The process of claim 143 wherein the surface features comprise two or more layers stacked on top of each other and/or intertwined in a three-dimensional pattern.

159. The process of claim 143 wherein the surface features are in the form of circles, oblongs, squares, rectangles, checks, chevrons, wavy shapes, or combinations thereof.

160. The process of claim 143 wherein the surface features comprise sub-features where the major walls of the surface features further contain smaller surface features in the form of notches, waves, indents, holes, burrs, checks, scallops, or combinations thereof.

161. The process of claim 143 wherein the process microchannel has an internal dimension of width or height of up to about 10 mm.

162. The process of claim 143 wherein the process microchannel has an internal dimension of width or height of up to about 2 mm.

163. The process of claim 143 wherein the process microchannel is made of a material comprising: steel; monel; inconel; aluminum; titanium; nickel; copper; brass; an alloy of any of the foregoing metals; a polymer; ceramics; glass; a composite comprising a polymer and fiberglass; quartz; silicon; or a combination of two or more thereof.

164. The process of claim 148 wherein the liquid channel comprises a microchannel.

165. The process of claim 148 wherein the process microchannel is adjacent to the liquid channel, the process microchannel and the liquid channel having a common wall with the apertured section in the common wall.

166. The process of claim 147 wherein the apertured section comprises a relatively thin sheet overlying a relatively thick sheet or plate, the relatively thin sheet containing an array of relatively small apertures, and the relatively thick sheet or plate containing an array of relatively large apertures, at least some of the relatively small apertures being aligned with the relatively large apertures.

167. The process of claim 147 wherein the apertured section comprises apertures that are partially filled with a coating material.

168. The process of claim 147 wherein the apertured section is heat treated.

169. The process of claim 147 wherein the apertured section is made from a porous material.

170. The process of claim 169 wherein the porous material is metallic, nonmetallic and/or oxidized.

171. The process of claim 169 wherein the porous material is coated with alumina or nickel.

172. The process of claim 147 wherein the apertured section is made from a porous material, the surface of the porous material being treated by filling the pores on the surface with a liquid filler, solidifying the filler, grinding or polishing the surface, and removing the filler.

173. The process of claim 147 wherein the apertured section extends along about 1% to about 100% of the axial length of the process microchannel.

174. The process of claim 145 wherein the heat source and/or heat sink is adjacent to the process microchannel.

175. The process of claim 145 wherein the heat source and/or heat sink is remote from the process microchannel.

176. The process of claim 145 wherein the heat source and/or heat sink comprises at least one heat exchange channel.

177. The process of claim 176 wherein the heat exchange channel comprises a microchannel.

178. The process of claim 145 wherein the heat source and/or heat sink comprises at least one electric heating element, resistance heater and/or non-fluid cooling element.

179. The process of claim 176 wherein a heat exchange fluid is in the heat exchange channel.

180. The process of claim 179 wherein the heat exchange fluid undergoes a phase change in the heat exchange channel.

181. The process of claim 145 wherein the heat flux between the heat source and/or heat sink and the process microchannel is in the range from about 0.01 to about 250 watts per square centimeter of surface area of the process microchannel.

182. The process of claim 176 wherein an endothermic process is conducted in the heat exchange channel.

183. The process of claim 176 wherein an exothermic process is conducted in the heat exchange channel.

184. The process of claim 176 wherein the emulsion flows in the process microchannel in a first direction, and a heat exchange fluid flows in the heat exchange channel in a second direction, the second direction being cross current relative to the first direction.

185. The process of claim 176 wherein the emulsion flows in the process microchannel in a first direction, and a heat exchange fluid flows in the heat exchange channel in a second direction, the second direction being cocurrent or counter current relative to the first direction.

186. The process of claim 176 wherein a heat exchange fluid is in the heat exchange channel, the heat exchange fluid comprising the first liquid, the second liquid, or the emulsion.

187. The process of claim 176 wherein a heat exchange fluid is in the heat exchange channel, the heat exchange fluid comprising one or more of air, steam, liquid water, carbon monoxide, carbon dioxide, gaseous nitrogen, liquid nitrogen, inert gas, gaseous hydrocarbon, oil, and liquid hydrocarbon.

188. The process of claim 143 wherein the emulsion is quenched in the process microchannel.

189. The process of claim 143 wherein the process microchannel is formed from parallel spaced sheets, plates or a combination of such sheets and plates.

190. The process of claim 147 wherein the second liquid flows in a liquid channel and from the liquid channel through the apertured section into the process microchannel, the liquid channel being formed from parallel spaced sheets, plates, or a combination of such sheets and plates, the liquid channel being adjacent to the process microchannel.

191. The process of claim 145 wherein the heat source and/or heat sink comprises a heat exchange channel, the heat exchange channel being formed from parallel spaced sheets, plates, or a combination of such sheets and plates, the heat exchange channel being adjacent to the process microchannel.

192. The process of claim 143 wherein the process is conducted in an emulsion process unit, the emulsion process unit comprising a plurality of the process microchannels, the process microchannels having walls with apertured sections and adjacent liquid channels, the second liquid flowing in the liquid channels and from the liquid channels through the apertured sections into the process microchannels in contact with the first liquid, the process microchannels and liquid channels being formed from parallel spaced sheets, plates, or a combination of such sheets and plates, the process microchannels and liquid channels being adjacent to each other and aligned in interleaved side-by-side vertically oriented planes or interleaved horizontally oriented planes stacked one above another.

193. The process of claim 192 wherein the emulsion process unit further comprises a plurality of heat exchange channels formed from parallel spaced sheets, plates, or a combination of such sheets and plates, the heat exchange channels exchanging heat with the process microchannels, the liquid channels, or both the process microchannels and the liquid channels.

194. The process of claim 147 wherein the second liquid flows in a liquid channel and from the liquid channel through the apertured section into the process microchannel, the process microchannel and the liquid channel comprising circular tubes aligned concentrically.

195. The process of claim 194 wherein the process microchannel is in an annular space and the liquid channel is in the center space or an adjacent annular space.

196. The process of claim 194 wherein the process microchannel is in the center space and the liquid channel is in an adjacent annular space.

197. The process of claim 143 wherein the process is conducted in an emulsion process unit, the emulsion process unit comprising a plurality of the process microchannels wherein separate emulsions are formed in each of the process microchannels, the emulsions formed in at least two of the process microchannels being different from each other.

198. The process of claim 147 wherein the process microchannel comprises two or more apertured sections and separate second liquids flow through each of the apertured sections.

199. The process of claim 147 wherein the process microchannel has a mixing zone adjacent to the apertured section and a non-apertured region extending from the entrance to the process microchannel to the mixing zone.

200. The process of claim 147 wherein the apertured section has a wall thickness, the ratio of the wall thickness to the axial length of the apertured section being in the range from about 0.001 to about 1.

201. The process of claim 143 wherein the emulsion comprises a water-in-oil emulsion.

202. The process of claim 143 wherein the emulsion comprises an oil-in-water emulsion.

203. The process of claim 143 wherein the emulsion comprises at least one organic liquid.

204. The process of claim 143 wherein the emulsion comprises a skin care product, a paint or coating composition, an adhesive composition, a glue composition, a caulk composition, a sealant composition, a food composition, an agricultural composition, a pharmaceutical composition, a fuel composition, a lubricant composition, a surface dressing composition, a silicone emulsion, a crystal containing composition, a liquid crystal composition, or a wax emulsion.

205. The process of claim 143 wherein the emulsion comprises at least one emulsifier and/or surfactant.

206. The process of claim 143 wherein solids are dispersed in the emulsion.

207. The process of claim 143 wherein a catalyst is dispersed in the emulsion.

208. The process of claim 7 wherein the process microchannel, liquid channel and/or apertured section is coated with a lipophobic coating.

209. The process of claim 70 wherein the process microchannel, liquid channel and/or apertured section is coated with a lipophobic coating.

210. The process of claim 148 wherein the process microchannel, liquid channel and/or apertured section is coated with a lipophobic coating.

211. The process of claim 7 wherein the liquid channel comprises a flow-through channel with a liquid channel outlet, a first part of the second liquid flowing through the apertured section, a second part of the second liquid flowing out of the liquid channel through the liquid channel outlet.

212. The process of claim 211 wherein the flow of the second liquid through the liquid channel outlet is controlled to control the pressure within the liquid channel.

213. The process of claim 68 wherein the liquid channel comprises a flow-through channel with a liquid channel outlet, a first part of the second liquid flowing through the apertured section, a second part of the second liquid flowing out of the liquid channel through the liquid channel outlet.

214. The process of claim 213 wherein the flow of the second liquid through the liquid channel outlet is controlled to control the pressure within the liquid channel.

215. The process of claim 148 wherein the liquid channel comprises a flow-through channel with a liquid channel outlet, a first part of the second liquid flowing through the apertured section, a second part of the second liquid flowing out of the liquid channel through the liquid channel outlet.

216. The process of claim 215 wherein the flow of the second liquid through the liquid channel outlet is controlled to control the pressure within the liquid channel.

217. The process of claim 7 wherein the apertured section is in the form of a tube with an apertured tubular wall, an axial length and a circular cross section, the interior of the tube comprising the liquid channel, the process microchannel being positioned on the outer surface of the tube, the axial length of the process microchannel extending parallel to the axial length of the tube, the first liquid flowing in the process microchannel, the second liquid flowing from the interior of the tube through the apertured tubular wall into the process microchannel in contact with the first liquid to form the emulsion.

218. The process of claim 217 wherein a plurality of the process microchannels are positioned on the outer surface of the tube.

219. The process of claim 217 wherein a heat exchange channel is adjacent to the process microchannel, the process microchannel being positioned between the outer surface of the tube and the heat exchange channel.

220. The process of claim 69 wherein the apertured section is in the form of a tube with an apertured tubular wall, an axial length and a circular cross section, the interior of the tube comprising the liquid channel, the process microchannel being positioned on the outer surface of the tube, the axial length of the process microchannel extending parallel to the axial length of the tube, the first liquid flowing in the process microchannel, the second liquid flowing from the interior of the tube through the apertured tubular wall into the process microchannel in contact with the first liquid to form the emulsion.

221. The process of claim 220 wherein a plurality of the process microchannels are positioned on the outer surface of the tube.

222. The process of claim 220 wherein a heat exchange channel is adjacent to the process microchannel, the process microchannel being positioned between the outer surface of the tube and the heat exchange channel.

223. The process of claim 148 wherein the apertured section is in the form of a tube with an apertured tubular wall, an axial length and a circular cross section, the interior of the tube comprising the liquid channel, the process microchannel being positioned on the outer surface of the tube, the axial length of the process microchannel extending parallel to the axial length of the tube, the first liquid flowing in the process microchannel, the second liquid flowing from the interior of the tube through the apertured tubular wall into the process microchannel in contact with the first liquid to form the emulsion.

224. The process of claim 223 wherein a plurality of the process microchannels are positioned on the outer surface of the tube.

225. The process of claim 224 wherein a heat exchange channel is adjacent to the process microchannel, the process microchannel being positioned between the outer surface of the tube and the heat exchange channel.

226. The process of claim 6 wherein the apertured section comprises at least two sheets overlying each other, a first sheet having a first array of apertures in it, a second sheet having a second array of apertures in it, the apertures in the first sheet being larger than the apertures in the second sheet, the second sheet at least partially blocking some of the apertures in the first sheet.

227. The process of claim 68 wherein the apertured section comprises at least two sheets overlying each other, a first sheet having a first array of apertures in it, a second sheet having a second array of apertures in it, the apertures in the first sheet being larger than the apertures in the second sheet, the second sheet at least partially blocking some of the apertures in the first sheet.

228. The process of claim 147 wherein the apertured section comprises at least two sheets overlying each other, a first sheet having a first array of apertures in it, a second sheet having a second array of apertures in it, the apertures in the first sheet being larger than the apertures in the second sheet, the second sheet at least partially blocking some of the apertures in the first sheet.

229. The process of claim 6 wherein the apertured section comprises a porous substrate coated with at least one metal, the metal being applied to the porous substrate by electroless plating.

230. The process of claim 229 wherein the metal comprises platinum.

231. The process of claim 68 wherein the apertured section comprises a porous substrate coated with at least one metal, the metal being applied to the porous substrate by electroless plating.

232. The process of claim 231 wherein the metal comprises platinum.

233. The process of claim 147 wherein the apertured section comprises a porous substrate coated with at least one metal, the metal being applied to the porous substrate by electroless plating.

234. The process of claim 233 wherein the metal comprises platinum.

235. A process for making an emulsion, the emulsion comprising a continuous phase and a dispersed phase, the continuous phase comprising a first liquid, the dispersed phase comprising a second liquid; the process comprising:
flowing the first liquid in a rotating flow pattern in a cylindrical cavity, the cylindrical cavity including a side wall with apertured section; and
flowing the second liquid through the apertured section into the cylindrical cavity in contact with the first liquid to form the emulsion.

236. A process for making an emulsion, the emulsion comprising a continuous phase and a dispersed phase, the continuous phase comprising a first liquid, the dispersed phase comprising a second liquid, the process comprising:
flowing the first liquid in a rotating flow pattern in an annular space of a cylindrical cavity, the cylindrical cavity including a hollow cylinder positioned inside the annular space and having apertures pointing radially outward from the hollow cylinder toward the annular space; and
flowing the second liquid through the apertures into contact with the first liquid to form the emulsion.

237. The process of claim 236 wherein the first liquid flows in a rotating pattern in a first direction, and the hollow cylinder rotates in a direction opposite the first direction.

238. A process for making an emulsion, the emulsion comprising a continuous phase and a dispersed phase, the continuous phase comprising a first liquid, the dispersed phase comprising a second liquid, the process comprising:
flowing the first liquid on an apertured substrate, the apertured substrate including cylindrical posts extending into the flow path of the first liquid and containing capillary pores; and
flowing the second liquid through the capillary pores in the cylindrical posts into contact with the first liquid to form the emulsion.

239. A process for making an emulsion, the emulsion comprising a continuous phase and a dispersed phase, the continuous phase comprising a first liquid, the dispersed phase comprising a second liquid, the process comprising:
flowing the first liquid tangentially to or in impinging contact with an apertured section; and
flowing the second section through the apertured section in contact with the first liquid to form the emulsion.

240. The process of claim 239 wherein the first liquid flows through a jet into contact with the apertured section.

241. A process for making an emulsion, the emulsion comprising a continuous phase and a dispersed phase, the continuous phase comprising a first liquid, the dispersed phase comprising a second liquid, the process comprising:
flowing the first liquid in a process microchannel, the process microchannel having an apertured section in one side wall and a ramped structure in the side wall opposite the apertured section; and
flowing the second liquid through the apertured section into the process microchannel in contact with the first liquid to form the emulsion.

242. A process for making an emulsion, the emulsion comprising a continuous phase and a dispersed phase, the continuous phase comprising a first liquid, the dispersed phase comprising a second liquid, the process comprising:
flowing the first liquid in a process microchannel, the process microchannel having a wavy apertured section; and
flowing the second liquid through the apertured section into the process microchannel in contact with the first liquid to form the emulsion.

243. A process for making an emulsion, the emulsion comprising a continuous phase and a dispersed phase, the continuous phase comprising a first liquid, the dispersed phase comprising a second liquid; the process comprising:
flowing the second liquid through a porous substrate and then flowing the second liquid through a rotating blade into contact with the first liquid to form the emulsion.

244. A process for making an emulsion, the emulsion comprising a continuous phase and a dispersed phase, the continuous phase comprising a first liquid, the dispersed phase comprising a second liquid; the process comprising:
flowing the second liquid through at least two parallel apertured substrates into contact with the first liquid to form the emulsion, one of the apertured substrates moving relative to the other apertured substrate.

245. A process for making an emulsion, the emulsion comprising a continuous phase and a dispersed phase, the continuous phase comprising a first liquid, the dispersed phase comprising a second liquid; the process comprising:
forming a first dispersion comprising droplets of the first liquid dispersant in an inert gas;
forming a second dispersion comprising droplets of the second liquid dispersed in an inert gas;
combining the first dispersion and the second dispersion to form a combined dispersion; and
separating the inert gas from the combined dispersion to form the emulsion.

246. The process of claim 6 wherein the apertured section comprises a porous material and a plurality of adjacent ribs supporting the porous material.

247. The process of claim 68 wherein the apertured section comprises a porous material and a plurality of adjacent ribs supporting the porous material.

248. The process of claim 147 wherein the apertured section comprises a porous material and a plurality of adjacent ribs supporting the porous material.

249. The process of claim 1 wherein the first liquid and/or the second liquid is a non-Newtonian fluid.

250. The process of claim 68 wherein the first liquid and/or the second liquid is a non-Newtonian fluid.

251. The process of claim 143 wherein the first liquid and/or the second liquid is a non-Newtonian fluid.

252. The process of claim 6 wherein a surface feature section is positioned in the process microchannel upstream of the apertured section.

253. The process of claim 68 wherein a surface feature section is positioned in the process microchannel upstream of the apertured section.

254. The process of claim 147 wherein a surface feature section is positioned in the process microchannel upstream of the apertured section.
